(19) United States
(12) Patent Application Publication
(10) Pub. No.: US 2026/0064037 A1
(43) Pub. Date: Mar. 5, 2026

(54) DEVELOPING APPARATUS, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: TAIJI KATSURA, Shizuoka (JP); YOSHIAKI SHIOTARI, Shizuoka (JP); ATSUSHI NOGUCHI, Shizuoka (JP); SHINTARO NOJI, Shizuoka (JP)

(21) Appl. No.: 19/304,800

(22) Filed: Aug. 20, 2025

(30) Foreign Application Priority Data
Aug. 27, 2024 (JP) 2024-145487
Apr. 10, 2025 (JP) 2025-064998

(51) Int. Cl. G03G 15/08; G03G 5/043; G03G 5/087; G03G 15/02; G03G 21/18

(52) U.S. Cl. CPC G03G 15/0818; G03G 5/0436; G03G 5/087; G03G 15/0291; G03G 21/1814; G03G 2215/026

(57) ABSTRACT

A developing apparatus including: a toner configured to have toner particle and external additive; a toner carrying member configured to carry the toner; and an charge injection member configured to inject electric charge into the toner, in which the external additive contain titanium atom-containing fine particles containing a compound containing titanium atoms, a presence ratio of the titanium atoms is 0.05 to 4.00 atomic % when a surface of the toner is measured using X-ray photoelectron spectroscopy, the toner carrying member is a developing roller having a substrate having a conductive outer surface and a resin layer on the outer surface of the substrate, impedance of the developing roller measured under specific conditions is 1.00×10⁶ Ω or more, and a maximum value of a surface potential measured under specific conditions is less than 20.0 V.

### BACKGROUND

### Field of the Technology

The present disclosure relates to a developing apparatus, a process cartridge, and an electrophotographic image forming apparatus.

### Description of the Related Art

In recent years, image forming apparatuses such as a copy machine and a printer have been required to have image quality, high speed, and high stability while being required to be reduced in size of the apparatus and simple to maintain and manage. A dry type single-component developing system that is advantageous in these aspects is preferably used.

As developing apparatuses using dry type single-component development, various apparatuses have been proposed.

As one example, there is an apparatus as below. In other words, in a developing apparatus, toner (hereinafter also referred to as “developer”) that is a single-component developer is housed in a developer container. The toner is carried on a developing roller that is rotatably fixed to the developer container, and a toner layer having a uniform layer thickness is formed by a toner regulating member. The developing roller carrying the toner layer is brought close to or brought into contact with a photosensitive member, and, for example, a developing bias voltage is applied to the developing roller, whereby an electric potential difference is generated between an electrostatic image on the photosensitive member and the developing roller. In accordance with this, the toner is moved to the electrostatic image, and development is performed.

In order to obtain a good image quality, it is necessary to uniformly develop the toner, and, for this reason, it is necessary to uniformly charge an appropriate amount of the toner on the developing roller. As a process for charging toner, triboelectric charging using contact of the toner regulating member and the developing roller with the toner is generally used. However, in the triboelectric charging, rubbing between toner and a contact member does not uniformly occur, and overcharged toner and low charged toner may be generated. The reason for this is that electric charge according to triboelectric charging is generated only in a portion in which toner and the contact member are in contact with each other.

In addition, triboelectric charging is easily affected by humidity, and the amount of charging may vary depending on the humidity of the environment. Furthermore, since triboelectric charging is greatly influenced by the flowability of the toner, the amount of charging may change in a case in which external additives become submerged in the toner surface to reduce the toner flowability due to long-term use.

In order to solve the problems of such a triboelectric charging process, an injection charging process has been reviewed. The injection charging process is a process of charging toner by injecting electric charge in accordance with an electric potential difference between the toner and a charging member. In this case, if there is a conduction path in a toner or between toners, not only a portion in contact with a charging member but also the entire toner can be uniformly charged.

In addition, since the injection charging process can arbitrarily control the amount of charging by changing the electric potential difference, it becomes easy to satisfy the amount of charging required by the system. Furthermore, since the injection charging is less difficult to be affected by humidity, the change in the amount of charging according to environments can be suppressed.

Japanese Patent Application Laid-open No. 2008-058874 has proposed a toner configuration capable of simultaneously performing contact charging and charge injection charging by adjusting the resistance and the static capacitance of toner by immobilizing metal oxide particle having medium resistance on the surface of the toner. Japanese Patent Application Laid-open No. 2021-021791 is an example of toner to which a large amount of titania is externally added as toner applicable to an injection charging process.

### SUMMARY

However, according to review of the inventors, in Japanese Patent Application Laid-open No. 2008-058874, the resistance and the electrostatic capacitance of toner strongly depend on the state of presence of external additives on the surface of the toner, and thus the toner is easily susceptible to the effect of submersion of external additives. In a case in which the toner is used in a high-speed developing process in which a load can be easily applied to the toner, external additives are submerged, and the charging performance of the toner is reduced. As a result, adverse effects such as fogging and scattering of toner may easily occur.

In addition, in systems utilizing injection charging, the characteristics of a developing roller combined with the toner are important as well. However, although a developing roller combined with toner in Japanese Patent Application Laid-open No. 2008-058874 is described as being covered with an elastic rubber layer and having an electrical resistance value set to 10³ to 10¹⁰ Ω, details thereof are not mentioned.

In a case in which a developing roller having a relatively low resistance of less than 10⁶ Ω is used, the charge of toner acquired through contact charging or charge injection leaks through the developing roller, and adverse effects such as fogging and toner scattering may easily occur. In order to maintain charge of toner on a developing roller, although it is necessary to increase the resistance value of the developing roller, in the case, the charge-up of the surface of the developing roller becomes significant, and adverse effects such as fogging and poor regulation may easily occur.

Japanese Patent Application Laid-open No. 2021-021791 discloses that, by causing a medium-resistance external additive such as titania to be contained much on the surface of toner, high charge injection performance can be acquired. However, in a case in which a large amount of an external additive such as titania is used in a high-speed developing process, a large amount of the external additive adheres to the surface of the developing roller, and the characteristics of the developing roller change. Particularly, in a high-humidity environment, the leakage of electric charge from a developing roller increases, and adverse effects such as fogging and scattering of toner may easily occur.

As described above, although Japanese Patent Application Laid-open No. 2008-058874 and Japanese Patent Application Laid-open No. 2021-021791 attempt to improve the charge injection performance for toner by externally attaching a medium-resistance external additive to the toner, there is still room for improvement in the viewpoint of adaptability to a high-speed developing process. In particular, in the viewpoint of a combination of toner and a developing roller, there is still room to consider.

The present disclosure provides a developing apparatus, a process cartridge, and an electrophotographic image forming apparatus that have good injection charging characteristics, are capable of being applied to a high-speed developing process, and have charging stability even in long-term use.

The present disclosure relates to a developing apparatus comprising: a toner comprising a toner particle and external additive; a toner carrying member for carrying the toner; and a charge injection member configured to inject electric charge into the toner, wherein the external additive contains titanium atom-containing fine particles containing a compound containing titanium atoms, a presence ratio of the titanium atoms is 0.05 to 4.00 atomic % when a surface of the toner is measured using X-ray photoelectron spectroscopy, the toner carrying member is a developing roller having a substrate having a conductive outer surface and a resin layer on the outer surface of the substrate, a metal film is directly provided on an outer surface of the developing roller, and under an environment of 23° C. temperature and 50% relative humidity, when an AC voltage of which an amplitude is 50 V is applied between the outer surface of the substrate and the metal film with a frequency changing in a range of 1.0×10⁻¹ to 1.0×10⁵ Hz while a DC voltage of 50 V is applied therebetween, an impedance at the frequency of 1.0×10⁰ to 1.0×10¹ Hz is 1.00×10⁶ Ω or more, and under an environment of 23° C. temperature and 50% relative humidity, a corona discharger having a grid portion of which a width is 3.0 mm is arranged such that a distance between the grid portion and the outer surface of the developing roller is 1.0 mm, and a direction of the width of the grid portion coincides with an axial direction of the developing roller, and when a voltage of 8 kV is applied to the grid portion, and the outer surface of the developing roller is charged by relatively moving the corona discharger in the axial direction of the developing roller at a speed of 400 mm/sec, a maximum value of an electric potential of the outer surface is less than 20.0 V when the electric potential is measured after 0.06 seconds from passage of the grid portion.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic cross-sectional view illustrating an example of a developing roller;

FIG. 2 is a schematic cross-sectional view illustrating an example of a developing roller;

FIG. 3 is a schematic view of a process cartridge;

FIG. 4 is a schematic view of an electrophotographic image forming apparatus;

FIG. 5 is a schematic view of a state in which measurement electrodes are formed on a developing roller;

FIG. 6 is a cross-sectional view of a developing roller and measurement electrodes;

FIG. 7 is a schematic view of an impedance measurement system;

FIG. 8 is a schematic view illustrating an example of an apparatus measuring the surface electric potential of a developing roller;

FIG. 9 is a schematic diagram of a circuit measuring a leakage current flowing from toner to a developing roller;

FIG. 10 is a schematic view of an electrophotographic image forming apparatus for image evaluation;

FIG. 11 is an example of a Faraday cage; and

### DESCRIPTION OF THE EMBODIMENTS

In the present disclosure, the expression “from XX to YY” or “XX to YY” representing a numerical range means a numerical range including a lower limit and an upper limit, which are endpoints, unless otherwise specified. In a case where numerical ranges are described stepwise, an upper limit and a lower limit of each numerical range can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In a case in which XX is a group, a plurality of elements may be selected from XX, and this similarly applies also to YY and ZZ.

As described above, in order to acquire injection charging performance, a conduction path needs to be present between toner and a charging member. For this reason, it is necessary to increase the conductivity of the toner. In order to increase the conductivity of the toner, it may be considered to cover the surface of the toner with an external additive (medium-resistance external additive) having relatively low resistance such as titania. However, in order to acquire the required charge injection performance, it is necessary to cover a toner particle with a large amount of medium-resistance external additives. In a case in which such toner is used in a high-speed developing process, there is a problem of a change in the surface property of the toner due to submersion of the external additive and contamination of members due to the external additive, and it is difficult to maintain the charge injection performance.

The present inventors thought that, when necessary injection charging performance is acquired without using a large amount of medium-resistance external additives, the change in the surface properties of the toner according to a developing process is small, and contamination of members due to the external additives is improved. In other words, it was though that a developing system, which has stable charging, that can be applied also to a high-speed developing process can be acquired.

As a reason for requiring a large amount of medium-resistance external additives for acquiring charge injection performance, there is a problem of a charging retention property of toner. To raise the conductivity of toner, on the other hand, promotes electric charge leakage from the toner, and thus it is difficult to retain electric charge acquired through injection on the toner. This was considered to inhibit efficient injection charging. Thus, while performing charge injection into toner, the present inventors attempted to prevent leakage of the electric charge from the toner.

More specifically, it was attempted to prevent leakage of electric charge from toner after injection of the electric charge into the toner by combining a developing roller having a high resistance with toner having charge injection performance. Thus, it was examined to combine, for example, a developing roller of which a surface layer is formed using polyurethane as a developing roller having high resistance with toner having charge injection performance. As a result, while it was checked that good injection charging performance can be acquired without using a large amount of medium-resistance external additives, on the other hand, it was found that another problem occurs. There was a new problem that toner that is excessively charged adheres to the surface of the developing roller in accordance with excessively high electrical resistance of the surface layer of the developing roller. At the same time, it has been found that, in accordance with marked occurrence of contamination of the developing roller with an external additive and reduction of the surface resistance of the developing roller, the injection charging performance cannot be maintained through durable use.

Thus, the present inventors reviewed to remove excessive charges from the excessively-charged toner by causing a conductive filler to be contained in the surface layer of the developing roller. For example, although it was reviewed to cause a conductive filler to be contained in the surface layer, the present inventors recognized a new problem that it is difficult to cause a conductive filler to sufficiently disperse to such an extent that excessive charge can be removed. If the dispersibility of the conductive filler is insufficient, a conductive path according to the conductive filler is formed inside of the surface layer to cause charge leakage, and to the contrary, the effect of removing excessive charge expected for the conductive filler may be insufficient.

In other words, relating to the surface layer of the developing roller, it is necessary to solve contradictory problems of preventing charge leakage from toner and removing excessive charge from the excessively charged toner at a high level. For this reason, the present inventors recognized that development of a new surface layer is necessary such that excessive charge can be removed while maintaining high electrical resistance of the surface layer. On the basis of such recognition, the present inventors made further reviews.

As a result, regarding a developing roller having a substrate having a conductive outer surface and a resin layer on this outer surface of the substrate, the present inventors found that a developing system having charging stability in a combination with toner having a charge injection capability can be acquired by satisfying the following two requirements.

### Requirement (1)

A metal film is directly provided on the outer surface of the developing roller, and, under an environment of temperature 23° C. and relative humidity 50%, while DC voltage of 50 V is applied between the outer surface of the substrate and the metal film, AC voltage having an amplitude of 50 V is applied while changing the frequency between 1.0×10⁻¹ to 1.0×10⁵ Hz. At this time, impedance at the frequency of 1.0×10⁰ to 1.0×10¹ Hz is 1.00×10⁶ Ω or more.

### Requirement (2)

Under an environment of temperature 23° C. and relative humidity 50%, a corona discharger having a grid portion of which the width is 3.0 mm is placed such that a distance between this grid portion and the outer surface of the developing roller is 1.0 mm, and the direction of the width of the grid portion coincides with the axial direction of the developing roller. Then, voltage 8 kV is applied to the grid portion, the corona discharger is relatively moved in the axial direction of the developing roller at the speed of 400 mm/sec to charge the outer surface of the developing roller, and the electric potential of the outer surface after 0.06 seconds from passage of the grid portion is measured. A maximum value of the electric potential at this time is less than 20.0 V.

Hereinafter, details of Requirements (1) and (2) described above will be described.

### Technical Significance of Requirement (1)

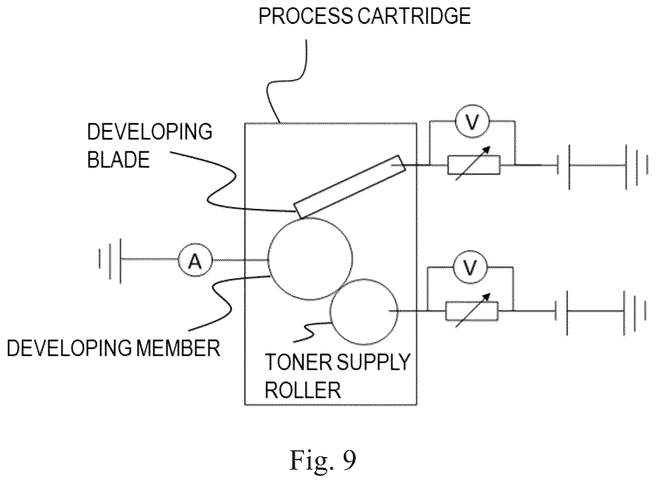

Requirement (1) defines a numerical value of the impedance of the developing roller. This impedance is a physical property value that represents a charge leakage property from the toner to the developing roller. The present inventors measured a current value (leakage current value) flowing through the developing roller when a blade bias is applied to a developing blade in accordance with a circuit diagram shown in FIG. 9. As a result, it was found that this current value exhibits a higher correlation with the impedance value of the developing roller than the electrical resistance value of the developing roller.

In other words, charge leakage indicates that not only the resistance component of the developing roller but also the influence of the electrostatic capacitance component needs to be considered. It is considered that the reason for this is that, when the electrical characteristics of the developing roller are represented in a simulated manner using an RC parallel circuit, a transient state until charge is sufficiently accumulated in the capacitor component, and a steady state in which the resistance component is dominant is reached has a large influence on the charge leakage.

A voltage application condition for impedance measurement is that an AC voltage of 50 V is superimposed on a DC voltage of 50 V. In other words, a sinusoidal wave of which a minimum value and a maximum value of the applied voltage are respectively 0 V and 100 V (Vpp 100 V) is applied. The value of Vpp 100 V is a value acquired by assuming the maximum value of a shared voltage applied to the developing roller when the voltage is applied such that a voltage difference of 300 V is applied between the developing roller and the developing blade in an electrophotographic image forming apparatus.

Although the impedance represents bias dependency, and the impedance has a property of decreasing in accordance with an increase of the bias, it has been found that the degree of decrease differs depending on the developing roller. While a condition that the voltage application condition is the AC voltage of 1 V is generally used in the impedance measurement of a conventional developing roller, in the application condition of the AC voltage being 1 V, the voltage is clearly lower than a voltage (generally several hundred V) applied between the developing roller and the developing blade in an actual electrophotographic image forming apparatus. For this reason, the behavior of the developing roller in the electrophotographic image forming apparatus is often not simulated, and the impedance measurement conditions are often inadequate.

Thus, the present disclosure employs voltage application conditions, which are applied to an actual electrophotographic image forming apparatus, imitating a high blade bias. The sinusoidal wave of which the minimum value of an applied voltage is 0 V simulates a rectangular wave that is generally used in application of the blade bias of an actual electrophotographic image forming apparatus.

In the present disclosure, although the impedance at the frequency of 1.0×10⁰ to 1.0×10¹ Hz is specified, a low frequency region of 1.0×10⁰ to 1.0×10¹ Hz is a frequency region in which the transient state has been completed, and the steady state in which the resistive component is dominant has been reached. In other words, the region is a region, in which the influence of both the electrostatic capacitance component and the resistance component is reflected, that is suitable for recognizing the charge leakage from toner to the developing roller. When the impedance at the frequency of 1.0×10⁰ to 1.0×10¹ Hz is 1.00×10⁶ Ω or more, the charge leakage is low, and, under a high blade bias, charge leakage from toner to the developing roller is suppressed, whereby reduction in the amount of charging of the toner can be prevented.

The impedance at the frequency of 1.0×10⁰ to 1.0×10¹ Hz is preferably 1.40×10⁶ Ω or more. The higher the value of this impedance, the more preferable it is, and although the upper limit thereof is not particularly limited, for example, the upper limit is 5.00×10⁷ Ω or less.

A minimum value of the impedance at the frequency of 1.0×10⁰ to 1.0×10¹ Hz is preferably 1.40×10⁶ Ω or more, more preferably, 2.00×10⁶ Ω or more, particularly preferably, 3.00×10⁶ Ω or more, and even more preferably, 5.00×10⁶ Ω or more. A preferred range of the impedance is from 1.00×10⁶ Ω to 5.00×10⁷ Ω, is preferably from 1.40×10⁶ Ω to 5.00×10⁷ Ω, is more preferably from 2.00×10⁶ Ω to 5.00×10⁷ Ω, is particularly preferably from 3.00×10⁶ Ω to 5.00×10⁷ Ω, and even more preferably from 5.00×10⁶ Ω to 5.00×10⁷ Ω.

### Technical Significance of Requirement (2)

Requirement (2) defines the surface electric potential of the developing roller. The surface electric potential of the developing roller indicates residual charge on the surface of the developing roller and is a physical property value indicating the degree of excessive charge (charge-up) of the toner. If the surface electric potential is high, the charge of the excessively-charged toner cannot be appropriately controlled, and there are cases in which reduction in the image density and fogging occur.

As factors causing image density reduction, two factors may be considered. The first factor is a factor causing the excessively-charged toner to be electrically fixed to the surface of the developing roller and to be unable to charge toner that has been conveyed to the same spot next time. The second factor is a factor causing residual charge to be present on the surface of the developing roller after removal of toner from the surface of the developing roller and being unable to charge toner that has been conveyed to the same spot next time.

In the present disclosure, when a voltage of 8 kV is applied to the grid portion, and the corona discharger is relatively moved in the axial direction of the developing roller at the speed of 400 mm/sec, the electric potential of the outer surface of the developing roller after 0.06 seconds after passage of the corona discharger through the grid portion is checked. If the maximum value of the electric potential on the outer surface is less than 20.0 V, also in an electrophotographic image forming apparatus, in which a time required for toner charged by the developing blade to be conveyed to the photoreceptor is shorter, having a fast process speed, the occurrence of image defects due to excessive charging of the toner can be suppressed. At 0.06 seconds after the passage of the grid portion of the corona discharger, it imitates a model with high process speed.

The maximum value of the electric potential of the outer surface described above is preferably 15.0 V or less and more preferably 10.0 V or less. The lower the maximum value of the potential on the outer surface, the more preferable it is, and the lower limit is not particularly limited.

A preferred range of the maximum value of the electric potential value of the outer surface described above is, for example, 0 V or more and less than 20.0 V, is particularly from 0 V to 15.0 V, and more preferably from 0 V to 10.0 V.

In accordance with the developing roller satisfying Requirement (1) and Requirement (2) described above, both suppression of charge leakage from the toner and suppression of excessive charging on the surface of the developing roller can be achieved. As a result, the charge injected into the toner is properly retained on the toner, and efficient charge injection into the toner can be performed.

As a result, sufficient injection charging performance can be acquired without using a large amount of a medium-resistance external additive in toner. Since a large amount of a medium-resistance external additive is not used, the change of the properties of the toner surface according to a developing process is small, and contamination of the member according to an external additive is suppressed as well. In other words, a developing system, which can be applied also to a high-speed developing process, having stable charging performance can be acquired.

A means satisfying Requirement (1) and Requirement (2) described above is not particularly limited. Although more specific description is described below, there is a means improving dispersibility of a conductive filler by using a material of the resin layer, a material of the conductive filler, and additives as below.

Hereinafter, the present disclosure will be described in more detail.

### Toner (Developer)

The toner according to the present aspect is toner that has a toner particle and an external additive. The external additive contains titanium atom-containing fine particles containing a compound containing a titanium atom. When the surface of the toner is measured using X-ray photoelectron spectroscopy, the presence ratio of titanium atoms is 0.05 to 4.00 atomic %.

As described above, in order to acquire injection charging performance, in toner having a toner particle, it is necessary to arrange a material having higher conductivity than the toner particle on the surface of the toner particle. In the present disclosure, titanium atom-containing fine particles containing a compound containing titanium atoms are used as the material having higher conductivity than the toner particle.

A compound containing titanium atoms is preferable from the viewpoint of moderate volume resistivity and low water absorption. In addition, since moderate polarization is likely to occur in the compound, efficient injection charging can be performed.

As the compound containing titanium atoms, a known compound such as titanium oxide, composite oxide, polyvalent metal salt, and the like can be used without any particular limitation. One example of the titanium atom-containing fine particles includes at least one selected from a group consisting of titanium oxide, strontium titanate, barium titanate, calcium titanate, magnesium titanate, aluminum titanate, and titanium phosphate. From the viewpoint of structural stability and volume resistivity, among them, it is preferable that the titanium atom-containing fine particle should be at least one selected from the group consisting of a titanium oxide fine particle and a strontium titanate fine particle. These may be used alone or in combination of two kinds or more thereof.

The volume resistivity of the titanium atom-containing fine particles, for example, is 1.0×10⁰ to 2.0×10¹⁰ (Ω·cm), is preferably 1.0×10⁰ to 1.0×10⁹ (Ω·cm), and is more preferably 1.0×10³ to 1.0×10⁹ (Ω·cm). If the volume resistivity is 1.0×10⁹ (Ω·cm) or less, the conductivity is sufficient, and the injection charging performance can be acquired more easily.

The volume resistivity can be calculated by measuring a distance between the electrodes and a resistance value in a state in which a sample is interposed between the electrodes and a constant load is applied using a torque wrench. A detailed measurement will be described below.
Reason for Presence Ratio

Since the external additive has titanium atom-containing fine particles, the conductivity of the surface of the toner particle is controlled to acquire the injection charging performance. In the present disclosure, the presence ratio of titanium atoms needs to be 0.05 to 4.00 atomic %. In a case in which the presence ratio of titanium atoms is within the range described above, the charge injection effect from a charging member can be acquired when combined with a developing roller to be described below.

When the presence ratio of titanium atoms is less than 0.05 atomic %, the conduction path between the toner and the charging member is insufficient, and the injection charging performance cannot be acquired. When the presence ratio of titanium atoms is greater than 4.00 atomic %, although the injection charging performance can be acquired, a change in the surface property of the toner due to submersion of the external additive and the contamination of the member due to the external additive may easily occur, and it becomes difficult to maintain the injection charging performance in a high-speed developing process. Particularly, regarding the contamination of the external additive on the developing roller, it is assumed that the deposition and the removal of the external additive on the developing roller simultaneously proceed during the process. It is assumed that, when the presence ratio of titanium atoms exceeds 4.00 atomic %, the deposition of the external additive exceeds the amount of removal, and thus the deposition of the external additive may easily proceed. As a result, the characteristics of the developing roller change, and thus the effects of the present disclosure cannot be acquired.

The presence ratio of titanium atoms acquired when the surface of the toner is measured using X-ray photoelectron spectroscopy is preferably 0.05 to 2.00 atomic % and is more preferably 0.10 to 1.00 atomic %.

The titanium atom-containing fine particle preferably has a major axis length to be 8 to 3000 nm. The titanium atom-containing fine particle preferably has a number average value of major axis lengths to be 8 to 3000 nm.

The titanium atom-containing fine particles preferably contain titanium atom-containing fine particles L having a major axis length of 100 to 3000 nm (more preferably 100 to 1000 nm) and an aspect ratio of 5.0 or more (more preferably 5.0 to 20.0, and further more preferably 5.0 to 10.0).

The titanium atom-containing fine particles preferably contain titanium atom-containing fine particles La having the number average value of major axis lengths to be 100 to 3000 nm (more preferably 100 to 1000 nm) and the number average value of aspect ratios to be 5.0 or more (more preferably 5.0 to 20.0 and further more preferably 5.0 to 10.0).

The titanium atom-containing fine particles preferably contain titanium atom-containing fine particles S having a major axis length of 8 to 60 nm (more preferably 8 to 40 nm) and an aspect ratio of 2.0 or less (more preferably 1.0 to 2.0 and further more preferably 1.0 to 1.7).

The titanium atom-containing fine particles preferably contain titanium atom-containing fine particles Sa having a number average value of major axis lengths of 8 to 60 nm (more preferably 8 to 40 nm) and a number average value of aspect ratios of 2.0 or less (more preferably 1.0 to 2.0, and further more preferably 1.0 to 1.7).

It is more preferable that the titanium atom-containing fine particles should contain any one or both of the titanium atom-containing fine particles L and the titanium atom-containing fine particles S. It is more preferable that the titanium atom-containing fine particles should contain any one or both of the titanium atom-containing fine particles La and titanium atom-containing fine particles Sa.

The titanium atom-containing fine particles preferably contain the titanium atom-containing fine particles L having a major axis length of 100 to 3000 nm and an aspect ratio of 5.0 or more.

Then, the toner is observed using a scanning electron microscope, and when it is assumed that the total number of observed toners is Nt, and the number of toners that can be checked to have the titanium atom-containing fine particles L present on the surface among the observed toners is NL, it is preferable that Nt described above and NL described above should satisfy NL/Nt≥0.3 at this time. For example, NL/Nt is 0.1 to 1.0, preferably 0.3 to 1.0, and more preferably 0.5 to 1.0.

NL/Nt can be controlled in accordance with the amount of the titanium atom-containing fine particles L added and mixing conditions at the time of external addition. In a case in which the amount of the titanium atom-containing fine particle L added is increased, NL/Nt can be raised. Further, NL/Nt can be raised by strengthening the mixing conditions at the time of external addition (increasing the number of revolutions at the time of agitation).

It is preferable that the titanium atom-containing fine particles should include:
titanium atom-containing fine particles L having a major axis length of 100 to 3000 nm and an aspect ratio of 5.0 or more; and
titanium atom-containing fine particles S having a major axis length of 8 to 60 nm and an aspect ratio of 2.0 or less.

Then, the toner is observed using a scanning electron microscope, and it is assumed that the total number of the observed toners is Nt, and the number of toners that can be checked to have both the titanium atom-containing fine particles L and the titanium atom-containing fine particles S on the surface among the observed toners is NLS. At this time, it is preferable that Nt described above and NLS described above should satisfy “NLS/Nt≥0.3”. For example, NLS/Nt is 0.1 to 1.0, is preferably 0.3 to 1.0, and is more preferably 0.5 to 1.0.

NLS/Nt can be controlled in accordance with the amounts of the titanium atom-containing fine particles L and S added and the mixing conditions at the time of external addition. NLS/Nt can be raised in a case in which the amounts of the titanium atom-containing fine particles L and S added are increased. In addition, NLS/Nt can be raised by strengthening the mixing conditions at the time of external addition (raising the number of revolutions at the time of agitation). Alternatively, NLS/Nt can be increased by pre-mixing the titanium atom-containing fine particles L and S and then adding them to the toner particle.

Since the titanium atom-containing fine particles L have a relatively large particle size and a high aspect ratio, a conduction path with a conductive member can be appropriately formed while suppressing submersion into the surface of a toner particle and migration to recess on the surface of the toner. For this reason, the toner contains the titanium atom-containing fine particles L, whereby a conduction path can be easily formed between a charging member and the toner. This similarly applies also to the titanium atom-containing fine particles La.

The titanium atom-containing fine particles S have a relatively small particle size and an approximately spherical shape, can uniformly cover the surface of the toner particle, and can uniformly and appropriately form a conduction path between the toners. For this reason, by containing the titanium atom-containing fine particles S, electric charge can be easily moved in the toner, and the toner charging distribution is improved. This similarly applies also to the titanium atom-containing fine particles Sa.

Even when any fine particles are used, in a direction in which leakage of electric charge from toner to a developing roller is promoted, in a case in which the fine particles are not combined with a developing roller to be described below, the good injection charging characteristics cannot be maintained through durable use. By combining the titanium atom-containing fine particles L and the titanium atom-containing fine particles S with a developing roller to be described later, good injection charging characteristics can be initially acquired, and they can be maintained throughout the durable use.

In particular, by having the toner to contain the titanium atom-containing fine particles L and the titanium atom-containing fine particles S and combining the fine particles with a developing roller to be described below, high injection electric charges can be acquired, and they can be maintained in a particularly good state through durable use.

It is preferable to adjust the titanium atom-containing fine particles described above in accordance with the particle size described above such that the presence ratio of metal elements acquired when the surface of the toner described above is measured using X-ray photoelectron spectroscopy satisfies the numerical range described above.

The smaller the particle size, the smaller the content, and the larger the particle size, the larger the content, whereby the presence ratio of the titanium atoms described above can be easily controlled to be in the numerical value range described above.

More specifically, the content of the titanium atom-containing fine particles in the toner is preferably from 0.01 mass % to 3.0 mass %. The content of the titanium atom-containing fine particles with respect to 100 parts by mass of toner particles, for example, is 0.01 to 3.0 parts by mass, is more preferably 0.3 to 3.0 parts by mass, and further more preferably 0.5 to 2.5 parts by mass.

The titanium atom-containing fine particles may be surface-treated. For the improvement of heat-resistant storage and the improvement of environmental stability, a luster treatment may be performed on the titanium atom-containing fine particles, for example, using a silane coupling agent, a titanium coupling agent, a higher fatty acid, a silicone oil, or the like. The titanium atom-containing fine particles preferably have a BET specific surface area of 10 m²/g to 450 m²/g.

The fixing ratio of the titanium atom-containing fine particles to the surface of the toner particle, which is measured using wavelength-dispersive fluorescent X-ray analysis, is, for example, 8 to 95%, preferably 10 to 90%, more preferably 20 to 80%, and even more preferably 50 to 80%. In the case of being in the range described above, the contamination of the member due to migration of the titanium atom-containing fine particles to the developing roller and reduction in the injection electrostatic performance due to submersion of the titanium atom-containing fine particles into the surface of the toner are further suppressed. The fixing ratio can be controlled by changing the external addition conditions.

Each component constituting the toner and a method of producing a toner will be described in more detail.

### Binder Resin

The toner particle may comprise a binder resin.

Examples of the binder resin include a polyester resin and a vinyl resin, and there are the following resins or polymers as other binder resins. Examples thereof include a styrene acrylic resin, a polyester resin, an epoxy resin, a polyurethane resin, a polyamide resin, a cellulose resin, a polyether resin, and a mixed resin or a composite resin thereof.

The binder resin is preferably a polyester resin, a styrene acrylic resin, or a hybrid resin thereof from a point that those are easily available at a low cost and have excellent low-temperature fixability and is more preferably a styrene acrylic resin.

The polyester resin is obtained by selecting preferred compounds from a polycarboxylic acid, a polyol, a hydroxycarboxylic acid, and the like and combining the selected compounds, for example, synthesizing the compounds using a conventionally known method such as a transesterification method or a polycondensation method.

The polycarboxylic acid is a compound containing at least two carboxy groups in one molecule. Among them, the dicarboxylic acid is a compound containing two carboxy groups in one molecule, and is preferably used.

Examples of the dicarboxylic acid include dicarboxylic acids such as oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylene diacetic acid, m-phenylene diacetic acid, o-phenylene diacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexane dicarboxylic acid.

Examples of the polycarboxylic acid other than the dicarboxylic acid include trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. These compounds may be used alone or in combination of at least two kinds thereof.

The polyol is a compound containing at least two hydroxyl groups in one molecule. Among them, a diol is a compound containing two hydroxyl groups in one molecule, and is preferably used.

Specific examples thereof include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, hydrogenated bisphenol A, bisphenol A, bisphenol F, bisphenol S, and alkylene oxide (ethylene oxide, propylene oxide, butylene oxide, or the like) adducts of the bisphenols.

Among them, an alkylene glycol having 2 to 12 carbon atoms and an alkylene oxide adduct of a bisphenol are preferable, and an alkylene oxide adduct of a bisphenol and a combination thereof with an alkylene glycol having 2 to 12 carbon atoms are particularly preferable.

Examples of the trivalent or higher polyol include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and an alkylene oxide adduct of the trivalent or higher polyphenol. These compounds may be used alone or in combination of at least two kinds thereof. The polyester resin may be a polyester resin containing a urea group. It is preferable that the polyester resin should be not capped with carboxy groups at the terminal or the like.

Examples of the styrene-acrylic resin include homopolymers including the following polymerizable monomers, copolymers obtained by combining two or more of these, or mixtures thereof.

styrene monomer such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octyl styrene, p-n-nonylstyrene, p-n-decylstyrene, p-n-dodecylstyrene, p-methoxystyrene, and p-phenylstyrene; (Meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid, and maleic acid; vinyl ether-based monomers such as vinyl methyl ether and vinyl isobutyl ether; vinyl ketone-based monomers such as vinyl methyl ketone, vinyl ethyl ketone, and vinyl isopropenyl ketone; and polyolefins such as ethylene, propylene, and butadiene.

As the styrene acrylic resin, a polyfunctional polymerizable monomer can be used as necessary. The polyfunctional polymerizable monomer, for example, includes diethyleneglycol di(meth)acrylate, triethyleneglycol di(meth)acrylate, tetraethyleneglycol di(meth)acrylate, polyethylene glycol di(meth)acrylate, 1,6-hexandiol di(meth)acrylate, Neopentyl glycol di(meth)acrylate, tripropylene glycol di(meth)acrylate, polypropylene glycol di(meth)acrylate, 2,2-bis(4-((meth)acryloxy diethoxy)phenyl) propane, trimethylolpropane tri(meth)acrylate, tetramethylolmethane tetra(meth)acrylate, divinylbenzene, divinylnaphthalene, divinyl ether, and the like.

In order to control the degree of polymerization, known chain transfer agents and polymerization inhibitors can be further added.

Examples of polymerization initiators used for obtaining styrene-acrylic resins include organic peroxide-based initiators and azo-based polymerization initiators.

Examples of the organic peroxide-based initiator include benzoyl peroxide, lauroyl peroxide, di-α-cumyl peroxide, 2,5-dimethyl-2,5-bis(benzoyl peroxide) hexane, bis(4-t-butylcyclohexyl) peroxydicarbonate, 1,1-bis(t-butylperoxide)cyclododecane, t-butylperoxymaleic acid, bis(t-butylperoxide) isophthalate, methyl ethyl ketone peroxide, tert-butylperoxide-2-ethylhexanoate, diisopropylperoxy carbonate, cumene hydroperoxide, 2,4-dichlorobenzoyl peroxide, and tert-butyl-peroxypivalate, and the like.

Examples of the azo-based polymerization initiators include 2,2′-azobis(2,4-dimethylvaleronitrile), 2,2′-azobisisobutyronitrile, 1,1′-azobis(cyclohexane-1-carbonitrile), 2,2′-azobis(4-methoxy-2,4-dimethylvaleronitrile), azobismethylbutyronitrile, 2,2′-azobis(methyl isobutyrate), and the like.

As the polymerization initiator, a redox-based initiator in which an oxidizing substance and a reducing substance are combined can also be used.

Examples of the oxidizing substances include hydrogen peroxide, inorganic peroxides of persulfates (sodium, potassium and ammonium salts), oxidizing metal salts of tetravalent cerium salts, and the like.

Examples of the reducing substance includes a reducing metal salt (divalent iron salt, monovalent copper salt and trivalent chromium salt), ammonia, lower amine (amine having from 1 to 6 carbon atoms such as methylamine and ethylamine), an amino compound such as hydroxylamine, reducing sulfur compounds such as sodium thiosulfate, sodium hydrosulfite, sodium bisulfite, sodium sulfite and sodium formaldehyde sulfoxylate, lower alcohols (carbon atoms from 1 to 6), ascorbic acid or salts thereof, and lower aldehyde (carbon atoms from 1 to 6).

The polymerization initiator is selected by referring to the 10-hour half-life temperature and is used either individually or in combination. The amount of the polymerization initiator added varies depending on the degree of polymerization to be desired, but generally from 0.5 parts by mass to 20.0 parts by mass is added to 100.0 parts by mass of the polymerizable monomer.

The toner particle may contain a crystalline polyester. The crystalline polyester, for example, includes a condensation polymer of an aliphatic diol and an aliphatic dicarboxylic acid.

The crystalline polyester is preferably a condensation polymer of an aliphatic diol having from 2 to 12 carbon atoms and an aliphatic dicarboxylic acid having from 2 to 12 carbon atoms. An example of the aliphatic diol having from 2 to 12 carbon atoms includes the following compounds. 1,2-ethandiol, 1,3-propanediol, 1,4-butanediol, 1,5-pentanediol, 1,6-hexandiol, 1,7-heptandiol, 1,8-octandiol, 1,9-nonandiol, 1,10-decanediol, 1,11-undecanediol, 1,12-dodecandiol, and the like.

As the crystalline polyester, an aliphatic diol having a double bond can also be used. As examples of the aliphatic diol having a double bond, there are the following compounds. 2-butenes-1,4-diol, 3-hexene-1,6-diol and 4-octen-1,8-diol.

Examples of the aliphatic dicarboxylic acids having from 2 to 12 carbon atoms include the following compounds. Oxalic acid, malonic acid, succinic acid, glutaric acid, adipic acid, pimelinic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, lower alkyl esters and acid anhydrides of these aliphatic dicarboxylic acids.

Among them, sebacic acid, adipic acid and 1,10-decanedicarboxylic acid, and lower alkyl esters and acid anhydrides thereof are preferred. These can be used individually or in combination of two or more types thereof.

As the crystalline polyester, aromatic dicarboxylic acid can also be used. As examples of the aromatic dicarboxylic acid, there are the following compounds. Terephthalic acid, isophthalic acid, 2,6-naphthalenedicarboxylic acid and 4,4-diphenyldicarboxylic acid. Among these, terephthalic acid is preferable from a viewpoint that it is readily available and can easily form a polymer having a low melting point.

As the crystalline polyester, dicarboxylic acid having a double bond can also be used. The dicarboxylic acid having a double bond can be appropriately used for suppressing hot offset at the time of fixation in that the entire resin is cross-linked using the double bond.

Examples of such dicarboxylic acid include fumaric acid, maleic acid, 3-hexenedioic acid and 3-octenedioic acid. In addition, there are lower alkyl esters and acid anhydrides thereof. Among them, fumaric acid and maleic acid are more preferable.

A method for producing a crystalline polyester is not particularly limited, and it can be produced by a general polyester polymerization method in which a dicarboxylic acid component and a diol component are reacted. For example, it can be manufactured using a direct polycondensation method or an ester exchange method depending on the type of monomer.

The content of crystalline polyester is preferably from 1.0 parts by mass to 30.0 parts by mass and is more preferably from 3.0 parts by mass to 25.0 parts by mass with respect to 100 parts by mass of the binder resin.

The peak temperature of the maximum endothermic peak of the crystalline polyester, which is measured using a differential scanning calorimetry (DSC), is preferably from 50.0° C. to 100.0° C. and is more preferably from 60.0° C. to 90.0° C. from the viewpoint of low-temperature fixability.

As the molecular weight of the binder resin, the peak molecular weight Mp is preferably from 5,000 to 100,000 and is more preferably from 10,000 to 40,000. The glass transition temperature Tg of the binder resin is preferably from 40° C. to 70° C. and is more preferably from 40° C. to 60° C. The content of the binder resin is preferably 50 mass % or more with respect to the total amount of resin components in the toner particle.

### Crosslinking Agent

In order to control the molecular weight of the binder resin that composes toner particle, a crosslinking agent may be added when polymerizable monomers are polymerized.

For example, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloxy polyethoxyphenyl) propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycols #200, #400, and #600, dipropylene glycol diacrylate, polypropylene glycol diacrylate, polyester-type diacrylate (MANDA Nippon Kayaku), and the methacrylate analogues of the acrylates described above.

The amount of crosslinking agent to be added is preferably from 0.001 parts by mass to 15.000 parts by mass with respect to 100 parts by mass of the polymerizable monomer.

### Release Agent

In the toner, a known wax can be used as a release agent.

More specifically, examples thereof include petroleum-based waxes such as paraffin wax, microcrystalline wax, and petrolatum, and their derivatives; montan wax and its derivatives; hydrocarbon waxes obtained by the Fischer-Tropsch process and their derivatives; polyolefin waxes such as polyethylene and polypropylene and their derivatives; and natural waxes such as carnauba wax and candelilla wax and their derivatives. Derivatives include oxides, block copolymers with vinyl monomers, and graft-modified substances.

Also there are alcohols such as higher aliphatic alcohols; Fatty acids such as stearic acid, palmitic acid or their acid amides, esters, and ketones; Hydrogenated castor oils and derivatives thereof, plant waxes, and animal waxes. These may be used individually or in combination.

Among these, the use of polyolefin wax, hydrocarbon wax produced using a Fischer-Tropsch method, or petroleum-based wax tends to improve developability and transferability and thus is preferable. In addition, an antioxidant may be added to such waxes as long as it does not affect the characteristics of the toner.

In addition, from the viewpoint of phase separation from the binder resin or crystallization temperature, higher fatty acid esters such as behenyl behenate and dibehenyl sebacate can be suitably exemplified.

The content of the release agent is preferably from 1.0 parts by mass to 30.0 parts by mass with respect to 100.0 parts by mass of the binder resin.

The melting point of the release agent is preferably from 30° C. to 120° C. and is more preferably from 60° C. to 100° C. By using a release agent of which the melting point is from 30° C. to 120° C., the release effect can be efficiently exhibited, and a broader fixing range can be secured.

### Plasticizer

From the viewpoint of improving the sharp melt characteristics of the toner, the toner may contain a plasticizer. The plasticizer is not particularly limited, and any known plasticizer used in toner as below can be used.

Esters of a monovalent alcohol and an aliphatic carboxylic acid such as behenyl behenate, stearyl stearate, and pulmiyl palmitate, or esters of a monovalent carboxylic acid and an aliphatic alcohol; Esters of a divalent alcohol and an aliphatic carboxylic acid such as ethylene glycol distearate, dibehenyl sebacate, hexandiol dibehenate, or esters of a divalent carboxylic acid and an aliphatic alcohol; Esters of a trivalent alcohol and an aliphatic carboxylic acid, such as glycerin tribehenate, or esters of a trivalent carboxylic acid and an aliphatic alcohol; Esters of a tetravalent alcohol and an aliphatic carboxylic acid, such as pentaerythritol tetrastearate, pentaerythritol tetrapalmitate, or esters of a tetravalent carboxylic acid and an aliphatic alcohol; Esters of a hexaalcohol and an aliphatic carboxylic acid, such as dipentaerythritol hexastearate, dipentaerythritol hexapalmitate, or esters of a hexacarboxylic acid and an aliphatic alcohol; Esters of polyhydric alcohols and aliphatic carboxylic acids, such as polyglycerin behenate, or esters of polyhydric carboxylic acids and aliphatic alcohols; Natural ester waxes such as carnauba wax and rice wax. These may be used individually or in combination.

### Colorant

The toner particle may contain a colorant. As the colorant, known pigments and dyes can be used. From the viewpoint of excellent weather resistance, a pigment is preferable as the colorant.

Examples of the cyan colorant include copper phthalocyanine compounds and derivatives thereof, anthraquinone compounds, base dye lake compounds, and the like.

More specifically, examples are as below. C.I. pigment blue 1, 7, 15, and 15:1 and 15:2 and 15:3 and 15:4, 60, 62, and 66.

Examples of the magenta colorant include a condensed azo compound, a dyketopyrrolopyrrole compound, an anthraquinone compound, a quinacridone compound, a basic dye lake compound, a naphthol compound, a benzimidazolone compound, a thioindigo compound, a perylene compound, and the like.

More specifically, examples are as below. C.I. pigment red 2, 3, 5, 6, 7, 23, and 48:2 and 48:3 and 48:4 and 57:1 and 81:1, 122, 144, 146, 150, 166, 169, 177, 184, 185, 202, 206, 220, 221, and 254, and C.I. pigment violet 19.

Examples of yellow colorants include a condensed azo compound, an isoindolinone compound, an anthraquinone compound, an azo metal complex, a methine compound, an arylamide compound, and the like.

Specifically, examples are as below. C.I. pigment yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black colorants include those adjusted to black in color using the yellow colorant, the magenta colorant, and the cyan colorant described above and carbon black.

These colorants can be used individually, or as a mixture, or in the form of a solid solution.

The colorant is preferably used from 1.0 parts by mass to 20.0 parts by mass with respect to 100.0 parts by mass of the binder resin.

### Charge Control Agents and Charge Control Resins

The toner particle may contain a charge control agent or a charge control resin. As the charge control agent, a known agent can be used, and a charge control agent having a high triboelectric charging speed and being capable of stably maintaining a consistent amount of triboelectric charge is preferable. Furthermore, in a case in which the toner particle is produced using a suspension polymerization method, a charge control agent that has a low polymerization inhibition property and is substantially free of solubilized substances in aqueous media is particularly preferrable.

Examples of the charge control agent that controls the toner to be negatively charged include a monoazo metal compound, an acetylacetone metal compound, an aromatic oxycarboxylic acid, an aromatic dicarboxylic acid, an oxycarboxylic and dicarboxylic acid-based metal compound, an aromatic oxycarboxylic acid, an aromatic mono and polycarboxylic acid and their metal salts, an anhydride, an ester, a phenol derivative such as a bisphenol, an urea derivative, a metal-containing salicylic acid compound, a metal-containing naphthoic acid compound, a boron compound, a quaternary ammonium salt, a calixarene, a charge control resin, and the like.

Examples of the charge control resin include a polymer or a copolymer having a sulfonic acid group, a sulfonic acid base or a sulfonic acid ester group. As the polymer having a sulfonic acid group, a sulfonic acid base or a sulfonic acid ester group, a polymer containing 2 mass % or more of a sulfonic acid group-containing acrylamide monomer or a sulfonic acid group-containing methacrylamide monomer in a copolymerization ratio is preferable, and a polymer containing 5 mass % or more thereof is more preferable.

The charge control resin of which a glass transition temperature (Tg) is from 35° C. to 90° C., a peak molecular weight (Mp) is from 10000 to 30000, and a weight average molecular weight (Mw) is from 25000 to 50000 is preferable. In a case in which this is used, preferable triboelectric charge characteristics can be imparted without affecting the thermal characteristics required for the toner particle. Further, when the charge control resin contains a sulfonic acid group, for example, the dispersibility of the charge control resin in the polymerizable monomer composition and the dispersibility of the colorant are improved, and coloring power, transparency, and triboelectric properties can be further improved.

These charge control agents or charge control resins may be added alone or in combination of two or more.

The amount of the charge control agent or charge control resin to be added is preferably from 0.01 parts by mass to 20.0 parts by mass and more preferably from 0.5 parts by mass to 10.0 parts by mass with respect to 100.0 parts by mass of the binder resin.

### External Additive

The toner may contain external additives other than the titanium atom-containing fine particles described above. For example, in order to improve fluidity, chargeability, cleaning properties, and the like, the toner may be acquired by adding a fluidizing agent, a charge aid, a cleaning aid, and the like to the toner particle.

The external additive, for example, includes an inorganic oxide fine particle such as a silica fine particle and an alumina fine particle, a positively-charged particle such as a melamine resin, an inorganic stearic acid compound fine particle such as an aluminum stearate fine particle and a zinc stearate fine particle, and the like. These may be used alone or in combination of two kinds or more thereof. It is preferable that the toner should contain a silica fine particle.

For the improvement of heat-resistant storage and the improvement of environmental stability, a gloss treatment may be performed on these inorganic fine particles using a silane coupling agent, a higher fatty acid, a silicone oil, or the like. The BET specific surface area of the external additive is preferably from 10 m²/g to 450 m²/g.

The BET specific surface area can be obtained using a low-temperature gas adsorption method following a dynamic constant pressure method in accordance with a BET method (preferably a BET multi-point method). For example, the BET specific surface area (m²/g) can be calculated by adsorbing nitrogen gas on the sample surface using a specific surface area measuring device (product name: Gemin 2375 Ver.5.0, manufactured by Shimadzu Corporation) and performing measurement using a BET multi-point method.

A content of other external additives in total is preferably from 0.05 parts by mass to 5 parts by mass and more preferably from 0.1 parts by mass to 3 parts by mass with respect to 100 parts by mass of the toner particles. Various external additives may be used in combination.

### Method for Producing Toner Particle

The toner particle preferably has a core particle that contains a binder resin and a shell on the surface of the core particle. The method for producing the toner particle is not particularly limited, a known means can be used, and a kneading and pulverizing method or a wet production method can be used. Examples of the wet production method include a suspension polymerization method, a dissolution suspension method, an emulsion polymerization aggregation method, an emulsion aggregation method, and the like. From the viewpoint of making particle size uniform, shape control, and easy to obtain the toner particle having a core-shell structure, the wet production method is preferable, and, among them, the suspension polymerization method and the emulsion aggregation method are preferable.

### Suspension Polymerization Method

In the suspension polymerization method, first, a polymerizable monomer composition is prepared in which a polymerizable monomer to form a binder resin, a colorant and, if necessary, other additives are uniformly dissolved or dispersed using a dispersing machine such as a ball mill or an ultrasonic dispersing machine (a step of preparing the polymerizable monomer composition). At this time, if necessary, a polyfunctional monomer and a chain transfer agent, and a wax, a charge control agent, a plasticizer, and the like as release agents can be added as appropriate.

Next, the polymerizable monomer composition described above is input into an aqueous medium that has previously been prepared, and droplets of the polymerizable monomer composition are formed into a desired size of toner particles using a stirrer or a dispersing machine having a high shear force (a granulation step).

It is preferable that the aqueous medium in the granulation step should contain a dispersion stabilizer in order to control the particle size of the toner particle, to sharpen the particle size distribution, and to suppress the toner particles from being mixed in the production process. Generally, dispersion stabilizers are largely classified into polymers that exhibit repulsive forces due to steric hindrance and poorly water-soluble inorganic compounds that achieve dispersion stabilization in accordance with electrostatic repulsive forces. Fine particles of the slightly water-soluble inorganic compound are dissolved by an acid or an alkali, can be dissolved and easily removed by washing with an acid or an alkali after polymerization, and thus are appropriately used.

As the dispersion stabilizer for the slightly water-soluble inorganic compound, a stabilizer in which any one of magnesium, calcium, barium, zinc, aluminum, and phosphorus is contained is preferably used. More preferably, it is desirable to include any one of magnesium, calcium, aluminum, and phosphorus. More specifically, examples thereof are as below.

Magnesium phosphate, tricalcium phosphate, aluminum phosphate, zinc phosphate, magnesium carbonate, calcium carbonate, magnesium hydroxide, calcium hydroxide, aluminum hydroxide, calcium metasilicate, calcium sulfate, barium sulfate, and hydroxyapatite.

Organic compounds, for example, polyvinyl alcohol, gelatin, methyl cellulose, methyl hydroxypropyl cellulose, ethyl cellulose, sodium salt of carboxymethyl cellulose, and starch may be used in combination with the dispersion stabilizer described above. These dispersion stabilizers are preferably used from 0.01 parts by mass to 2.00 parts by mass with respect to 100 parts by mass of the polymerizable monomer.

Furthermore, in order to micronize these dispersion stabilizers, from 0.001 parts by mass to 0.1 parts by mass of a surfactant with respect to 100 parts by mass of the polymerizable monomer may be used in combination. More specifically, commercially available nonionic, anionic, or cationic surfactants can be used. For example, sodium dodecyl sulfate, sodium tetradecyl sulfate, sodium pentadecyl sulfate, sodium octyl sulfate, sodium oleate, sodium laurate, potassium stearate, and calcium oleate is preferably used.

After the granulation step or while the granulation step is performed, the temperature is preferably set to from 50° C. to 90° C., and the polymerizable monomer contained in the polymerizable monomer composition is polymerized to obtain a toner particle dispersion (a polymerization step).

In the polymerization step, a stirring operation is preferably performed such that the temperature distribution inside of the container becomes uniform. In a case in which addition of the polymerization initiator is performed, it can be performed at any timing with a required time. Further, the temperature may be raised in a latter half of the polymerization reaction for the purpose of obtaining a desired molecular weight distribution, and furthermore, in order to remove unreacted polymerizable monomers, by-products, and the like from the system, a part of the aqueous medium may be distilled off using a distillation operation in the latter stage of the reaction or after completion of the reaction. The distillation operation can be performed under either normal pressure or reduced pressure.

As the polymerization initiator used in the suspension polymerization method, an oil-soluble initiator is generally used. The polymerization initiator may be also used as a water-soluble initiator as needed.

These polymerization initiators can be used individually or in combination, and in order to control the degree of polymerization of the polymerizable monomer, chain transfer agents, polymerization inhibitors, and the like can be further added and used.

Regarding the particle size of the toner particle, from the viewpoint of obtaining high-definition and high-resolution images, the volume-based median diameter is preferably from 3.0 μm to 10.0 μm. The volume-based median diameter and number average particle diameter of the toner can be measured using a pore electrical resistance method. For example, it can be measured using a “Coulter Counter Multisizer 3” (manufactured by Beckman Coulter Co.). The toner particle dispersion acquired in this way is sent to a filtration step in which the toner particle and the aqueous medium are separated from each other through solid-liquid separation.

The solid-liquid separation used for obtaining toner particle from the acquired toner particle dispersion can be performed using a general filtration method, and further washing is preferably performed through rinsing with re-slurry or washing water in order to remove foreign matters that could not be completely removed from the surface of the toner particle. After sufficient washing is performed, solid-liquid separation is performed again to obtain a toner cake. Thereafter, the toner cake is dried by a known drying means, and if necessary, a particle group having particle sizes other than a predetermined size is separated through classification to obtain toner particle. At this time, the separated particle group having particle sizes other than the predetermined size may be reused for improving the final yield.

### Emulsion Aggregation Method

In the emulsion aggregation method, first, dispersions of materials such as fine particles of a binder resin and a coloring agent are prepared. The acquired dispersion of each material is dispersed and mixed with a dispersion stabilizer as needed. Thereafter, aggregation is performed until a desired particle size of the toner particle is achieved by adding a coagulant, and thereafter or simultaneously with the aggregation, fusion between resin fine particles is performed. Further, if necessary, shape control using heat is performed to form the toner particle.

Here, the fine particles of the binder resin may be composite particles formed of a plurality of layers having two or more layers composed of resins having different compositions. For example, they can be produced by emulsion polymerization, mini emulsion polymerization, phase inversion emulsification, or the like or several methods thereof in combination. In a case in which an internal additive is contained in the toner particle, the resin fine particles may contain the internal additive, or when a dispersion of internal additive fine particles consisting of only the internal additive is separately prepared, and the internal additive fine particles are aggregated together with the resin fine particles, all of them may be aggregated. In addition, layered toner particle having different compositions may be prepared by adding resin fine particles having different compositions with a time difference and aggregating them during aggregation. After the resin fine particles containing the binder resin are aggregated to form a core part, a shell part may be formed by adding the resin fine particles containing a resin for the shell with a time difference and aggregating them.

The resin for a shell may be the same as the binding resin or may be a different resin. The amount of the resin for a shell added is preferably from 1.0 parts by mass to 10.0 parts by mass and more preferably from 2.0 parts by mass to 7.0 parts by mass with respect to 100 parts by mass of the binder resin contained in the core particle.

In this case, the method for manufacturing the toner preferably has the following steps:
(1) a dispersion step of adjusting a binder resin fine particle dispersion containing a binder resin,
(2) an aggregation step of aggregating binder resin fine particles contained in the binder resin fine particle dispersion to form an aggregate,
(3) a shell formation step of further adding resin fine particles containing a resin for a shell to a dispersion containing an aggregate and aggregating them to form an aggregate having a shell, and
(4) a fusion step of heating and fusing the aggregate.

The aggregate may contain a coloring agent dispersion or a release agent dispersion as needed. It is preferable to perform the following step (5) during step (4) described above or after steps (1) to (4) described above.
(5) A spheroidization step of heating the aggregate by further raising the temperature.

It is more preferable to perform the following steps (6) and (7) after step (5) described above.
(6) A cooling step of cooling the aggregate described above at a cooling rate of 0.1° C./see or more.
(7) An annealing step of heating and retaining the aggregate at a temperature equal to or higher than a crystallization temperature of the binder resin described above or equal to or higher than a glass transition temperature after the cooling step described above.

As the dispersion stabilizer, the following can be used.

As the surfactant, a known cationic surfactant, an anionic surfactant, or a nonionic surfactant can be used.

Examples of an inorganic dispersion stabilizer include tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina.

Examples of an organic dispersion stabilizer include polyvinyl alcohol, gelatin, methyl cellulose, methyl hydroxypropyl cellulose, ethyl cellulose, sodium salt of carboxymethyl cellulose, and starch.

As the coagulant, an inorganic salt or a divalent or more inorganic metal salt can be appropriately used in addition to a surfactant having a polarity opposite to that of the surfactant used in the dispersion stabilizer described above. In particular, the inorganic metal salt is preferable because aggregation control and toner charging performance control thereof can be easily performed by ionizing multivalent metal elements in an aqueous medium.

Specific examples of preferable inorganic metal salts include metal salts of calcium chloride, calcium nitrate, barium chloride, magnesium chloride, zinc chloride, iron chloride, aluminum chloride, and aluminum sulfate and inorganic metal salt polymers of poly iron chloride, poly aluminum chloride, poly aluminum hydroxide, and calcium polysulfide. Among them, an aluminum salt and a polymer thereof are particularly suitable. In general, in order to acquire a sharper particle size distribution, it is preferable that the valence of the inorganic metal salt should be divalent rather than monovalent, trivalent or more rather than divalent, and the inorganic metal salt polymer is more suitable for the same valence.

From the viewpoint of high definition and high resolution of an image, the volume-based median diameter of the toner particle is preferably from 3.0 μm to 10.0 μm.

### Method of Producing Toner

The toner contains at least titanium atom-containing fine particles as external additives. The toner can be acquired by externally adding at least titanium atom-containing fine particles to the toner particle.

A mixer for externally adding external additives to the toner particle is not particularly limited, and a known mixer can be used regardless of a dry type or a wet type. For example, there are FM mixer (manufactured by Japanese Cokes Industrial Co., Ltd.), Super mixer (manufactured by Kawata Co.), Nonvider (manufactured by Horoka Micron Co.), Hybrider (manufactured by Nara Machine Co.), and the like. In order to control the covering state of the external additives, by adjusting the number of rotations, a processing time, and a water temperature and a water amount of the jacket of the external adding apparatus described above, the toner can be prepared.

In addition, examples of a screening apparatus used for screening coarse particles after external addition include Ultrasonic (manufactured by Kishi Industries Co.), Resonaceive and Gyroshifter (manufactured by Tokujyu Kosakujo Co.), Vibra Sonic System (manufactured by Dalton Co.), Soniclean (manufactured by Shinto Kogyo Co.), Turbo Screener (manufactured by Turbo Kogyo Co.), and Microshifter (manufactured by Makino Sangyo Co.).

### Developing Roller

The toner carrying member (also referred to as “developer carrying member”) is a developing roller having a substrate that has a conductive outer surface and a resin layer on the outer surface of the substrate.

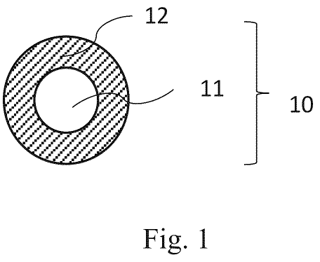

An example of the developing roller is illustrated in FIG. 1. In the developing roller 10 shown in FIG. 1, a resin layer 12 is laminated on the outer peripheral surface of a substrate 11 having a cylindrical shape or a hollow cylindrical shape.

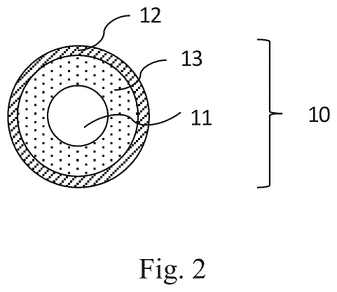

Note that the configuration of layers of the developing roller is not limited to the form shown in FIG. 1. As another form of the developing roller, as shown in FIG. 2, an elastic layer 13 may be provided between a substrate 11 and a resin layer 12 provided on the outer peripheral surface of the substrate 11.

### Substrate

The substrate has a conductive outer surface and functions as a support member of the developing roller and, in some cases, an electrode. A specific example of the substrate is preferably a solid cylindrical or hollow cylindrical shape.

A material composing the substrate may be appropriately selected from those known in the field of electrophotographic conductive members and materials that can be used as a relating developing roller and used. As an example, a metal represented by aluminum and stainless steel, a carbon steel alloy, a conductive synthetic resin, metals or alloys such as iron or copper alloys.

Furthermore, the material constituting the substrate may be subjected to oxidation treatment or plating treatment with chromium, nickel, or the like. As the type of plating, either electroplating or electroless plating may be used. From the viewpoint of dimensional stability, electroless plating is preferable. Examples of the type of electroless plating used here may include nickel plating, copper plating, gold plating, and other various kinds of alloy plating. The plating thickness is preferably 0.05 μm or more, and the plating thickness is preferably 0.1 to 30 μm in consideration of the balance between working efficiency and anti-corrosion ability.

A primer may be applied to the surface of the substrate in order to improve the adhesion between the substrate and the resin layer. As the primer, a known primer can be selected and used in accordance with the rubber material for forming the conductive layer, the material of the support body, and the like. Examples of the material of the primer include a thermosetting resin and a thermoplastic resin, and more specifically, materials such as a phenolic resin, polyurethane resin, an acrylic resin, a polyester resin, a polyether resin, and an epoxy resin can be used.

### Resin Layer

The developing roller has a resin layer on an outer surface of the substrate. For example, the resin layer is present on the outer surface of the developing roller. The resin layer may have a binder resin. As the binder resin of the resin layer in the developing roller, in order to suppress charge leakage from the toner to the developing roller, polyurethane is preferably used, and more preferably, polyurethane having a polycarbonate structure is used. In other words, the resin layer preferably contains a polyurethane, and more preferably contains a polyurethane having a polycarbonate structure. By having the polycarbonate structure, the surface strength becomes high, and the electrical resistance is caused to be in a good state, whereby the characteristics as the developing roller can be easily maintained through durability.

Furthermore, in order to sufficiently maintain a light load on the toner and wear resistance of the resin layer while suppressing charge leakage from the toner to the developing roller, it is more preferable to use polyurethane having a structure described below as the binder resin of the resin layer.

Preferably, the resin layer comprises a polyurethane, and the polyurethane satisfies at least two of the following (A), (B) and (C). The polyurethane may satisfy all the following (A), (B) and (C).
(A) The polyurethane has a structure represented by the following structural formula (1) in a molecule thereof;
(B) The polyurethane has one or both of a structure represented by the following structural formula (2), and a structure represented by the following structural formula (3) in a molecule thereof;
(C) The polyurethane has a structure represented by the following structural formula 4 in a molecule thereof.

That is, preferably, the polyurethane satisfies at least any one of the following:
At least having a structure represented by the structural formula (1), and a structure represented by the structural formula (2);
At least having a structure represented by the structural formula (1), and a structure represented by the structural formula (3);
At least having a structure represented by the structural formula (1), and a structure represented by the structural formula (4);
At least having a structure represented by the structural formula (2), and a structure represented by the structural formula (4); and
At least having a structure represented by the structural formula (3), and a structure represented by the structural formula (4).

Among them, preferably, the polyurethane at least has a structure represented by the structural formula (1), and a structure represented by the structural formula (4) in a molecule thereof in view of better fogging suppression and image density stability.

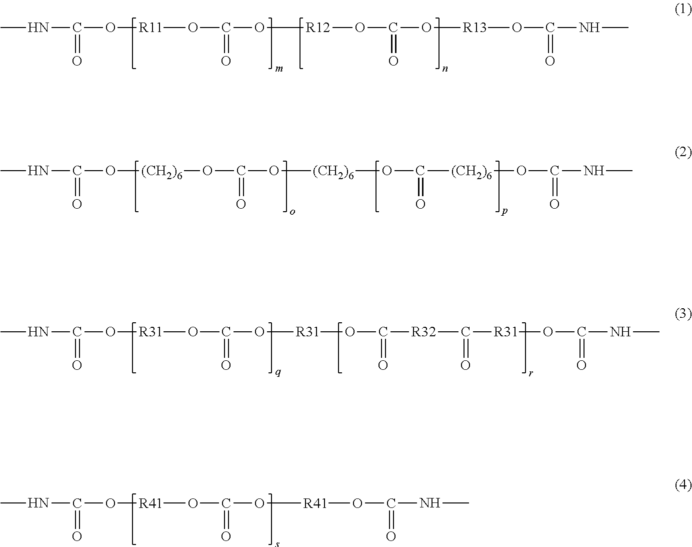

In the structural formula (1), R11, R12 and R13 represent C3-9 divalent hydrocarbon. Here, R11 and R12 are different from each other, and R13 is the same as at least one selected from the group consisting of R11 and R12. m and n are average addition mol numbers, and each independently represent a number of 1.0 or more (preferably 1.0 to 20.0, and more preferably 2.0 to 12.0).

In the structural formula (2), o and p are average addition mol numbers, and each independently represent a number of 1.0 or more (preferably 1.0 to 15.0, and more preferably 4.0 to 10.0).

In the structural formula (3), R31 and R32 each independently represent C3-8 divalent hydrocarbon. q and r are average addition mol numbers, and each independently represent a number of 1.0 or more (preferably 1.0 to 20.0, and more preferably 2.0 to 14.0).

In the structural formula (4), R41 represents C6-9 (preferably C5-8) divalent hydrocarbon. s is an average addition mol number, and represents a number of 1.0 or more (preferably 1.0 to 22.0, and more preferably 4.0 to 18.0).

A structure represented by the structural formula (1) is the structure obtained by reacting, with an isocyanate, a copolymerized polycarbonate polyol such that the crystallinity thereof is suppressed by bonding two carbonate groups by two different hydrocarbon groups. Because the crystallinity is suppressed, the cohesive energy in soft segments is less, and flexibility and a high volume resistivity can be given the resin layer.

The adhesiveness of the resin layer can be lowered by using, for the resin layer, a structure of the structural formula (1) in combination with any of structures of the structural formulae (2) to (4). Therefore, it can be suppressed that toner, powder, etc. adhere to the surface of the resin layer, a rise in electric resistance of the surface of the resin layer due to stains is suppressed, and the toner can be uniformly charged easily.

In the structural formula (1), R11 and R12 are each independently C3-9 divalent hydrocarbon. R11 and R12 are different from each other, and R13 is the same as at least one selected from the group consisting of R11 and R12.

When the carbon number of each of R11 and R12 is 3 or more, the amount of carbonate groups that are polar functional groups and that have more cohesive energy is not too large in the polyurethane, which makes it easy to keep the resin layer flexible and keep the electric resistance thereof high.

When the carbon number of each of R11 and R12 is 9 or less, the amount of the carbonate group in the polyurethane is not too small, which allows the strength of the polymer to be kept. R11 and R12 have different structures from each other; thereby the crystallinity of the polymer is suppressed, which allows the resin layer to be given flexibility. m and n each independently represent a number of 1.0 or more. The hydrocarbon groups represented by R11, R12 and R13 may each have a branching structure, and may each have a cyclic structure.

Structures represented by the structural formulae (2) and (3) are the structures each obtained by reacting, with an isocyanate, a copolymerized polyol formed by copolymerizing a polycarbonate structure and a polyester structure. The copolymerization of the polycarbonate structure and the polyester structure leads to suppressed crystallinity of the polymer, and the introduction of an ester group that has more cohesive energy than a carbonate group leads to moderately reinforced soft segments. Therefore, wear resistance can be given the resin layer.

When the resin layer is formed using a polymer that is the combination of a structure of the structural formula (1) or (4) with (a) structure(s) represented by the structural formula (2) and/or (3), a sufficient volume resistivity can be given the resin layer, whereas a polar ester group is included, which makes it easier to suppress charge leakage from toner to the developing roller.

In the structural formula (2), o and p each independently represent a number of 1.0 or more.

In the structural formula (3), R31 and R32 each independently represent C3-8 divalent hydrocarbon, and q and r each independently represent a number of 1.0 or more. When the carbon number of each of R31 and R32 is at least 3, the amount of carbonate groups and ester groups that are polar functional groups and that have more cohesive energy is not too large in the polyurethane, which allows the resin layer to be kept flexible. When the carbon number of each of R31 and R32 is 8 or less, the amount of the carbonate groups and the ester groups in the polyurethane is not too small, which allows the resin layer to be given wear resistance.

A structure represented by the structural formula (4) is the structure obtained by reacting, with an isocyanate, a polycarbonate polyol of high crystallinity which is formed by bonding two carbonate groups by a single hydrocarbon group. This structure has high crystallinity, and is easily arranged in a soft segment; therefore, allows wear resistance and a high volume resistivity to be given the resin layer. The formation of the resin layer by using a polymer that is the combination of a structure represented by the structural formula (4) with any of structures of the structural formulae (1) to (3) causes the hardness of the resin layer not to be too high, which cause appropriate control to be carried out easily.

In the structural formula (4), R41 represents C6-9 divalent hydrocarbon, and s represents a number of 1.0 or more. When the carbon number of R41 is 6 or more, the crystallinity easily develops, and wear resistance and a high volume resistivity can be given the resin layer. When the carbon number of R41 is 9 or less, excessive crystallinity can be suppressed. Therefore, by further comprising at least one of structures represented by the structural formulae (1), (2) and (3) in the polymer, rise in hardness of the resin layer can be suppressed.

The resin layer comprises, as a binder resin, a polymer having a urethane bond, that is, a polyurethane. Preferably, this polymer satisfies at least two selected from the group consisting of the aforementioned (A), (B) and (C). According to this, the resin layer has flexibility, and shows less wear.

The structure of the polymer comprised in the resin layer of the developing roller can be confirmed by, for example, analysis using pyrolysis GC/MS, FT-IR, or NMR.

A polyurethane can be produced using a polyol compound (A), and a polyisocyanate compound (B). Usually, polyurethane is synthesized using a method such as the following (1) and (2):
(1) The one-shot process of mixing and reacting a polyol component and a polyisocyanate component; and
(2) The method of reacting an isocyanate group-terminated prepolymer that is obtained by reacting part of a polyol and an isocyanate with a chain extender such as a small molecular diol and a small molecular triol.

In the present disclosure, the polyurethane may be synthesized by either of the aforementioned methods. More preferable is the method of subjecting a hydroxyl group-terminated prepolymer obtained by reacting a raw material polyol and an isocyanate, and an isocyanate group-terminated prepolymer obtained by reacting a raw material polyol and an isocyanate to a heat curing reaction.

Preferably, the polyurethane is a reaction product of the mixture comprising the hydroxyl group-terminated prepolymer and the isocyanate group-terminated prepolymer. This mixture can be used as a coating liquid for forming the resin layer. More preferably, the polyurethane is a reaction product of the mixture comprising the hydroxyl group-terminated prepolymer and the isocyanate group-terminated prepolymer, and a conductive filler and an additive.

When there are many hydroxyl groups, isocyanate groups, urea bonds, allophanate bonds, isocyanurate bonds, and the like, many polar functional groups are present in the polyurethane, and thus there are cases in which the absorbency of the polymer increases, leading to a decrease in the volume resistivity of the resin layer. Meanwhile, by heat-curing the hydroxyl group-terminated prepolymer and the isocyanate group-terminated prepolymer, a polyurethane with less unreacted polyol and polar functional groups can be obtained without using any excess isocyanate. For this reason, it is preferable from the viewpoint of further suppressing charge leakage from the toner to the developing roller.

### (A) Polyol Compound

As the polyol compound, as a use for the synthesis of a urethane resin, a polyol that is known or can be used for the synthesis of a urethane resin can be used. Examples of the polyol compound include the following. Polyolefin polyols such as polycarbonate polyols, polyether polyols, polyester polyols, polybutadiene polyols and polyisoprene polyols, so-called polymeric polyols obtained by polymerization of ethylenically unsaturated monomers among polyols, polyester polycarbonate co-polymerized polyol, and the like.

Among them, the polyol compound is preferably at least one selected from the group consisting of polycarbonate polyol and polyester polycarbonate co-polymerized polyol.

Examples of the polycarbonate polyols include polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random/block copolymers thereof.

Examples of the polyester polycarbonate copolymerized polyols include a copolymer obtained by polycondensing a lactone such as ε-caprolactone with any of the aforementioned polycarbonate polyols; and a copolymer with a polyester obtained by polycondensing a diol such as 1,4-butanediol, 1,5-pentanediol, 1,6-hexanediol, 3-methylpentanediol, and neopentylglycol, and a dicarboxylic acid such as adipic acid and sebacic acid.

### Polyisocyanate Compound (B)

A polyisocyanate as used herein is selected from generally used known polyisocyanates, and examples thereof include toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among them, more preferably used is an aromatic isocyanate such as toluene diisocyanate (TDI), diphenylmethane diisocyanate (MDI), polymeric diphenylmethane polyisocyanate, and polymeric MDI. Any other polyisocyanates can be used as long as not affecting the impedance value and the surface electric potential.

Preferably, the ratio of the number of the isocyanate groups to the number of the hydroxy groups (hereinafter also expressed as the “NCO/OH ratio”) is 1.0 to 2.0. When the NCO/OH ratio is 1.0 to 2.0, a crosslinking reaction proceeds to suppress “bleeding” of an unreacted content or a low molecular weight polyurethane. The NCO/OH ratio is more preferably 1.0 to 1.6. When the NCO/OH ratio is 1.0 to 1.6, bleeding is suppressed and the hardness of the polymer can be reduced.

The content of the polyurethane in the resin layer is not particularly limited, but is preferably 50 to 95 mass %, more preferably 60 to 80 mass %, and further preferably 65 to 75 mass %.

### Conductive Filler

Preferably, the resin layer comprises a conductive filler for obtaining conductivity. More preferably, an electron conductive agent is used as the conductive filler in the resin layer. Preferably, the electron conductive agent is a conductive particle showing electronic conductivity, and has a surface functional group that can be interactive with a functional group present in the undermentioned additive.

An example of electron conductive agents showing these characteristics is at least one selected from the group consisting of carbon blacks such as furnace black, thermal black, acetylene black, and ketjen black; electroconductive particles of metal oxides, such as titanium oxide surface-treated with an acidic functional group; and electroconductive particles of metals, such as aluminum and iron which are surface-treated with an acidic functional group.

Among them, at least one selected from the group consisting of carbon blacks having a surface functional group of high stability is preferably used. Preferably, the conductive filler comprises a carbon black. Further, the following carbon black is particularly preferably used for obtaining a desired impedance value and a desired surface electric potential: the number average diameter of the primary particle is 30 nm or less, the DBP absorption amount is 90 mL/100 g or less, and the pH is 4.0 or less, which allow a higher dispersion in the resin layer to be realized.

When the number average diameter of the primary particle of the carbon black is 30 nm or less, an aggregate that is the minimum unit by which the carbon black can disperse is small, and the structure (the size of a particle chain) is also small. Therefore, conduction paths are difficult to form. Therefore, a sufficiently high impedance is easily obtained. The primary particle diameter of the carbon black can be calculated by transmission electron microscopy (TEM). The smaller this number average diameter is, the more preferable, and the lower limit of this number average diameter is not particularly limited. For example, the number average diameter of the primary particle of the carbon black is 5 to 30 nm, and is more preferably 20 to 28 nm.

When the DBP absorption amount of the carbon black is not more than 90 mL/100 g, the structure of the carbon black is small, and conduction paths are difficult to form. Therefore, a sufficiently high impedance is easily obtained. The smaller this DBP absorption amount is, the more preferable, and the lower limit of this DBP absorption amount is not particularly limited. For example, the DBP absorption amount of the carbon black is 30 to 90 mL/100 g, and more preferably 40 to 60 mL/100 g.

When the pH of the carbon black is 4.0 or less, the effect of dispersion stability is obtained by the repulsion of the surface functional group of the carbon black, and the carbon black is difficult to agglomerate. Therefore, a sufficiently high impedance is easily obtained. The lower the pH of the carbon black is, the more preferable, and the lower limit of this pH is not particularly limited. For example, the pH of the carbon black is 2.0 to 4.0, and more preferably 2.2 to 2.8.

However, in some cases, sufficient dispersion cannot be obtained completely, and a desired impedance cannot be obtained when a polycarbonate-urethane is used as the binder resin although the number average diameter of the primary particle, the DBP absorption amount, and the pH of the carbon black are within the foregoing ranges. The reason why the carbon black having desired raw material physical properties cannot disperse when a polycarbonate-urethane is used as the binder resin is not clearly found. However, the conjecture about this is as follows.

A hydroxyl group that is a surface functional group of the carbon black tends to interact with a hydroxyl group at an end of a polycarbonate diol. In contrast, the structure of bonding a carbonate bond and a hydrocarbon group which is present between two hydroxyl groups of a polycarbonate diol is hydrophobic because of the presence of the hydrocarbon group, and then tends not to interact with the carbon black. The structure is stabler when a hydrophobic group is present close to another hydrophobic group, and a hydrophilic group is present close to another hydrophilic group. Then, a hydrophilic aggregate of the carbon black is present in the vicinity of another hydrophilic aggregate of the carbon black. As a result, the carbon black tends to agglomerate, and is considered to be difficult to disperse.

More preferably, the undermentioned additive is added for sufficiently dispersing the carbon black having a number average diameter of the primary particle, a DBP absorption amount, and a pH within the foregoing numerical ranges when a polycarbonate-urethane is used as the binder resin.

Desirably, the carbon black is added so as to lead to a desired volume resistivity. The content of the carbon black is preferably 30 parts by mass or less to 100 parts by mass of the polyurethane forming the resin layer. This content is more preferably 10 to 30 parts by mass, and further preferably 15 to 25 parts by mass.

When the content of the carbon black is 30 parts by mass or less, an appropriate distance between aggregates of the carbon black in the coating liquid is kept, and the probability of collision of aggregates of the carbon black due to Brownian motion or the like is lowered, which makes the carbon black difficult to agglomerate. Then, the carbon black easily disperses, and the dispersion stability also becomes better. As a result, the carbon black well disperses in the resin layer made by forming the film of the coating liquid.

To achieve the aforementioned specific impedance and surface electric potential, preferably, the dispersion of the carbon black is controlled. For the dispersed particle size of the carbon black, preferably, the arithmetic mean value Rc of the circle-equivalent diameters of the carbon black in the resin layer is 60.0 nm or less. When the standard deviation of the circle-equivalent diameter is defined as σc [nm], more preferably, σc/Rc is 0.000 to 0.650.

For the distance between aggregates of the carbon black, more preferably, the arithmetic mean value d of the distances between wall surfaces of the carbon black in the resin layer is 80.0 to 150.0 nm, and when the standard deviation of the distance between the wall surfaces is defined as σd [nm], σd/d is 0.000 to 0.600.

The reason why both high impedance and low surface electric potential are easily achieved in a case in which the circle equivalent diameter described above is in the numerical range of the distance between wall surfaces described above is assumed as below.

When the dispersed particle size is large, there are locations at which the distance between wall surfaces is short and a conductive path can be easily formed, whereby the impedance and the surface electric potential become low. On the other hand, when the dispersed particle size is small, the distance between wall surfaces becomes uniformly short, and the resistance becomes high not to enable formation of a conductive path, whereby the impedance becomes high. In the surface electric potential, local accumulation of charge is less likely to occur, and the surface electric potential can be lowered.

Note that a plurality types of carbon blacks may be used in combination so long as they do not affect the impedance value and the surface electric potential. The arithmetic mean value Rc of the circle-equivalent diameters is more preferably 40.0 to 60.0 nm, and further preferably 45.0 to 55.0 nm. σc/Rc is more preferably 0.500 to 0.650, and further preferably 0.550 to 0.650.

The arithmetic mean value Rc and standard deviation σc of the circle-equivalent diameter can be changed according to, for example, the state of the dispersion in a mill or the like when the coating liquid for forming the resin layer is made. Weaker dispersion tends to cause larger Rc and σc, and stronger dispersion tends to cause smaller Rc and σc. Since Rc usually converges, σc can be decreased while Rc remains almost constant above a certain dispersion state, and σc/Rc can be made smaller.

The arithmetic mean value d of the distances between wall surfaces is more preferably 90.0 to 120.0 nm, and further preferably 95.0 to 115.0 nm. σd/d is more preferably 0.500 to 0.600, and is further preferably 0.540 to 0.590.

The arithmetic mean value d and standard deviation σd of the distance between wall surfaces can be changed according to, for example, the state of the dispersion in a mill or the like when the coating liquid for forming the resin layer is made. Weaker dispersion tends to cause smaller d and larger σd, and stronger dispersion tends to cause larger d and smaller σd. Therefore, weaker dispersion tends to cause larger σd/d, and stronger dispersion tends to cause smaller σd/d.

### Additive

It is also one of preferable aspects to use an additive for much further improving the dispersibility of the carbon black in the binder resin using a polycarbonate-urethane. As an additive as used herein, for example, at least one compound selected from the group consisting of a compound having a structure represented by the following structural formula (5), a compound having a structure represented by the following structural formula (6), and a compound having a structure represented by the following structural formula (7) can be preferably used. One method of comprising the additive in the surface layer is the method of comprising a dispersing agent in the coating liquid for forming the surface layer. In the surface layer formed using the coating liquid for forming the surface layer which comprises at least one compound selected from the group consisting of the compound having a structure represented by the structural formula (5), and the compound having a structure represented by the structural formula (6), this compound may be incorporated in an end of the polymer chain of the polyurethane. Even in such a case, the effect of improving the dispersibility of the carbon black can be expected. However, preferably, it should be present in the surface layer independently from the polyurethane.

Among the compounds having structures represented by the structural formulae (5) to (7), the compound having a structure represented by the structural formula (5) is more preferably used because being particularly excellent in dispersibility of the carbon black, and affinity with a polycarbonate-urethane.

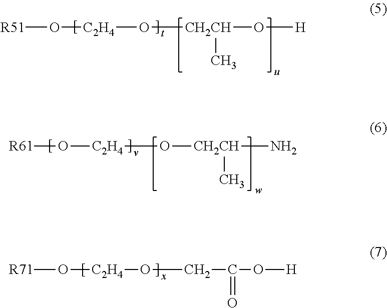

In the structural formula (5), R51 represents C1-12 (preferably C3-12) monovalent hydrocarbon. t and u are average addition mol numbers, and each independently represent a number of 1 or more (preferably 5 to 30, and more preferably 10 to 25).

In the structural formula (6), R61 represents C1-8 (preferably C1-4) monovalent hydrocarbon. v and w are average addition mol numbers, and each independently represent a number of 1 or more (preferably 1 to 30, and more preferably 5 to 30).

In the structural formula (7), R71 represents C1-12 monovalent hydrocarbon. x is an average addition mol number, and represents a number of 1 or more (preferably 1 to 30, and more preferably 4 to 15).

The structural formula (5) is a polyoxyethylene polyoxypropylene alkyl ether, and is a polyether monol having a structure of block addition polymerization of ethylene oxide and propylene oxide. A hydroxyl group at an end of this polyether monol interacts with the surface functional group of the carbon black, which is a conductive filler, by a hydrogen bond, to act as a dispersing agent of the carbon black. The structure of the structural formula (5) is also highly compatible with a polycarbonate-urethane to enhance the effect as a dispersing agent of the carbon black.

Ethylene oxide is introduced in the structure in order for the additive to be uniformly present in the polycarbonate-urethane. This is considered to be because the ethylene group in ethylene oxide is highly compatible with the hydrophobic hydrocarbon group in polycarbonate-urethane. Propylene oxide is introduced in the structure for improving the dispersibility of the conductive filler dispersing in the resin layer. This is considered to be because the interaction of the side chain methyl group of propylene oxide with the conductive filler improves the dispersibility of the conductive filler.

R51, which is C1-12 monovalent hydrocarbon, is introduced in the structure in order for the additive to be uniformly present in the polycarbonate-urethane. The monovalent hydrocarbon group causes high compatibility with the hydrophobic hydrocarbon group in the polycarbonate-urethane, and allows the additive to be uniformly present in the polycarbonate-urethane. The carbon number of 12 or less causes less steric hindrance with the polycarbonate-urethane, and makes it easy for the additive to be present uniformly.

The compound of the formula (5) has a monol structure, thereby, has poorer reactivity than diol, and is difficult to be taken in during the urethane-forming reaction caused by the reaction of an isocyanate and a polyol, which makes it difficult to invite the resistance reduction of the polyurethane caused by the introduction of an ether structure into the polycarbonate-urethane.

The polyoxyethylene polyoxypropylene alkyl ether can be obtained by using a commercially available product, or by synthesis. The polyoxyethylene polyoxypropylene alkyl ether can be synthesized by performing the step (B) after the step (A) as follows. The step (B) may be performed on a commercially available product having a structure on which the step (A) has been completed.
Step (A): Reaction of an alcohol and ethylene oxide
Step (B): Reaction of the product obtained by the step (A), and propylene oxide

In the step (A), the reaction can proceed by adding ethylene oxide to an alcohol at 50 to 200° C., more preferably at 100 to 160° C. in the presence of a catalyst. The boiling point of ethylene oxide is 10.7° C. Therefore, ethylene oxide is a gas at the foregoing temperatures. Therefore, preferably, the reaction is carried out under the environment where pressure is applied in a sealed container. The pressure is preferably 0.1 to 1.0 MPa. The reaction time is not particularly limited, but is preferably approximately 1 to 3 hours for reducing an unreacted content of ethylene oxide.

As the catalyst, an acid catalyst or an alkaline catalyst may be used, but an alkaline catalyst is preferable for facilitating purification after the completion of the reaction. Examples of an alkaline catalyst as used herein include: alkali metal hydroxides such as sodium hydroxide and potassium hydroxide; alkaline earth metal hydroxides such as calcium hydroxide and barium hydroxide; ammonium hydroxide; and tertiary amines. Sodium hydroxide and potassium hydroxide are particularly preferable in view of easiness and efficiency of the reaction. Examples of an acid catalyst as used herein include Brønsted acids such as sulfuric acid and phosphoric acid, and Lewis acids such as stannic chloride and boron trifluoride.

The use amount of the catalyst when the catalyst is sodium hydroxide or potassium hydroxide is preferably 0.1 to 5 mol % to 1 mol of an alcohol. The reaction of ethylene oxide with water generates ethylene glycol. Therefore, care must be taken to reduce a moisture content as much as possible. Dehydration may be performed before the reaction of the step (A) if necessary.

The step (B) can be performed under the same conditions as in the step (A). The boiling point of propylene oxide is 34.2° C. Then, propylene oxide is a gas at the reaction temperature of 50 to 200° C. Therefore, preferably, the reaction is carried out under the environment where pressure is applied in a sealed container. For the catalyst, the catalyst used in the step (A) may be used as it is, or a catalyst may be newly added. Preferably, the catalyst used in the step (A) is newly added.

The structural formula (6) is a polyetheramine (monoamine) having a structure of block addition polymerization of ethylene oxide and propylene oxide. An amino group at an end of this polyetheramine interacts with the surface functional group of the carbon black, which is a conductive filler, by a hydrogen bond, to act as a dispersing agent of the carbon black. For enhancing the effect as a dispersing agent, the introduction of R61, which is C1-8 monovalent hydrocarbon, leads to the structure easily showing an affinity with the hydrophobic functional group of the polycarbonate-urethane, and also highly compatible with the polycarbonate-urethane.

The polyether monoamine can be obtained by using a commercially available product, or by synthesis. The polyether monoamine can be synthesized by performing the step (D) after the step (C) as follows.
Step (C): Oxidation reaction of the compound of the structural formula 5 which is a secondary alcohol
Step (D): Reductive amination reaction of the product obtained by the step (C)

The step (C) is the reaction of generating a ketone by the oxidation reaction of a secondary alcohol. In the synthesis of a ketone by the oxidation of a secondary alcohol, the oxidation reaction using a heavy metal salt such as chromic acid and manganese dioxide, and derivatives thereof, or the oxidation reaction of a non-heavy metal salt using dimethylsulfoxide (DMSO), or a hypohalogenite such as hypochlorous acid is used.

The synthesis may be performed using either of the reactions. In view of the environmental impact of heavy metals, the oxidation reaction using dimethylsulfoxide (DMSO), or a hypohalogenite such as hypochlorous acid is preferable. Further, the reaction with dimethylsulfoxide (DMSO) explosively proceeds at room temperature according to a used electrophilic activating reagent, and therefore, low temperature of −60° C. is necessary. Therefore, the method using a hypohalogenite is more preferable. Examples of a hypohalogenite as used herein include hypochlorites such as sodium hypochlorite and calcium hypochlorite (bleaching powder). A ketone is obtained by reacting such a hypochlorite with a secondary alcohol in acetic acid.

When dimethylsulfoxide (DMSO) is used, an electrophilic activating reagent is also necessary other than this. An electrophilic activating reagent improves the electrophilicity of sulfur in dimethylsulfoxide (DMSO), and thereby, dimethylsulfoxide (DMSO) is subjected to a nucleophilic attack by an alcohol hydroxyl group. This nucleophilic attack leads to the formation of a dimethyl alkoxysulfonium salt. This dimethyl alkoxysulfonium salt decomposes, and then, a ketone and dimethyl sulfide are obtained. Examples of an electrophilic activating reagent as used herein include dicyclohexylcarbodiimide (DCC), acetic anhydride, phosphorus pentoxide, pyridine sulfur trioxide complex, trifluoroacetic anhydride, oxalyl chloride, and halogens.

The step (D) is the reductive amination reaction of converting the ketone into an amine. This reaction includes separate two stages. First, a carbonyl group and an amine react with each other to generate an iminium cation. Next, the iminium cation is subjected to a nucleophilic attack of a hydride reducing agent to generate an amine. As the reducing agent, a borohydride reagent is preferably used. Examples of a borohydride reagent as used herein include sodium cyanoborohydride, sodium triacetoxyborohydride, and 2-picoline borane. Among them, sodium triacetoxyborohydride, and 2-picoline borane that have low toxicity are preferable. In the reductive amination reaction by the use of a borohydride reagent, a bulky structure causes difficulty in the formation of the iminium cation due to steric hindrance. Therefore, R61 in the structural formula (6) is preferably C1-8 monovalent hydrocarbon.

The structural formula (7) is a polyoxyethylene alkyl ether acetic acid. Carboxylic acid at an end of the structural formula (7) interacts with the surface functional group of the carbon black, which is a conductive filler, by a hydrogen bond, to act as a dispersing agent of the carbon black. For enhancing the effect as a dispersing agent, the introduction of R71, which is C1-12 monovalent hydrocarbon, leads to the structure easily showing an affinity with the hydrophobic functional group of the polycarbonate-urethane, and also highly compatible with the polycarbonate-urethane.

The polyoxyethylene alkyl ether acetic acid can be obtained by using a commercially available product, or by synthesis. The polyoxyethylene alkyl ether acetic acid can be synthesized by performing the step (F) after the step (E) as follows. The step (F) may be performed on a commercially available product having a structure on which the step (E) has been completed.
Step (E): Reaction of an alcohol and ethylene oxide
Step (F): Oxidation reaction of a primary alcohol that is the product by the step (E)

The step (E) is the same as the step (A). In the step (E), production can be performed in the same manner as in the step (A).

The step (F) is the step of oxidizing a primary alcohol to generate carboxylic acid. In the oxidation of a primary alcohol, an aldehyde is generated, and thereafter carboxylic acid is generated by further oxidation. Then, it is necessary to select a reaction process and reaction conditions that do not stop the reaction at the stage where an aldehyde is generated. Examples of the process of obtaining carboxylic acid by the oxidation of a primary alcohol include oxidation by an oxidizing agent, and a catalytic dehydrogenation reaction by a catalyst. Examples of an oxidizing agent as used herein include permanganates, chromic acid, ruthenium tetroxide, and hypochlorites. Examples of a catalyst for the dehydrogenation reaction includes palladium, platinum, iridium, rhodium, and manganese.

The compounds represented by the structural formulae (5) to (7) each have the function as a dispersing agent of the carbon black, and show a high affinity with the polycarbonate-urethane. Generally, a surfactant is used as a measure to improve dispersibility and dispersion stability of carbon black. However, the compounds represented by the structural formulae (5) to (7) each have a small number of the functional groups to act on a surface functional group of carbon black, and therefore, weak effect of surface activity, and are not generally used. As general dispersing agents for carbon black, coupling agents, and non-ionic surfactants are practically used.

As coupling agents used as general dispersing agents for carbon black, silane coupling agents, titanate-based coupling agents, and aluminum-based coupling agents are used. As non-ionic surfactants used as general dispersing agents for carbon black, polyester-based or polyether-based non-ionic surfactants are used. However, when any of these dispersing agents are added to such an extent that the dispersibility of the carbon black can be sufficiently improved in the polycarbonate-urethane (50% to 100% to the carbon black in mass ratio), the conductivity of the carbon black and the binder resin are inhibited. On the contrary, when the adding amount of this dispersing agent is such an extent that the conductivity of the carbon black and the binder resin are not inhibited (10% to 40% to the carbon black in mass ratio), the dispersibility of the carbon black cannot be obtained.

The adding amount of the compounds represented by the structural formulae (5) to (7) is preferably 3.0 to 7.0 mass %, and more preferably 3.0 to 5.0 mass % on the basis of the solid content of the coating for forming the surface layer; and the total content thereof is preferably 18.9 to 46.0 parts by mass to 100 parts by mass of the carbon black in the coating for forming the surface layer.

The content of the additive in the coating for forming the surface layer is within the above range; thereby, the dispersibility of the carbon black in the polyurethane is much further improved, and desired impedance value and surface electric potential can be more easily achieved.

Confirmation of the presence of additives in the resin layer and quantitative evaluation can be analyzed using the following method. The resin layer of the developing roller is cut out, and the slice is analyzed using, for example, ¹H-NMR, ¹³CNMR, XPS, and FT-IR. In accordance with this, the carbonate structure of the binder resin, the ether structure of the additive, the amine structure, and the carboxylic acid structure can be detected in the resin layer, and the ratio can be calculated from the ratio of peaks and the like.

The slices are also immersed overnight in an organic solvent such as 2-butanone (methyl ethyl ketone; MEK) and are extracted, and both the extract solution and the extracted slices are analyzed using ¹H-NMR, ¹³C-NMR, XPS, and FT-IR. In accordance with this, the ratio of incorporated additives to unincorporated additives during the polymerization reaction of the resin can be calculated.

The resin layer may have a structure in which at least one of compounds having structures represented in structural Formulas (5) and (6) is bonded to a polyurethane (a structure reacted at the time of polymerization of the polyurethane). The structure reacted at the time of polymerization of the polyurethane includes, for example, the following aspects.
In the case of the structure represented by structural Formula (5), in the polyurethane, a compound having the structure shown in structural Formula (5) is urethanized
In the case of the structure represented by structural Formula (6), in the polyurethane, a compound having the structure shown in structural Formula (6) is ureated

### Roughening Particle

The resin layer may comprise a roughening particle. The roughening particle may be, for example, a spherical particle. The particle diameter of the roughening particle is, for example, preferably in the range of 1 to 150 μm, and more preferably in the range of 5 to 30 μm. An example of the roughening particle is at least one spherical particle selected from the following particles:

Urethane resin particle, acrylic resin particle, phenolic resin particle, silicone resin particle, polyacrylonitrile resin particle, polystyrene resin particle, polyurethane resin particle, nylon resin particle, polyethylene resin particle, and polypropylene resin particle; and preferably urethane resin particle.

The content of the roughening particle is preferably 1 to 20 mass %, and more preferably 5 to 15 mass % in the resin layer.

The developing roller may have an elastic layer on the outer surface of a substrate. The developing roller has, for example, an elastic layer between a substrate and a resin layer. The elastic layer is not particularly limited, and a known elastic layer of the developing roller may be used. An example of the elastic layer may be, for example, a cured product of an addition-curable liquid silicone rubber mixture.

### Production Method

The method of forming the resin layer is not particularly limited. Examples of the method include the methods by spraying using a coating, dip coating, and roll coating. For example, the resin layer can be formed by applying a coating liquid for forming the resin layer onto the substrate or the elastic layer formed over the outer surface of the substrate by a known method, and heat-drying the resultant. The heat-drying conditions are not particularly limited. An example is the method of drying under the condition of 120 to 200° C. The thickness of the resin layer is not particularly limited, either, but is preferably 1 to 50 μm, and more preferably 5 to 20 μm.

### Developing Apparatus

A developing apparatus according to the present disclosure includes a toner, a toner carrying member, and a charge injection member. As the charge injection member, the volume resistivity is preferably 1.0×10⁸ Ω·cm or less and is more preferably 1.0×10⁶ Ω·cm or less. The volume resistivity of the charge injection member is preferably 1.0×10⁻⁸ to 1.0×10⁸ Ω·cm and is more preferably 1.0× 10⁻⁶ to 1.0×10⁶ Ω·cm.

Further, the shape of the charge injection member is not particularly limited, and it is necessary that the charge injection member can be brought into contact with the toner carrying member. In this respect, a developing blade or the like is preferable as the charge injection member. The developing blade may be a charge injection member and a toner layer thickness control member.

### Process Cartridge and Electrophotographic Image Forming Apparatus

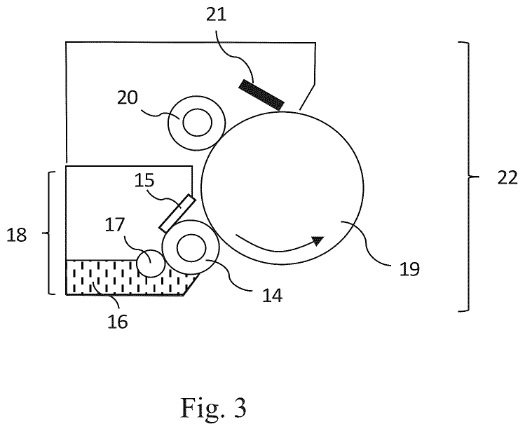

The developing roller according to the present disclosure can be appropriately used as a developing roller in a process cartridge. The process cartridge includes the developing apparatus according to the present disclosure. FIG. 3 is a schematic sectional view of an example of the process cartridge according to one aspect of the present disclosure. A process cartridge 22 is configured to be attachable and detachable to the main body of the electrophotographic image forming apparatus. The process cartridge 22 includes a developing apparatus 18 provided with a developing roller 14 and a developing blade 15 (charge injection member); a photoreceptor 19; a charging roller 20; and a cleaning blade 21, which are integrated together. The developing apparatus 18 is further filled with a toner 16. The toner 16 is supplied to the surface of the developing roller 14 by the toner supply roller 17, and a layer of the toner 16 having a predetermined thickness is formed on the surface of the developing roller 14 by the developing blade 15.

The developing roller 14 is in contact with the photoreceptor 19 and is driven to rotate at a predetermined peripheral speed ratio with respect to the photoreceptor 19. A predetermined bias is applied to the developing roller 14 to develop and visualize the electrostatic latent image on the photoreceptor 19 using the toner 16.

The toner supply roller 17 is in contact with the developing roller 14, penetrates in a predetermined penetration level, and rotates in either the same direction as the rotational direction of the developing roller 14 or a direction opposite thereto. In addition, a predetermined bias is applied to the toner supply roller 17.

One end of the developing blade 15 is fixed to the developing apparatus 18, and the other free end is arranged in contact with the developing roller 14 in a counter direction to the rotational direction of the developing roller 14. By arranging the developing blade 15 in contact with the developing roller 14, the amount of the toner on the developing roller 14 is regulated and made thin to form a toner layer having a uniform thickness. A predetermined bias is applied to the developing blade 15 to charge the toner 16.

The developing apparatus has a developing roller 14 and a toner 16. In addition, the developing apparatus has a developing blade 15 that is a toner layer thickness control member that comes into contact with a developing roller 14 that is a toner carrying member and controls the layer thickness of toner 16 as the toner carried on the toner carrying member and a contact point that is electrically connected to the toner layer thickness control member. When the developing apparatus described above is mounted in the main body of an electrophotographic image forming apparatus, the contact point described above is electrically connected to a main body contact point of the main body of the electrophotographic image forming apparatus described above and allows a predetermined voltage to be able to be applied to the toner layer thickness control member. The volume resistivity of the toner layer thickness control member is preferably 1.0×10⁶ Ω·cm or less. In accordance with this, by using the toner layer thickness control member, a toner layer of a uniform thickness is formed on the toner carrying member, and at the same time, electric charge can be injected from the toner layer thickness control member into the toner, and thus the amount of charging of the toner can be easily controlled to be uniform.

As described above, the developing blade can serve as both the charge injection member and the toner layer thickness control member. In other words, the charge injection member and the toner layer thickness control member may be the same member.

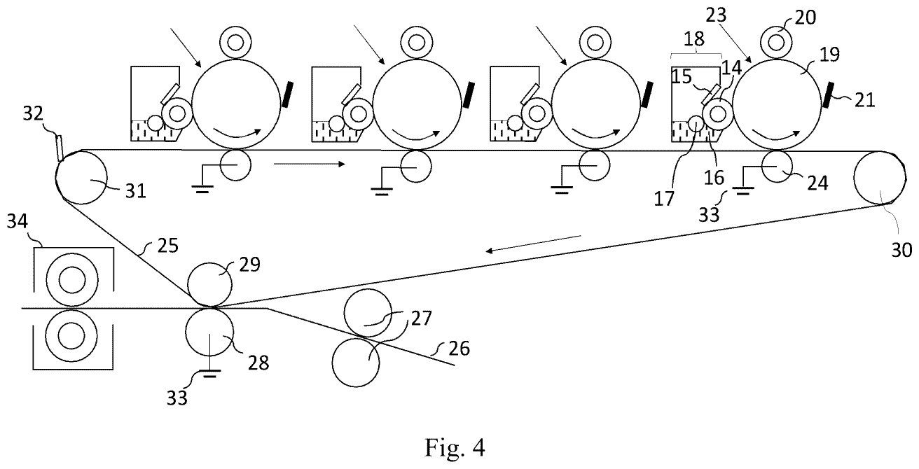

An electrophotographic image forming apparatus includes a developing apparatus. FIG. 4 is a schematic cross-sectional view showing an example of an electrophotographic image forming apparatus including a contact-type developing apparatus using single-component toner.

Each of the developing apparatuses 18 comprises the toner 16 as a single-component toner, the developing roller 14, the toner supply roller 17 to supply the toner to the developing roller 14, and the developing blade 15 to regulate the thickness of the toner layer over the developing roller 14. The developing roller 14 is positioned at an opening part that is present as extending in the longitudinal direction in the developing apparatus 18, and is placed to be in contact with the photosensitive member 19. The main body of the electrophotographic image forming apparatus may be equipped with the photosensitive member 19, the charging roller 20, and the cleaning blade 21. The colored toners of black, cyan, magenta, and yellow are prepared in the developing apparatuses 18, respectively, which enables color printing.

Hereinafter the printing operation of the electrophotographic image forming apparatus will be described. Each of the photosensitive members 19 rotates in the direction indicated by the arrow, and is uniformly charged by the charging roller 20 for charging the photosensitive member 19. Next, an electrostatic latent image is formed on the surface of the photosensitive member 19 by a laser light 23 that is an exposure measure. The toner 16 is applied to the electrostatic latent image by the developing apparatus 18 from the developing roller 14 arranged to be in contact with the photosensitive member 19; thereby, the electrostatic latent image is visualized (developed) as a toner image. This development is so-called reversal development such that a toner image is formed on an exposure part.

The toner image formed on the photosensitive members 19 is transferred onto an endless belt-shaped intermediate transfer member 25 by transfer rollers 24 that are transfer members.

Paper 26 that is a recording medium is fed into the apparatus by sheet-feeding rollers 27 and a secondary transfer roller 28, and is conveyed to a nip portion between the secondary transfer roller 28 and a driven roller 29 together with the intermediate transfer member 25 having the toner image, and the toner image is transferred on the paper 26. The intermediate transfer member 25 is operated by the driven roller 29, a driver roller 30, and a tension roller 31. The toner remaining on the intermediate transfer member 25 is cleaned by a cleaning device 32.

A voltage is applied from bias power sources 33 to the developing rollers 14, the developing blades 15, the transfer rollers 24, and the secondary transfer roller 28. The paper 26 onto which the toner image is transferred is subjected to a fixing treatment by a fixing apparatus 34, and discharged to the outside of the apparatus, and the printing operation is completed. Meanwhile, transfer residual toners remaining on the photosensitive members 19 without being transferred are scraped off by the cleaning blades 21 that are cleaning members for cleaning the surfaces of the photosensitive members. The cleaned photosensitive members 19 repeatedly perform the foregoing printing operation.

Hereinafter, a method of measuring physical properties of the toner, the developing roller, and each material will be described.

### Method of Calculating Presence Ratio of Titanium Element Using X-Ray Photoelectron Spectroscopy

The presence ratio of the titanium element is calculated by measuring the toner under the following conditions.
Measuring Device:X-ray photoelectron spectroscopy:Quantum 2000 (manufactured by ULVAC-PHI, Inc.)
X-ray source:Monochromic Al·Kα
X-ray Settings:100 μmφ (25 W (15 kV))
Photoelectronic Take-off angle:45 degrees
Neutralization conditions:A combination of a neutralizing gun and an ion gun
Analysis region:300 μm×200 μm
Pass Energy:58.70 eV
Step size:0.125 eV
Analysis Software:Multipak (PHI)

A method of determining a quantitative value of a titanium element through analysis will be described below. First, a peak derived from the C—C bond of the carbon 1s orbital is corrected to 285 eV. Thereafter, the amount of Ti derived from the Ti element with respect to the total amount of the constituent elements is calculated from a peak area derived from the Ti 2p orbital in which a peak top is detected at 452 to 468 eV by using the relative sensitivity factor provided by ULVAC-PHI, Inc., and the value is set to the presence ratio (atomic %) of the Ti element on the surface of the toner.

### Method of Measuring Fixing Ratio of Titanium Atom-Containing Fine Particles

The fixing ratio (%) is calculated from the ratio of the amount of titanium elements between the toner treated with the dispersion and initial toner before treatment using the following method. Treatment in the dispersion is as follows.

### Dispersion Treatment

160 g of sucrose (manufactured by Kishida Chemical Co., Ltd.) is added to 100 mL of ion exchanged water and dissolved in hot water to prepare a sucrose concentrate. 31 g of the sucrose concentrate and 6 mL of CONTAMINON N (a 10% by mass aqueous solution of a neutral detergent for washing a precision measuring instrument having a pH of 7 composed of a nonionic surfactant, an anionic surfactant, and an organic builder, manufactured by Wako Pure Chemical Industries, Ltd.) are put into a centrifuge tube (capacity: 50 mL) to produce a dispersion. 1.0 g of the toner is added to this dispersion, and massing of the toner is loosened with a spatula or the like.

The centrifuge tubes are shaken using a shaker (KM Shaker, manufactured by Iwaki Sangyo Co., Ltd.) at 350 spm (strokes per minute) for 20 minutes. After shaking, the solution is transferred to a swing rotor glass tube (volume: 50 mL) and centrifuged using a centrifuge (Model H-9R, manufactured by Kokusan Co., Ltd.) at 3500 rpm for 30 minutes. Sufficient separation of the toner and the aqueous solution is visually confirmed, and the toner separated into the uppermost layer is collected with the spatula or the like.

The collected toner-containing aqueous solution is filtered using a vacuum filtration device and then dried in a dryer for at least one hour to acquire the toner treated with the dispersion.

The toner treated with the dispersion is disaggregated using a spatula, and the amount of titanium element is measured using fluorescent X-rays. The fixing ratio (%) is calculated on the basis of the ratio of the amounts of elements of the toner treated with the dispersion described above and the measurement target of the initial toner.

Each element is measured with fluorescent X-rays according to JIS K 0119-1969 and specifically measured as described below.

As the measuring instrument, a wavelength dispersion type fluorescent X-ray analyzer “Axios” (manufactured by Malvern PANalytical Ltd.) and an attached dedicated software “SuperQ ver. 4.0F” (manufactured by Malvern PANalytical Ltd.) for setting measurement conditions and analyzing measurement data are used. Rh is used as the anode of the X-ray tube, the measuring atmosphere is set to a vacuum, the measuring diameter (collimator mask diameter) is set to 10 mm, and the measuring time is set to 10 seconds. In addition, detection is performed with a proportional counter (PC) in the case of measuring a light element and with a scintillation counter (SC) in the case of measuring a heavy element.

As a measurement sample, 1 g of the toner treated with the dispersion described above or the initial toner is put into a dedicated aluminum ring for pressing having a diameter of 10 mm, flattened, pressurized at 20 MPa for 60 seconds using a tablet molding compressor “BRE-32” (manufactured by Maekawa Testing Machine Mfg. Co., Ltd.), and molded to pellets having a thickness of 2 mm, and the pellets are used.

Measurement is performed under the above-described conditions, elements are identified on the basis of the resultant peak positions of the X-ray, and the concentrations thereof are calculated from the count rate (unit: cps) that is the number of X-ray photons per unit time.

As a method for determining the amount in the toner, for example, the titanium element of a certain amount is added such that titanium dioxide (TiO₂) fine particles are 0.5 parts by mass with respect to 100 parts by mass of the toner particles, and the mixture is sufficiently mixed using a coffee mill. Similarly, titanium oxide fine particles are mixed with the toner particle to be respectively at 2.0 parts by mass and 5.0 parts by mass, and these mixtures are used as samples for a calibration curve.

For each specimen, pellets of the specimen for a calibration curve are produced as described above using the tablet molding compressor, and the count rate (unit: cps) of a Ti-Kα ray that is observed at a diffraction angle (2θ)=109.08° at the time of using PET as a spectroscopic crystal is measured. At this time, the accelerating voltage and the current value of the X-ray generator are set to 24 kV and 100 mA, respectively. A calibration curve of a linear function is obtained with the resultant count rate of the X-ray indicated along the vertical axis and the amount of TiO₂ added in each specimen for a calibration curve indicated along the horizontal axis.

Next, the count rate of the Ti-Kα rays is measured using a pellet of the toner that is a measurement target. Then, the titanium content in the toner is determined from the calibration curve described above. The fixing ratio (%) is calculated as the ratio of the amount of the titanium element in the toner treated with the dispersion to the amount of the titanium element in the initial toner, as determined by the method described above.

$$Fixing ratio ( \% ) = Amount of titanium element in toner treated with dispersion / Amount of titanium in initial toner \times 100$$

### Method of Measuring Major Axis Length and Aspect Ratio of Titanium Atom-Containing Fine Particles

The major axis length and the aspect ratio of titanium atom-containing fine particles are measured using a scanning electron microscope (for example, a scanning electron microscope “S-4800” (product name; manufactured by Hitachi, Ltd.)). A toner to which titanium atom-containing fine particles are added is observed in a visual field enlarged at a maximum magnification of 50,000×, and the major axis length and the minor axis length of primary particles of 100 titanium atom-containing fine particles are randomly measured. Here, the aspect ratio of the titanium atom-containing fine particles is calculated using the following equation. The observation magnification is appropriately adjusted in accordance with the size of the titanium atom-containing fine particles. The number average value of the major axis lengths and the number average value of the aspect ratios of the 100 fine particles are calculated.

Aspect ratio of titanium atom-containing fine particles=major axis length of titanium atom-containing fine particle/minor axis length of titanium atom-containing fine particle

Method of Measuring Ratio NL/Nt of Toner at which Presence of Titanium Atom-Containing Fine Particles L on Surface can be Checked

The ratio of toner at which the presence of titanium atom-containing fine particles L on the surface can be checked is acquired using a scanning electron microscope (for example, a scanning electron microscope “S-4800” (product name; manufactured by Hitachi, Ltd.). In a visual field magnified about 3000 times such that 10 to 30 toners can be observed in one visual field, 50 toners are randomly observed. Toners to which the titanium atom-containing fine particles L having a major axis length of 100 to 3000 nm and an aspect ratio of 5.0 or more have been added are counted.

The number ratio of toners (NL) having one or more titanium atom-containing fine particles L present on the surface among 50 toners (Nt) is calculated, and the ratio of the toners at which the presence of titanium atom-containing fine particles L on the surface can be checked is set as NL/Nt. The observation magnification is appropriately adjusted in accordance with the size of the toner and the size of titanium atom-containing fine particles L.

Method of Measuring Ratio NLS/Nt of Toner at which Presence of Titanium Atom-Containing Fine Particles L and Titanium Atom-Containing Fine Particles S on Surface can be Checked

The ratio of toner at which the presence of titanium atom-containing fine particles L and titanium atom-containing fine particles S on the surface can be checked is acquired using a scanning electron microscope (for example, a scanning electron microscope “S-4800” (product name; manufactured by Hitachi, Ltd.). In a visual field magnified about 3000 times such that 10 to 30 toners can be observed in one visual field, 50 toners are randomly observed. Toners to which the titanium atom-containing fine particles L and the titanium atom-containing fine particles S have been added are counted.

The number ratio of toners (NLS) having one or more titanium atom-containing fine particles L and one or more titanium atom-containing fine particles S are present among 50 toners (Nt) is calculated, and the ratio of the toners at which the presence of both the titanium atom-containing fine particles L and the titanium atom-containing fine particles S on the surface can be checked is set as NLS/Nt. The observation magnification is appropriately adjusted in accordance with the size of the toner and the size of titanium atom-containing fine particles L and S.

### Method of Measuring Volume Resistivity

The volume resistivity of a sample is measured as follows.

A 6430 Sub-femto Ampere Remote Source Meter (manufactured by Keithley Instruments) is used as the measuring device. An SH2-Z four-terminal sample holder (manufactured by Bio-Logic Co.) is connected to a FORCE terminal of the device, and a 0.20 g sample is placed on an electrode part, and a distance between electrodes is measured in a state in which a load of 123.7 kgf is applied using a torque wrench.

The resistance value acquired when a voltage of 20 V is applied to the sample for one minute is measured, and the volume resistivity is calculated using the following equation.

$$Volume resistivity ( Ω \cdot cm ) = R \times S / L$$

(R: Resistance value (Ω), L: Inter-electrode distance (cm), S: Electrode area (cm²))

As a method of isolating the titanium element-containing fine particles from the toner, the toner is dispersed in a solvent such as chloroform, and thereafter, the fine particles can be isolated in accordance with a difference in specific gravity through centrifugation or the like. In a case in which the titanium element-containing fine particles can be obtained alone, the fine particles can be measured alone.

### Method for Measuring Glass Transition Temperature (Tg)

The glass transition temperature (Tg) of the binder resin, the toner, and the like is measured in compliance with ASTM D3418-82 using a differential scanning calorimeter “Q1000” (manufactured by TA Instruments Co.).

The melting points of indium and zinc are used to correct the temperature of the device detection unit, and heat of fusion of indium is used to correct the amount of heat.

More specifically, 5 mg of a sample is precisely weighed and placed in aluminum pan, and an empty aluminum pan is used as a reference.

Measurements are performed within the measurement range of 30° C. to 200° C. at a temperature raise speed of 1° C. per minute.

In this temperature raising process, a specific heat change is obtained in the range of temperatures 40° C. to 100° C.

An intersection between a line of midpoints of baselines before and after the occurrence of the specific heat change and the differential heat curve is defined as the glass transition temperature (Tg).

### Method for Measuring Particle Size Such as Volume-Based Median Diameter of Toner

The particle size such as a volume-based median diameter of the toner is calculated as follows. As the measurement device, a precision particle size distribution measurement device using a pore electrical resistance method “Coulter Counter Multisizer 3” (a registered trademark; manufactured by Beckman Coulter, Inc.) including an aperture tube of 100 μm is used. The setting of measurement conditions and the analysis of measurement data are performed using bundled dedicated software “Beckman Coulter Multisizer 3 Version 3.51” (manufactured by Beckman Coulter, Inc.). Note that the measurement is performed with an effective measurement channel number of 25,000 channels.

As an electrolyte aqueous solution used for the measurement, a solution prepared by dissolving special grade sodium chloride in deionized water to a concentration of about 1 mass %, for example, “ISOTON II” (commercially available from Beckman Coulter, Inc.) can be used.

Before the measurement and the analysis, the dedicated software is set as described below.

On the “standard measurement method (SOMME) change screen” of the dedicated software, the total count number in the control mode is set to 50,000 particles, the number of times of measurements is set to one, and the Kd value is set to a value obtained using “standard particle 10.0 μm” (manufactured by Beckman Coulter, Inc.). When the “threshold/noise level measurement button” is pressed, the threshold and the noise level are automatically set. In addition, the current is set to 1,600 μA, the gain is set to 2, the electrolyte solution is set to ISOTON II, and “flush aperture tube after measurement” is checked.

In the “Setting screen for converting pulse to particle diameter” in the dedicated software, the bin interval is set to the logarithmic particle diameter, the particle diameter bin is set to 256 particle diameter bin, and the particle diameter range is set to 2 μm to 60 μm.

A specific measurement method is as follows.

(1) 200 mL of the electrolyte aqueous solution described above is put into a 250 mL round-bottom glass beaker dedicated to Multisizer 3, which is set on a sample stand, and stirring rods are stirred counterclockwise at 24 rotations/sec. Then, contaminants and air bubbles in the aperture tube are removed by the function “flush aperture tube” in the dedicated software.

(2) 30 mL of the electrolyte aqueous solution described above is put into a 100 mL flat-bottom glass beaker. 0.3 mL of a diluted solution prepared by diluting “Contaminon N” (a 10 mass % aqueous solution of a neutral detergent with pH 7 for washing precision measurement instruments, containing a nonionic surfactant, an anionic surfactant, and an organic builder, commercially available from Wako Pure Chemical Industries, Ltd.) as a dispersing agent in 3 mass times of deionized water is added thereto.

(3) Two oscillators with an oscillating frequency of 50 kHz and with phases shifted by 180 degrees are incorporated, and an ultrasonic disperser “Ultrasonic Dispersion System Tetra150” with an electrical output of 120 W (manufactured by Nikkaki Bios Co., Ltd.) is prepared. Ion exchange water of 3.3 L is placed in a water tank of an ultrasonic dispersion device, and Contaminon N of 2 mL is added into the water tank.

(4) The beaker in (2) is set in a beaker fixing hole of the ultrasonic disperser, and the ultrasonic disperser is operated. Then, the height position of the beaker is adjusted so that the resonance state of the liquid surface of the electrolyte aqueous solution in the beaker is maximized.

(5) In a state in which the electrolyte aqueous solution in the beaker in (4) has been irradiated with ultrasonic waves, 10 mg of the toner is added little by little to the electrolyte aqueous solution and dispersed. In addition, an ultrasonic dispersion treatment is additionally continued for 60 seconds. Here, in the ultrasonic dispersion, the water temperature in the water tank is appropriately adjusted to be from 10° C. to 40° C.

(6) In the round-bottom beaker in (1) placed in the sample stand, the electrolyte aqueous solution in (5) in which the toner is dispersed using a pipette is added dropwise, and the measurement density is adjusted to 5%. In addition, the measurement is performed until the number of measurement particles reaches 50,000.

(7) The measurement data is analyzed using the dedicated software bundled with the device to calculate a volume-based median diameter.

### Composition Analysis of Binder Resin

Method for Separating Binder Resin from Toner

100 mg of the toner is dissolved in 3 ml chloroform. Next, the insoluble matter is removed by suction filtration with a syringe fitted with a sample treatment filter (pore size of from 0.2 μm to 0.5 μm, for example, using a Myshori Disk H-25-2 (manufactured by Tosoh Co.)). A soluble component is introduced into prep-HPLC (device: LC-9130 manufactured by Japan Analytical Industry Co., Ltd., two NEXT preparative columns [60 cm] exclusion limit: 20000, 70000 connected) and chloroform eluent is sent. When the peak can be checked through the acquired chromatographic display, the retention time at which the molecular weight is 2000 or more is collected in the monodispersed polystyrene standard sample. The acquired fraction solution is dried and solidified to obtain a binder resin.
Component Identification and Mass Ratio Measurement of Binder Resin Using Nuclear Magnetic Resonance Spectroscopy (NMR)

1 mL of deuterated chloroform is added to 20 mg of toner, and the proton NMR spectrum of the dissolved binder resin is measured. The molar ratio and the mass ratio of each monomer is calculated from the acquired NMR spectrum, and the content of constituent monomer units of a binder resin such as a styrene acrylic resin can be determined.

For example, in the case of a styrene-acrylic copolymer, the composition ratio and the mass ratio can be calculated on the basis of the peak near 6.5 ppm derived from a styrene monomer and the peak near 3.5 to 4.0 ppm derived from an acrylic monomer. In the case of a copolymer of a polyester resin and a styrene-acrylic resin, the molar ratio and the mass ratio of the peak derived from each monomer composing the polyester resin and the peak derived from the styrene-acrylic copolymer are calculated together.

### NMR Apparatus:JEOL Resonance Ecx500

### Observation Nuclei:Proton Measurement Mode:Single-Pulse Reference Peak:TMS

### Measurement of Weight Average Molecular Weight Mw, Number Average Molecular Weight Mn, and Peak Molecular Weight

A molecular weight distribution (a weight-average molecular weight Mw, a number average molecular weight Mn, and a peak molecular weight) of the resin and the like is measured as below using gel permeation chromatography (GPC).

First, a sample is dissolved in tetrahydrofuran (THF) at room temperature for 24 hours. Then, the obtained solution is filtered through a solvent-resistant membrane filter “Myshori Disk” (manufactured by Tosoh Corporation) with a pore size of 0.2 μm, thereby obtaining a sample solution. Note that the sample solution is adjusted so that a concentration of the component soluble in THF is 0.8 mass %. The sample solution is used to measure under the following conditions.

### Apparatus: HLC8120GPC (Detector: RI) (Manufactured by Tosoh Corporation)

Column: Seven connected Shodex KF-801, 802, 803, 804, 805, 806, and 807 columns (manufactured by Showa Denko)

### Eluent: Tetrahydrofuran (THF)

Flow Rate: 1.0 ml/min.
Oven temperature: 40.0° C.
Sample injection amount: 0.10 ml

In the calculation of the molecular weight of the sample, a molecular weight calibration curve created using a standard polystyrene resin (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

### Impedance of Developing Roller

In the impedance measurement, the response of the developing roller at the time of application of an AC voltage and a DC voltage is examined while changing the frequency. An AC voltage is applied, and responses are measured with being divided into two types of a response without a phase shift and a response with a phase shift of π/2 with respect to the applied AC voltage, the responses are plotted as a complex plane in which the impedance of the response without a phase shift is set as Z′ (real part) and the impedance of the response with a phase shift is Z″ (imaginary part), and a distance from the origin to the plot is calculated as an impedance value.

In a case in which the electrical characteristics of the developing roller are approximated using an RC parallel circuit, the real part without phase shift indicates a resistance component, and the imaginary part with a phase shift indicates an electrostatic capacitance component. Note that the meanings of the measurement conditions and measurement values have been described in the foregoing description of <Technical significance of Requirement (1)> and are omitted in this section.

The method for measuring the impedance of the developing roller, the measurement apparatus, and the measurement conditions are described below.

### Method for Measuring Impedance of Developing Roller

The impedance of the developing roller can be measured using methods represented in the following (1) and (2).

(1) A method in which a thin film electrode is provided on the surface of a developing roller, and measurement is performed using two terminals including the electrode and the substrate.

(2) A method in which a developing roller is pressed against a metal drum with a constant load, and measurement is performed using two terminals including the metal drum and the substrate.

Although the impedance can be measured in any one of the methods, the method (2) is affected by the width of the nip between the developing roller and the metal drum and a contact area and thus needs to perform measurement with a developing roller of which hardness is equivalent. For this reason, in the present disclosure, the measurement is performed using the method (1). Specific conditions are described below, since they are described in the following measurement method (1).

In measuring the impedance, in order to exclude the influence of the contact resistance between the developing roller and the measurement electrode, it is preferable to deposit a low-resistance thin film on the surface of the developing roller and measure the impedance using two terminals including the thin film as an electrode and a conductive substrate as a ground electrode.

Examples of the method for forming a thin film include metal film forming methods such as metal vapor deposition, sputtering, application of a metal paste, application of a metal tape, and the like. Among these, from the viewpoint of reducing the contact resistance with the developing roller, a method in which a thin metal film such as platinum or palladium is formed as an electrode through vapor deposition is preferable. In the present disclosure, vacuum platinum vapor deposition is employed.

In a case in which a metal thin film is formed on the surface of the developing roller, considering simplicity and uniformity of the thin film, it is preferable to use a vacuum vapor deposition apparatus in which a mechanism capable of gripping a developing roller is provided in a vacuum vapor deposition apparatus, and a rotating mechanism is further provided in the developing roller having a cylindrical cross-section.

It is preferable to form a metal thin film electrode having a width of about 10 mm in the longitudinal direction of the developing roller and to perform measurement by connecting a metal sheet wound around the metal thin film electrode in a direction intersecting the longitudinal direction without any gap to a measurement electrode coming out of a measurement device. In the case of a cylindrical developing roller, it is preferable to use a metal sheet wound around the developing roller without any gap in the circumferential direction. In accordance with this, the measurement can be performed without being affected by the deflection of the outer edge size (the outer diameter in a cylindrical developing roller) in a cross-section orthogonal to the longitudinal direction of the developing roller and the surface shape. As the metal sheet, an aluminum foil, a metal tape, or the like can be used.

### Impedance Measurement Condition of Developing Roller

The impedance measurement device may be a device capable of measuring impedance in a frequency range from 1.0×10⁻¹ to 1.0×10⁵ Hz such as an impedance analyzer, a network analyzer, a spectrum analyzer, or the like. Among these, it is preferable to perform measurement from the electrical resistance region of the developing roller using an impedance analyzer.

The impedance measurement conditions are described. By using an impedance measurement device, the impedance in the frequency region of 1.0×10⁻¹ to 1.0×10⁵ Hz is measured. As the measurement environment, the temperature is 23° C., and the relative humidity is 50%. An impedance measurement position is a central portion in the longitudinal direction of the developing roller. The voltage application condition is that an AC voltage of 50 V is superimposed on a DC voltage of 50 V.

More details are as follows.

First, as a pretreatment, vacuum platinum vapor deposition was performed on the developing roller while rotating to form a measurement electrode. For vapor deposition, a vacuum vapor deposition apparatus having a mechanism for gripping a base portion of a roller that is a film-forming object and rotating the roller in a circumferential direction was used, and by controlling the roller rotation speed, the deposition distance, and the deposition time, vapor deposition was performed such that the film thickness became 100 nm or more. At this time, by using a masking tape, an electrode with a width of 1.5 cm was produced. By forming this electrode with a film thickness of 100 nm or more, in accordance with surface roughness of the developing roller, the contribution of the contact area between the measurement electrode and the developing roller can be extremely reduced.

Next, an aluminum sheet was wound around the electrode without any gap, and this aluminum sheet was connected to measurement electrodes of an impedance measurement device (trade name: Soraltron 1260 and Soraltron 1296 manufactured by Soraltron Co.) and a high-voltage system (trade name: 6792 and HVA-500, manufactured by TOYO Corporation).

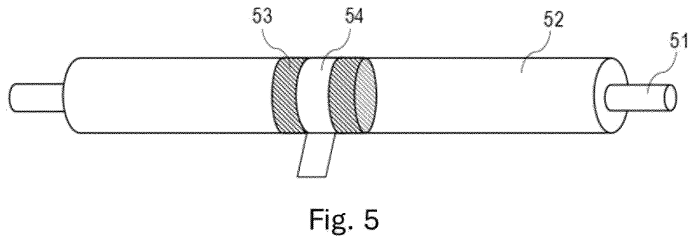

FIG. 5 is a schematic view showing a state in which the measurement electrode is formed on the developing roller. In FIG. 5, a conductive substrate 51, a resin layer 52, a platinum vapor-deposited layer 53, and an aluminum sheet 54 are illustrated. Although not shown in the drawing, an elastic layer is present between the substrate 51 and the resin layer 52.

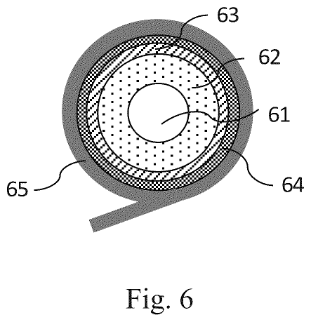

FIG. 6 shows a cross-sectional view of a state in which the measurement electrode is formed on the developing roller. A conductive substrate 61, an elastic layer 62, a resin layer 63, a platinum vapor deposition layer 64, and an aluminum sheet 65 are illustrated. As shown in FIG. 6, it is important to interpose the resin layer between the conductive substrate and the measurement electrode.

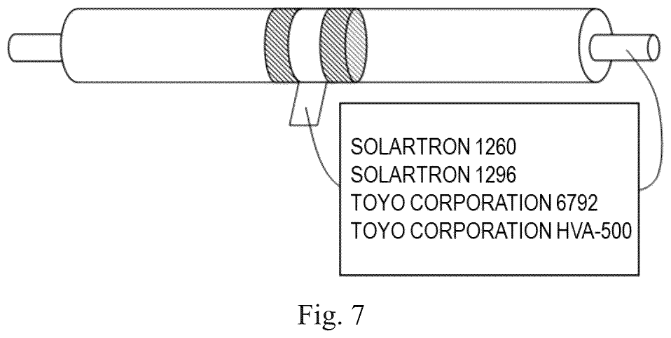

Then, the aluminum sheet was connected to measurement electrodes of an impedance measurement device (Soraltron 1260 and Soraltron 1296, manufactured by Soraltron Co.) and a high-voltage system (trade name: 6792 and HVA-500, manufactured by TOYO Corporation). FIG. 7 shows a schematic view of this measurement system. The impedance was measured by configuring the conductive substrate and the aluminum sheet as two electrodes for measurement.

In the measurement of impedance, by applying a DC voltage 50 V and an AC voltage of 50 V under the environment in which the temperature was 23° C. and the relative humidity was 50%, the absolute value of the impedance was obtained at the frequency of 1.0×10⁻¹ to 1.0×10⁵ Hz. Then, a minimum value of the impedance value at the frequency of 1.0×10⁰ to 1.0×10¹ Hz was checked. The impedance measurement position was a center portion in the longitudinal direction of the developing roller.

### Measurement of Surface Electric Potential

Under an environment in which the temperature is 23° C., and the relative humidity is 50%, by arranging a corona discharger with a grid portion of which the width is 3.0 mm such that a distance between the grid portion and the outer surface of the developing roller is 1.0 mm, and the widthwise direction of the grid portion coincides with the axial direction of the developing roller, charging the outer surface of the developing roller by applying the voltage of 8 kV to the grid portion and relatively moving the corona discharger in the axial direction of the developing roller at the speed of 400 mm/sec, and measuring the electric potential of the outer surface after 0.06 seconds from the passage of the grid portion, the degree of excessive charging (charge up) of the toner is evaluated.

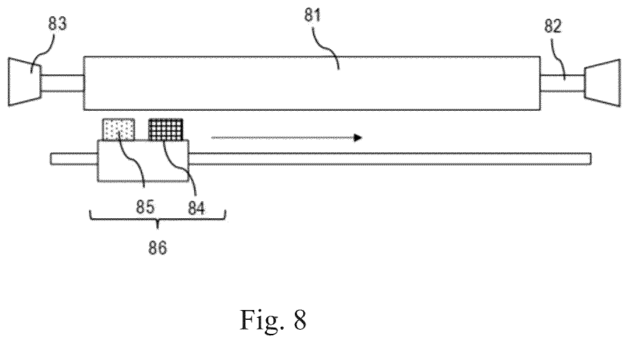

The surface electric potential of the developing roller, for example, can be measured by the apparatus illustrated in FIG. 8. Both end parts of the substrate 82 of the developing roller 81 are held by a chuck 83, and a measurement unit 86 in which a corona discharger 84 and a surface electrometer 85 are arranged in parallel at an interval of 25 mm is arranged to face the surface of the developing roller 81 at an interval of 1.0 mm distance. In a state in which the developing roller 81 is stopping, a voltage of 8 kV is applied to the grid portion of the corona discharger 84, the measurement unit 86 is moved in the axial direction of the developing roller 81 at a speed of 400 mm/sec, and the surface electric potential after 0.06 seconds from the passage of the corona discharger 84 is measured by the surface electrometer 85.

The meanings of the measurement conditions and the measurement values have been described in the foregoing description of <Technical significance of Requirement (2)> and thus are omitted in this section.

More details are as follows.

The surface electric potential of the developing roller was measured using a charging amount measurement apparatus (trade name: DRA-2000L, manufactured by Quality Engineering Associates, Inc.). More specifically, the grid portion of the corona discharger of the charging amount measurement apparatus was placed under an environment of temperature 23° C. and a relative humidity of 50% such that the interval between the grid portion and the outer surface of the developing roller is 1.0 mm. The grid portion of the corona discharger described above has a width of 3.0 mm.

Next, by applying a voltage of 8 kV to the corona discharger and relatively moving the corona discharger in the axial direction of the developing roller at a speed of 400 mm/second to charge the surface of the conductive member, the electric potential of the outer surface after 0.06 seconds from the passage of the grid portion was measured. A maximum value of all measured values obtained by performing measurement at eight positions in the longitudinal direction at every 45° in the circumferential direction of the developing roller was employed.

### Calculation of Physical Properties Such as Circle-Equivalent Diameter and Distance Between Wall Surfaces of Carbon Black Dispersed in Resin Layer

The circle-equivalent diameter and the distance between wall surfaces (inter-wall distance) of carbon black dispersed in the resin layer were measured using the following method.

First, a slice (with a thickness of 0.5 to 1.0 mm) is cut out using a razor so that a cross-section perpendicular to the longitudinal direction of the developing roller could be observed. In a case in which the adhesiveness between the substrate and the resin layer is high, and it is difficult to cut out the slices with a razor, the entire substrate is cut out with a metal saw or the like, and then cross-sectional processing is performed by a Focused Ion Beam (FIB) apparatus.

Next, the slice is then platinum-deposited, and a scanning electron microscope (SEM) (trade name: JSM-7800F, manufactured by JEOL Ltd.) is used to take images of the resin layer at 15,000× to obtain cross-sectional images.

Furthermore, in order to quantify the cross-sectional image obtained by SEM observation, 8-bit gray scaling is performed on the cross-sectional image using image processing software (trade name: Luzex AP, manufactured by NIRECO Corporation) to obtain a 256-gradation monochrome image. Next, after the black and white of the image is processed to be inverted such that the carbon black in the cross-sectional image becomes white, for the brightness distribution of the image, a threshold of binarization is set on the basis of the algorithm of the Otsu's thresholding method, and a binary image in which the carbon black is white, and the binder resin portion is black is acquired.

Then, the circle-equivalent diameter and the adjacent distance between wall surfaces of the carbon black portion that becomes white in the acquired binary image are calculated using image processing software (trade name: Luzex AP, manufactured by NIRECO Corporation). The circle-equivalent diameter and the distance between wall surfaces are calculated. In the image area, in order to exclude uncertainty in the calculated value of a carbon black that is divided at the top, bottom, left and right edges of the image, an area on the 0.075 μm inner side as an image actual dimension (in a case in which there is a text section describing SEM measurement conditions or the like, 0.075 μm inner side from a part at which the actual image starts) is set, and the circle-equivalent diameter and the adjacent distance between wall surfaces for all the carbon blacks inside of the designated image area are calculated.

Then, an arithmetic mean and a standard deviation are calculated for the distribution of the circle-equivalent diameters and the adjacent distance between wall surfaces that have been acquired. Although the number of images to be analyzed may be one, in order to exclude the influence of a difference in positions in the longitudinal direction of the carbon black dispersed in the resin layer of the developing roller and the like, the number of images is at least three or more.

In addition, the number average diameter of the primary particles of carbon black dispersed in the resin was measured by a transmission electron microscope (TEM). First, a thinned sample was produced. Known techniques can be used for thinning. For example, the sample can be thinned using an ion beam, a diamond knife, or the like. In the present disclosure, a thinning sample for observation having a thickness of 40 nm was produced using an ultra microtome (trade name: ULTRACUT-S, manufactured by Leica Microsystems Co., Ltd.).

Then, a TEM image was acquired under measurement conditions in which the mode is the TE mode, and the acceleration voltage is 100 kV using a transmission electron microscope (trade name: H-7100FA, manufactured by Hitachi Hitech Co., Ltd.).

Then, for the acquired TEM image, by using image analysis software (trade name: WinROOF, manufactured by Mitani Shoji Co., Ltd.), circle-equivalent diameters of 50 primary particles of carbon black in this TEM image were measured, and the number average value of 50 particles was set as the number average diameter of the primary particles.

### Measurement of DBP Absorption Amount of Carbon Black

The DBP absorption amount of carbon black was measured according to the Japan Industrial Standard (JIS) K6217-4 for the powder of the carbon black.

### Measurement of pH of Carbon Black

The pH of the carbon black was measured for the powder of the carbon black in accordance with ASTM D1512.

### EXAMPLES

Hereinafter, although the present disclosure will be described in more detail using examples, these do not limit the present disclosure at all.

### Production Example of Toner

### Production Example of Toner Particle 1

### Preparation Step of Aqueous Medium

14.0 parts of sodium phosphate (manufactured by Rasa Industries, Ltd., dodecahydrate) were added to 1000.0 parts of ion-exchanged water in a reaction vessel, and the vessel was kept warm at 65° C. for 1 hour while purging with nitrogen. By using T.K. homomixer (manufactured by Tokushu Kika Kogyo Co., Ltd.), an aqueous calcium chloride solution in which 9.2 parts of calcium chloride (dihydrate) were dissolved in 10.0 parts of ion-exchanged water was added together while stirring at 12000 rpm to prepare an aqueous medium containing a dispersion stabilizer. Furthermore, 10 mass % of hydrochloric acid was injected into the aqueous medium, and the pH was adjusted to 6.0, thereby obtaining an aqueous medium.

### Preparation Step for Polymerizable Monomer Composition

Styrene: 60.0 parts
C.I. pigment Blue 15:3: 6.5 parts

The materials were injected into an attritor (manufactured by Mitsui Miike Machinery Company, Limited) and further dispersed at 220 rpm for 5 hours using zirconia particles having a diameter of 1.7 mm, thereby preparing a pigment dispersion.

The following materials were added to this pigment dispersion.
Styrene: 11.0 parts
n-butyl acrylate: 29.0 parts
Cross-linking agent (divinylbenzene): 0.2 parts
Saturated polyester resin: 6.0 parts

(a condensation polymer of a propylene oxide-modified bisphenol A (2-mole adduct) and terephthalic acid (molar ratio=10:12), glass transition temperature Tg−68° C., weight-average molecular weight Mw=10,000, molecular weight distribution Mw/Mn=5.12)·
Fischer-Tropsch wax (melting point 78° C.): 10.0 parts
Charge control agent 0.5 parts

### (Aluminum Compound of 3,5-Di-Tert-Butylsalicylic Acid)

These were kept warm at 65° C. and uniformly dissolved and dispersed at 500 rpm using a T.K. homomixer (manufactured by Tokushu Kika Kogyo Co., Ltd.) to prepare a polymerizable monomer composition.

### Granulation Step

The polymerizable monomer composition was injected into the aqueous medium while the temperature of the aqueous medium was maintained at 70° C. and the rotation speed of the stirring device was maintained at 12000 rpm, and 9.0 parts of t-butyl peroxypivalate as a polymerization initiator were added thereto. While the rotation speed of the stirring device was maintained as it was at 12000 rpm, the polymerizable monomer composition was granulated for 10 minutes.

### Polymerization Step

The stirring device was changed from a high-speed stirring device to a propeller-type stirring blade, and polymerization was carried out by maintaining the temperature at 70° C. while stirring at 150 rpm for 5 hours, the temperature was raised to 95° C., and heating was performed for 5 hours to perform a polymerization reaction, whereby a slurry of toner particles was obtained.

### Washing and Drying Step

After the polymerization step, a slurry of the toner particle was cooled, hydrochloric acid was added to the slurry of the toner particle to adjust the pH of the system to 1.5 or less, after stirring was performed for 1 hour, solid-liquid separation is performed with a pressure filter to obtain a toner cake. The toner cake was re-slurried with ion exchanged water to produce a dispersion again, and the dispersion was separated into solid and liquid by the pressure filter again. After re-slurring and the solid-liquid separation were repeated until the electrical conductivity of the filtrate became 5.0 μS/cm or less, solid-liquid separation was finally performed to obtain a toner cake.

The acquired toner cake was dried with an air flow drier flash jet drier (manufactured by Seishin Corporation), and furthermore, fine coarse powder was cut using a multi-divided classifier utilizing the Coanda effect to obtain toner particle 1. As drying conditions, the blowing temperature was 90° C., the drier outlet temperature was 40° C., and the feed rate of the toner cake was adjusted to a rate at which the outlet temperature did not deviate from 40° C. in accordance with the moisture content of the toner cake. The volume-based median diameter of the acquired toner particle 1 was 6.7 μm.

### Production Example of Toner Particle 2

### Preparation Example for Resin Particle Dispersion 1

Styrene 75.0 parts
Butyl acrylate 23.7 parts
Acrylic acid 1.3 parts
n-lauryl mercaptan 3.2 parts

The materials described above were placed into a container, stirred, and mixed. To this solution, an aqueous solution of ion-exchanged water of 150.0 parts having 1.5 parts of Neogen RK (manufactured by Dai-ichi Kogyo Seiyaku Co., Ltd.) was added, and the mixture was dispersed.

Furthermore, an aqueous solution of ion-exchanged water of 10.0 parts having 0.3 parts of potassium persulfate was added while stirring slowly for additional 10 minutes. After nitrogen substitution, emulsion polymerization was performed at 70° C. for 6 hours. After the completion of the polymerization, the reaction solution as cooled to room temperature, and ion-exchanged water was added to acquired resin particle dispersion 1 having a solid content concentration of 12.5 mass %, a volume-based median diameter of 0.2 μm, and a glass transition temperature of 56° C.

### Preparation Example of Release Agent Dispersion 1

100.0 parts of behenyl behenate (melting point: 72.1° C.) and 15.0 parts of Neogen RK were mixed with 385.0 parts of ion-exchanged water, and the mixture was dispersed for approximately 1 hour using a wet jet mill JN100 (manufactured by JOKOH Co., Ltd.), to acquire Release Agent Dispersion 1. The wax concentration in Release Agent Dispersion 1 was 20.0 mass %.

### Preparation Example of Colorant Dispersion 1

50.0 parts of copper phthalocyanine (Pigment Blue 15:3) as a colorant and 5.0 parts of Neogen RK were mixed into 200.0 parts of ion-exchanged water, and the mixture was dispersed for 1 hour using a wet jet mill JN100 to acquire Colorant Dispersion 1. The solid content concentration of Colorant Dispersion 1 was 20.0 mass %.

### Production of Toner Particle 2

Resin particle dispersion 1:265.0 parts
Release agent dispersion 1 20.0 parts
Colorant dispersion 1:8.0 parts

As a core formation step, the materials described above were placed into a round stainless-steel flask and mixed. Subsequently, the mixture was dispersed at 5000 rpm for 10 minutes using a homogenizer (Ultraturrax T50, manufactured by IKA). While stirring, the temperature inside of the container was adjusted to 30° C., and a 1 mol/L aqueous sodium hydroxide solution was added to adjust the pH to 8.0.

As a coagulant, an aqueous solution prepared by dissolving 0.25 parts of aluminum chloride in 10.0 parts of ion-exchanged water was added over 10 minutes under stirring at 30° C. After allowing the mixture to stand for 3 minutes, temperature raise was started, the temperature was raised to 60° C., and the formation of aggregated particles (core formation) was performed. The volume-based median diameter of the formed aggregated particles was conveniently confirmed using a “Coulter Counter Multisizer 3” (registered trademark, manufactured by Beckman Coulter, Inc.). At a time point at which the volume-based median diameter became 7.0 μm, 15.0 parts of resin particle dispersion 1 were put therein as a shell formation step, and stirring was performed for an additional 1 hour to form the shell.

Thereafter, a 1 mol/L aqueous sodium hydroxide solution was added to adjust the pH to 9.0, and then, the temperature was raised to 95° C. to sphericalize the aggregated particles. When the average circularity reached 0.980, cooling was started, and after cooling to the room temperature, toner particle dispersion 1 was acquired.

The acquired toner particle dispersion 1 was adjusted to pH 1.5 or lower by adding hydrochloric acid and then stirred and left to stand for one hour, and then solid-liquid separation was performed using a pressure filter, whereby a toner cake was acquired. This toner cake was reslurried with ion exchange water to form a dispersion again, and then, solid-liquid separation was performed using the filter described above. After the reslurrying and the solid-liquid separation were repeated until the electrical conductivity of the liquid became 5.0 μS/cm or lower, finally solid-liquid separation was performed to acquire a toner cake. The resultant toner cake was dried and then classified using a classifier such that the volume-based median diameter became 7.0 μm, whereby toner particle 2 was acquired.

### Titanium Atom-Containing Fine Particles

As the titanium atom-containing fine particles, fine particles described in Table 1 below were used.

TABLE 1

| Titanium atom- | | Treatment agent | | Physical property | | |
|---|---|---|---|---|---|---|
| containing fine | | | Treatment | Major axis | | Volume |
| particle | Substrate | | amount | length | Aspect | resistivity |
| No. | Type | Type | [mass %] | [nm] | ratio | [Ω · cm] |
| 1 | Rutile-type | None | — | 120 | 5.0 | 1.0 × 10⁷ |
| | titanium oxide | | | | | |
| 2 | Rutile-type | None | — | 800 | 8.0 | 5.0 × 10⁷ |
| | titanium oxide | | | | | |
| 3 | Rutile-type | None | — | 2860 | 19.1 | 1.0 × 10⁷ |
| | titanium oxide | | | | | |
| 4 | Anatase-type | None | — | 90 | 4.5 | 4.0 × 10⁷ |
| | titanium oxide | | | | | |
| 5 | Rutile-type | i-butyltriethoxysilane | 4 | 35 | 1.3 | 2.0 × 10⁸ |
| | titanium oxide | | | | | |
| 6 | Anatase-type | i-butyltriethoxysilane | 4 | 8 | 1.6 | 2.0 × 10⁷ |
| | titanium oxide | | | | | |
| 7 | strontium titanate | n-octyltriethoxysilane | 4 | 38 | 1.2 | 2.0 × 10¹⁰ |
| 8 | strontium titanate | n-octyltriethoxysilane | 4 | 60 | 1.3 | 5.0 × 10⁹ |

In the table, the major axis length and the aspect ratio represent number average values.

### Production Example of Toner 1

1.5 parts of hydrophobic silica fine particles RY300 (manufactured by Nippon Aerosil Co., Ltd., BET specific surface area: 120 m²/g), titanium atom-containing fine particles 1 (0.5 parts), and titanium atom-containing fine particles 5 (0.4 parts) are added to the toner particle 1 described above (100.0 parts) as external additives, and the mixture is externally added and mixed using an FM10C mixer (manufactured by Nippon Coke & Engineering Co., Ltd.).

As the external addition conditions, the lower blade was set as an A0 blade, a gap from wall of the deflector was set to 20 mm, and the followings were set. Toner particle feed amount: 2.0 kg, rotation speed: 66.6 s⁻¹, external addition time: 10 minutes, and cooling water being set to 20° C. with a flow rate of 10 L/min. Thereafter, the mixture was screened with a mesh with an opening of 200 μm to acquire toner 1.

The toner described above was observed using a scanning electron microscope, and the ratio of toner particle at which the presence of titanium atom-containing fine particles L on the surface could be checked was 0.9. In addition, the ratio of the toner at which the presence of the titanium atom-containing fine particles L and S on the surface could be checked was also 0.9. Physical properties of the acquired toner 1 are shown in Table 2.

TABLE 2

| | | External additive 1 | | External additive 2 | | | | | | Fixing ratio |
|---|---|---|---|---|---|---|---|---|---|---|
| | | Titanium | | Titanium | | Hydrophobic | | | | of titanium |
| | | atom- | | atom- | | silica fine | Presence | | | atom- |
| | Toner | containing | | containing | | particle | ratio of Ti | | | containing |
| | particle | fine particle | Amount | fine particle | Amount | Amount | element | | | fine particle |
| | No. | No. | (parts) | No. | (parts) | (parts) | (atomic %) | NL/Nt | NLS/Nt | (%) |
| Toner 1 | 1 | 1 | 0.5 | 5 | 0.4 | 1.5 | 0.40 | 0.9 | 0.9 | 75 |
| Toner 2 | 1 | 2 | 0.5 | 6 | 0.7 | 1.5 | 3.00 | 0.8 | 0.8 | 80 |
| Toner 3 | 1 | 3 | 1.0 | 6 | 0.5 | 1.5 | 1.90 | 0.3 | 0.3 | 52 |
| Toner 4 | 1 | 2 | 0.5 | 8 | 0.2 | 1.5 | 0.10 | 0.8 | 0.8 | 65 |
| Toner 5 | 1 | 2 | 0.2 | 8 | 0.2 | 1.5 | 0.05 | 0.6 | 0.6 | 67 |
| Toner 6 | 1 | 3 | 0.5 | 8 | 0.2 | 1.5 | 0.05 | 0.2 | 0.2 | 43 |
| Toner 7 | 1 | 1 | 1.0 | — | — | 1.5 | 0.30 | 1.0 | 1.0 | 73 |
| Toner 8 | 1 | 2 | 1.5 | — | — | 1.5 | 0.20 | 0.9 | 0.9 | 63 |
| Toner 9 | 1 | 3 | 2.0 | — | — | 1.5 | 0.05 | 0.3 | 0.3 | 32 |
| Toner 10 | 1 | 4 | 0.8 | — | — | 1.5 | 0.40 | 0.0 | 0.0 | 71 |
| Toner 11 | 1 | — | — | 6 | 0.8 | 1.5 | 3.80 | 0.0 | 0.0 | 92 |
| Toner 12 | 1 | — | — | 5 | 1.5 | 1.5 | 0.91 | 0.0 | 0.0 | 75 |
| Toner 13 | 1 | — | — | 7 | 1.5 | 1.5 | 0.70 | 0.0 | 0.0 | 73 |
| Toner 14 | 1 | — | — | 8 | 1.5 | 1.5 | 0.38 | 0.0 | 0.0 | 65 |
| Toner 15 | 1 | 3 | 2.0 | — | — | 1.5 | 0.05 | 0.3 | 0.3 | 22 |
| Toner 16 | 1 | 3 | 2.0 | — | — | 1.5 | 0.05 | 0.2 | 0.2 | 8 |
| Toner 17 | 1 | — | — | 6 | 0.7 | 1.5 | 2.90 | 0.0 | 0.0 | 90 |
| Toner 18 | 1 | — | — | 6 | 0.7 | 1.5 | 2.90 | 0.0 | 0.0 | 94 |
| Toner 19 | 2 | 1 | 0.5 | 5 | 0.4 | 1.5 | 0.38 | 0.9 | 0.9 | 79 |
| Toner 20 | 2 | 1 | 1.0 | — | — | 1.5 | 0.30 | 1.0 | 1.0 | 72 |
| Toner 21 | 2 | — | — | 5 | 0.5 | 1.5 | 0.28 | 0.0 | 0.0 | 79 |
| Toner 22 | 2 | — | — | 7 | 0.5 | 1.5 | 0.20 | 0.0 | 0.0 | 80 |

### Production Example of Toners 2 to 22

In the production example of the toner 1, the external addition conditions were similar except changes as represented in Table 2 to acquire toners 2 to 22. The physical properties of the acquired toners 2 to 22 are represented in Table 2.

### Production Example of Toners 23 to 25

In the production example of the toner 1, the external addition conditions were similar except changes as represented in Table 3 to acquire toners 23 to 25. The physical properties of the acquired toners 23 to 25 are represented in Table 3.

### Production Example of Toner 26

Under conditions represented below, external addition of titanium atom-containing fine particles to toner particle was performed for the toner particle 2. Titanium atom-containing fine particles 5 (1.5 parts) were added to the toner particle 2 (100.0 parts), and external addition/mixing was performed using FM10C (manufactured by Nippon Coke & Engineering Co., Ltd.). As the external addition conditions, the lower blade was set as an A0 blade, a gap from wall of the deflector was set to 20 mm, and the followings were set. Toner particle feed amount: 2.0 kg, rotation speed: 66.6 s 1, external addition time: 10 minutes. By using warm water instead of cooling water, the intra-layer temperature during the externally-attached mixing was adjusted to be 50° C. to 60° C.

Thereafter, 1.5 parts of hydrophobic silica fine particles RY300 (manufactured by Nippon Aerosil Co., Ltd., BET specific surface area: 120 m²/g) were added, and external addition/mixing were performed again using FM10C (manufactured by Nippon Coke & Engineering Co., Ltd.). As the external addition conditions, the lower blade was set as an A0 blade, the gap from the wall of the deflector was set to 20 mm, and the followings were set. Feed amount of toner particles: 2.0 kg, rotation speed: 66.6 s⁻¹, external addition time: 10 minutes, and cooling water being set to the temperature of 20° C. and the flow rate of 10 L/min. Thereafter, the mixture was screened with a mesh with an opening of 200 μm to acquire toner 26. Physical properties of the acquired toner 26 are shown in Table 3.

TABLE 3

| | | External additive 1 | | External additive 2 | | | | | Fixing ratio |
|---|---|---|---|---|---|---|---|---|---|
| | | Titanium | | Titanium | | Hydrophobic | | | of titanium |
| | | atom- | | atom- | | silica fine | Presence | | atom- |
| | Toner | containing | | containing | | particle | ratio of Ti | | containing |
| | particle | fine particle | Amount | fine particle | Amount | Amount | element | | fine particle |
| Toner | No. | No. | (parts) | No. | (parts) | (parts) | (atomic %) | NL/Nt | (%) |
| Toner 23 | 1 | 1 | 0 | — | 0.0 | 1.5 | 0.0 | 0.0 | — |
| Toner 24 | 1 | 5 | 1.5 | — | 0.0 | 1.5 | 0.9 | 0.0 | 80 |
| Toner 25 | 1 | 5 | 6 | — | 0.0 | 1.5 | 5.1 | 0.0 | 61 |
| Toner 26 | 2 | 5 | 1.5 | — | 0.0 | 1.5 | 0.8 | 0.0 | 96 |

### Production Example of Developing Roller

Although this example describes a developing roller in which an elastic roller with an elastic layer provided on the outer surface of a substrate is coated with a resin layer, the developing roller is not limited to this configuration.

### 1. Preparation and Production of Raw Materials for Forming Resin Layer

### 1-1. Preparation of Raw Polyol and Production Example

Hereinafter, examples of synthesis for obtaining a polyurethane resin layer are described below.

### Measurement of Number Average Molecular Weight of Raw Polyol

The apparatus used to measure the number average molecular weight (Mn) in the present production example, and conditions are as follows:
Measuring instrument: HLC-8120 GPC (manufactured by Tosoh Corporation)
Column: TSKgel Super HZMM (manufactured by Tosoh Corporation)×2
Solvent: Tetrahydrofuran (THF) (20 mmol/l triethylamine added)
Temperature: 40° C.
Frow rate of THF: 0.6 ml/min

As the measuring sample, 0.1-mass % THF solutions were used. Furthermore, measurements were performed using an RI (refraction index) detector as a detector.

Calibration curves were prepared using TSK standard polystyrene A-1000, A-2500, A-5000, F-1, F-2, F-4, F-10, F-20, F-40, F-80, and F-128 manufactured by Tosoh Corporation as standard samples for preparing calibration curves. On the basis of these calibration curves, the number average molecular weight was determined from the retention time of the obtained measuring samples.

### Preparation of Raw Polyol

A-1 to A-5, which are 5 types of raw polyols listed in Table 4 below, were purchased commercially.

TABLE 4

| No. | Raw material polyol |
|---|---|
| A-1 | Duranol T5652 Mn = 2000 (Manufactured by Asahi Kasei |
| | Chemicals Corp.) |
| A-2 | Duranol G3452 Mn = 2000 (Manufactured by Asahi Kasei |
| | Chemicals Corp.) |
| A-3 | ETERNACOLL UH-200 Mn = 2000 (Manufactured by Ube |
| | Industries, Ltd.) |
| A-4 | Nippolan 982 Mn = 2000 (Manufactured by Tosoh Corporation) |
| A-5 | ETERNACOLL UM-90(1:3) Mn = 900 (Manufactured by Ube |
| | Industries, Ltd.) |

### 1-2. Preparation of Raw Isocyanates B-1 to B-3

Raw isocyanates listed in Table 5 below were prepared.

TABLE 5

| No. | Raw material isocyanate |
|---|---|
| B-1 | Diphenylmethane diisocyanate (MDI) |
| | (Trade name: Milionate MT, manufactured |
| | by Tosoh Corporation) |
| B-2 | Polymethylene polyphenylene polyisocyanate |
| | (polymeric MDI) |
| | (Trade name: Milionate MR200, manufactured |
| | by Tosoh Corporation) |
| B-3 | Hexamethylene diisocyanate isocyanurate trimer |
| | (Trade name: Duranate TPA-100, manufactured by |
| | Asahi Kasei chemicals Corp.) |

### 1-3. Production Examples of Hydroxyl Group-Terminated Urethan Prepolymers C-1 to C-3

### Synthesis of Hydroxyl Group-Terminated Urethan Prepolymer C-1

Under a nitrogen atmosphere, the materials listed in Table 6 below were heated and stirred at a temperature of 90° C. for 3 hours to cause a reaction. Thereafter, 2-butanone (MEK) was added to the obtained reactant to prepare a hydroxyl group-terminated urethan prepolymer C-1 as a solution with a solid content of 50 parts by mass.

TABLE 6

| | Parts |
|---|---|
| Material | by mass |
| Raw material polyol A-1 | 100 |
| (Trade name: Duranol T5652, manufactured | |
| by Asahi Kasei Chemicals Corp.) | |
| Raw material isocyanate B-1 | 6.3 |
| (Trade name: Milionate MT, manufactured | |
| by Tosoh Corporation) | |

### Synthesis of Hydroxyl Group-Terminated Urethan Prepolymers C-2 to C-3

Hydroxyl group-terminated urethan prepolymers C-2 to C-3 were synthesized in the same manner as in the case of the synthesis of the hydroxyl group-terminated urethan prepolymer C-1 using starting materials listed in Table 7 below.

The chemical structures of these hydroxyl group-terminated urethan prepolymers C-1 to C-3 were identified using ¹H-NMR and ¹³C-NMR. In Table 7, m, n, and s in Formulas (1) and (4) are average numbers of added moles.

TABLE 7

| Hydroxyl group- | Raw material | | Raw material | | | | | |
|---|---|---|---|---|---|---|---|---|
| terminated urethane | polyol | | isocyanate | | | | | |
| prepolymer No. | No. | Parts | No. | Parts | Structure contained in molecule | | | |
| C-1 | A-1 | 100 | B-1 | 6.3 | Formula (1) | R11 = (CH₂)₅ | R12 = (CH₂)₆ | m, n = 6.9 |
| C-2 | A-2 | 100 | B-1 | 6.3 | Formula (1) | R11 = (CH₂)₃ | R12 = (CH₂)₄ | m, n = 8.8 |

| | | | | | | | |
|---|---|---|---|---|---|---|---|
| C-3 | A-3 | 100 | B-1 | 6.3 | Formula (4) | R41 = (CH₂)₆ | s = 13.2 |

For hydroxyl group-terminated urethane prepolymers C-1 to C-2 having a structure represented by Structural Formula (1) in the molecule, R13 in Structural Formula (1) was the same as R12.

In the table, description of “x, y=A” such as m, n=6.9 indicates that the average number of added moles for each of x and y is A. The similarly applies also to the following tables. Parts represent parts by mass.

### 1-4. Production Examples of Isocyanate Group-Terminated Prepolymers D-1 to D-3

### Synthesis of Isocyanate Group-Terminated Prepolymer D-1

Under a nitrogen atmosphere, the materials listed in Table 8 below were heated and stirred at a temperature of 90° C. for 3 hours to cause a reaction. Thereafter, 2-butanone (MEK) was added to the obtained reactant to prepare a solution with a solid content of 50 mass %, and an isocyanate group-terminated prepolymer D-1 was produced.

TABLE 8

| | Parts |
|---|---|
| Material | by mass |
| Raw material polyol A-4 | 100 |
| (Trade name: Nippolan 982, manufactured by Tosoh | |
| Corporation) | |
| Raw material polyisocyanate B-2 | 33.5 |
| (Trade name: Millionate MR200, manufactured by | |
| Tosoh Corporation) | |

### Synthesis of Isocyanate Group-Terminated Prepolymers D-2 to D-3

Isocyanate group-terminated prepolymers D-2 to D-3 were prepared in the same manner as in the synthesis of the isocyanate group-terminated prepolymers D-1 using starting materials of the type and amount listed in Table 9 below.

The chemical structures of these isocyanate group-terminated prepolymers D-1 to D-9 were identified using ¹H-NMR and ¹³C-NMR. In Table 9, m, n, o, p, and s in structural formulas (1), (2), and (4), are the average numbers of added moles. Parts represent parts by mass.

TABLE 9

| Isocyanate | | | | | | | | |
|---|---|---|---|---|---|---|---|---|
| group- | Raw | | Raw | | | | | |
| terminated | material | | material | | | | | |
| prepolymer | polyol | | isocyanate | | | | | |
| No. | No. | Parts | No. | Parts | Structure contained in molecule | | | |
| D-1 | A-4 | 100 | B-2 | 33.5 | Formula | o = 9.1, p = 5.5 | | |
| | | | | | (2) | | | |
| D-2 | A-5 | 100 | B-3 | 78.4 | Formula (1) | R11 = (CH₂)₆ | 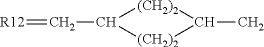 | m = 4.1, n = 1.4 |

| | | | | | | | |
|---|---|---|---|---|---|---|---|
| D-3 | A-3 | 100 | B-2 | 33.5 | Formula | R41 = (CH₂)₆ | s = 13.2 |
| | | | | | (4) | | |

For the isocyanate group-terminated prepolymer D-2 in which the structure represented by Structural Formula (1) is included in the molecule, R13 in the Structural Formula (1) was the same as at least one selected from a group consisting of R11 and R12.

### 2. Preparation and Production of Resin Layer Additive Raw Materials

### 2-1. Example of Preparation and Production of Polyoxyethylene Polyoxypropylene Alkyl Ether E1 to E2

### Preparation of Polyoxyethylene Polyoxypropylene Alkyl Ether

Additives E-1 to E-2 that are polyoxyethylene polyoxypropylene alkyl ethers listed in Table 10 below were purchased commercially.

### 2-2. Preparation and Production Example of Polyoxyethylene Alkyl Ether Acetate

### Preparation of Polyoxyethylene Alkyl Ether Acetate

An additive E-3 that is polyoxyethylene alkyl ether acetate listed in Table 10 below was purchased commercially.

### Synthesis of Polyoxyethylene Alkyl Ether Acetate E-3

First, 55.0 g of polyoxyethylene methyl ether (trade name: BLAUNON MP-550, manufactured by AOKI OIL INDUSTRIAL Co., Ltd., the average number of moles of ethylene oxide added is 12 moles with respect to alcohol) and 510 ml of a 1-mole/L aqueous sodium hydroxide solution were mixed, then 71.1 g of potassium permanganate was added, and stirred at room temperature for 6 hours. After that, 760 ml of 2-propanol was then added and stirred for 1 hour to quench the excess potassium permanganate, and the by-product manganese oxide was filtered. The aqueous layer was extracted with dichloromethane and purified to yield E-3, which was polyoxyethylene methyl ether acetate. Table 10 shows the structure of R71 in E-3 and the value of x.

TABLE 10

| No. | Material | Structure | | |
|---|---|---|---|---|
| E-1 | Polyoxyethylene- | Formula | R51 = C₄H₉ | t, u = 17 |
| | polyoxypropylene butyl ether | (5) | | |
| | (Trade name: Unilube 50MB- | | | |
| | 26, manufactured by NOF | | | |
| | Corporation) | | | |
| E-2 | Polyoxyethylene- | Formula | R51 = C₄H₉ | t = 9, |
| | polyoxypropylene butyl ether | (5) | | u = 10 |
| | (Trade name: Unilube 50MB- | | | |
| | 11, manufactured by NOF | | | |
| | Corporation) | | | |
| E-3 | Polyoxyethylene methyl ether | Formula | R71 = CH₃ | x = 11 |
| | acetate | (7) | | |

### 3. Production Examples of Resin Layer-Forming Coating Liquids F-1 to F-10

### 3-1. Preparation of Resin Layer-Forming Coating Liquid F-1

As material for a resin layer-forming coating liquid F-1, materials of the type and amount listed in Table 11 below were added to the inside of a reaction vessel and were stirred. Next, 2-butanone (MEK) was added so that the total solids ratio be 30 mass %, and then mixed with a sand mill. Subsequently, 2-butanone (MEK) was added to adjust the viscosity of the liquid to within the range of 6 to 10 mPa's to prepare the resin layer-forming coating F-1.

TABLE 11

| | Parts |
|---|---|
| Material | by mass |
| Hydroxyl group-terminated urethane prepolymer C-1 | 100 |
| Isocyanate group-terminated urethane prepolymer D-3 | 54.7 |
| Additive E-1 | 7 |
| Carbon black | 35 |
| (Trade name: MA8, manufactured by Mitsubishi Chemical | |
| Corporation) | |
| Coarse particles | 23 |
| (Trade name: Art pearl C-400T, manufactured by Negami | |
| Chemical Industrial Co., Ltd.) | |

### 3-2. Preparation of Resin Layer-Forming Coating Liquids F-2 to F-10

The resin layer-forming coating liquids F-2 to F-10 were prepared in the following method. First, the hydroxyl group-terminated urethane prepolymer, isocyanate-group terminated prepolymer, additives, carbon black, and coarse particles listed in Table 12 below were mixed in the same manner as that of the case of preparation of the resin layer-forming coating liquid F-1. Thereafter, 2-butanone (MEK) was added to adjust the viscosity of the liquids to be in the range of 6 to 10 mPa·s, thereby producing the resin layer-forming coatings F-2 to F-10.

TABLE 12

| | Hydroxyl group- | | Isocyanate group- | | | | | |
|---|---|---|---|---|---|---|---|---|
| | terminated urethane | | terminated urethane | | | | Carbon | Coarse |
| | prepolymer | | prepolymer | | Additives | | black | particles |
| | No. | Parts | No. | Parts | No. | Parts | Parts | Parts |
| F-1 | C-1 | 100 | D-3 | 54.7 | E-1 | 7 | 35 | 23 |
| F-2 | C-2 | 100 | D-3 | 54.7 | E-1 | 7 | 35 | 23 |
| F-3 | C-3 | 100 | D-2 | 54.7 | E-1 | 7 | 35 | 23 |
| F-4 | C-1 | 100 | D-1 | 54.7 | E-1 | 7 | 35 | 23 |
| F-5 | C-2 | 100 | D-1 | 54.7 | E-1 | 7 | 35 | 23 |
| F-6 | C-3 | 100 | D-1 | 54.7 | E-1 | 7 | 35 | 23 |
| F-7 | C-1 | 100 | D-3 | 54.7 | E-1 | 6.6 | 35 | 23 |
| F-8 | C-1 | 100 | D-3 | 54.7 | E-1 | 16.1 | 35 | 23 |
| F-9 | C-1 | 100 | D-3 | 54.7 | E-2 | 7 | 35 | 23 |
| F-10 | C-1 | 100 | D-3 | 54.7 | E-3 | 7 | 35 | 23 |

In the table, parts represent parts by mass.

### 4. Production Example of Developing Roller G1

### 4-1. Adjustment of Substrate

As the substrate, a substrate in which a peripheral surface of a stainless steel (SUS304) core rod with a diameter of 6 mm was coated with a primer (product name: DY35-051, manufactured by Dow Toray Co., Ltd.) and baked was prepared.

### 4-2. Preparation of Elastic Layer

The substrate was positioned in a mold, and an additional silicone rubber composition obtained by mixing the materials shown in Table 13 was injected into a cavity formed in the mold.

TABLE 13

| | parts |
|---|---|
| Material | by mass |
| Liquid silicone rubber | 100 |
| (Product name: SE6724 A/B, manufactured by Dow Toray | |
| Co., Ltd.) | |
| Carbon black | 16 |
| (Product name: Tokablack #4300, manufactured by Tokai | |
| Carbon Co., Ltd.) | |
| Curing control agent | 0.01 |
| (Product name: 1-ethenyl-1-cyclohexanol, manufactured | |
| by Tokyo Kasei Kogyo Co., Ltd.) | |
| Platinum catalyst | 0.01 |
| Product name: SIP6830.3, manufactured by Gelest Inc.) | |

Subsequently, after the mold was heated to vulcanize and cure the silicone rubber at the temperature of 150° C. for 15 minutes and demolded, the curing reaction was completed by further heating at 180° C. for 1 hour, thereby obtaining an elastic roller with an elastic layer of 11.5 mm in diameter formed on the outer circumference of the substrate.

### 4-3. Preparation of Resin Layer

The elastic roller was held at the upper end thereof with the longitudinal direction set to the vertical direction and was immersed (dipped) in the resin layer-forming coating liquid F-1 to coat the surface of the elastic roller with the coating liquid. The resulting coated matter was air-dried at normal temperature for 30 minutes and then dried in a hot air-circulating drier set at 160° C. for 1 hour. In this way, a developing roller G-1 in which a resin layer having a film thickness of 12 μm is formed on the elastic layer was obtained. The physical properties of the obtained developing roller G-1 are shown in Table 14-2.

TABLE 14-1

| | |
|---|---|
| Electro- | Resin |
| photo | layer |
| graphic | forming |

| roller | coating | Binder resin structure | | | | | | | | | |
|---|---|---|---|---|---|---|---|---|---|---|---|
| No. | liquid No. | Structure [symbol] | | | | Structure [symbol] | | | Additive structure | | |
| G-1 | F-1 | Formula | R11 = | R12 = | m, | Formula | R41 = (CH₂)₆ | s = | Formula | R51 = | t, |
| | | (1) | (CH₂)₅ | (CH₂)₆ | n = | (4) | | 13.2 | (5) | C₄H₉ | u = |
| | | | | | 6.9 | | | | | | 17 |
| G-2 | F-2 | Formula | R11 = | R12 = | m, | Formula | R41 = (CH₂)₆ | s = | Formula | R51 = | t, |
| | | (1) | (CH₂)₃ | (CH₂)₄ | n = | (4) | | 13.2 | (5) | C₄H₉ | u = |
| | | | | | 8.8 | | | | | | 17 |

| | | | | | | | | | | | |
|---|---|---|---|---|---|---|---|---|---|---|---|
| G-3 | F-3 | Formula (4) | R41 = (CH₂)₆ | s = 13.2 | Formula (1) | R11 = (CH₂)₆ | 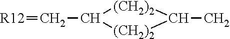 | m = 4.1, n = 1.4 | Formula (5) | R51 = C₄H₉ | t, u = 17 |

| G-4 | F-4 | Formula | R11 = | R12 = | m, | Formula | o = 9.1, p = 5.5 | | Formula | R51 = | t, |
|---|---|---|---|---|---|---|---|---|---|---|---|
| | | (1) | (CH₂)₅ | (CH₂)₆ | n = | (2) | | | (5) | C₄H₉ | u = |
| | | | | | 6.9 | | | | | | 17 |
| G-5 | F-5 | Formula | R11 = | R12 = | m, | Formula | o = 9.1, p = 5.5 | | Formula | R51 = | t, |
| | | (1) | (CH₂)₃ | (CH₂)₄ | n = | (2) | | | (5) | C₄H₉ | u = |
| | | | | | 8.8 | | | | | | 17 |
| G-6 | F-6 | Formula | R41 = (CH₂)₆ | | s = | Formula | o = 9.1, p = 5.5 | | Formula | R51 = | t, |
| | | (4) | | | 13.2 | (2) | | | (5) | C₄H₉ | u = |
| | | | | | | | | | | | 17 |
| G-7 | F-7 | Formula | R11 = | R12 = | m, | Formula | R41 = (CH₂)₆ | s = | Formula | R51 = | t, |
| | | (1) | (CH₂)₅ | (CH₂)₆ | n = | (4) | | 13.2 | (5) | C₄H₉ | u = |
| | | | | | 6.9 | | | | | | 17 |
| G-8 | F-8 | Formula | R11 = | R12 = | m, | Formula | R41 = (CH₂)₆ | s = | Formula | R51 = | t, |
| | | (1) | (CH₂)₅ | (CH₂)₆ | n = | (4) | | 13.2 | (5) | C₄H₉ | u = |
| | | | | | 6.9 | | | | | | 17 |
| G-9 | F-9 | Formula | R11 = | R12 = | m, | Formula | R41 = (CH₂)₆ | s = | Formula | R51 = | t = 9, |
| | | (1) | (CH₂)₅ | (CH₂)₆ | n = | (4) | | 13.2 | (5) | C₄H₉ | u = |
| | | | | | 6.9 | | | | | | 10 |
| G-10 | F-10 | Formula | R11 = | R12 = | m, | Formula | R41 = (CH₂)₆ | s = | Formula | R71 = | x = |
| | | (1) | (CH₂)₅ | (CH₂)₆ | n = | (4) | | 13.2 | (7) | CH₃ | 11 |
| | | | | | 6.9 | | | | | | |

TABLE 14-2

| | | | | | | Carbon black dispersion state | | | | | |
|---|---|---|---|---|---|---|---|---|---|---|---|
| | | | | | Surface | Dispersion circle- | | | Distance between | | |
| | Carbon black | | | | electric | equivalent diameter | | | wall surfaces | | |
| | physical property | | | Minimum | potential | Mean | | | Mean | | |
| | | DBP | | value of | maximum | value | SD | | value | SD | |
| Electrophotographic | PD | ml/ | | impedance | value | Rc | σc | | d | σd | |
| roller No. | [nm] | 100 g | pH | [Ω] | [V] | [nm] | [nm] | σc/Rc | [nm] | [nm] | σd/d |
| G-1 | 24 | 51 | 2.5 | 9.12E+06 | 5.7 | 55.2 | 33.1 | 0.600 | 111.6 | 64.1 | 0.574 |
| G-2 | 24 | 51 | 2.5 | 8.67E+06 | 12.5 | 55.9 | 32.9 | 0.589 | 108.9 | 62.1 | 0.570 |
| G-3 | 24 | 51 | 2.5 | 7.41E+06 | 14.2 | 52.1 | 31.1 | 0.597 | 102.3 | 57.2 | 0.559 |
| G-4 | 24 | 51 | 2.5 | 2.79E+06 | 3.2 | 54.3 | 31.8 | 0.586 | 100.7 | 56.9 | 0.565 |
| G-5 | 24 | 51 | 2.5 | 1.52E+06 | 3.2 | 59.2 | 38.0 | 0.642 | 103.8 | 57.2 | 0.551 |
| G-6 | 24 | 51 | 2.5 | 2.36E+06 | 3.2 | 58.2 | 35.3 | 0.607 | 105.8 | 60.9 | 0.576 |
| G-7 | 24 | 51 | 2.5 | 8.58E+06 | 4.5 | 57.4 | 34.5 | 0.601 | 99.8 | 56.6 | 0.567 |
| G-8 | 24 | 51 | 2.5 | 6.55E+06 | 7.2 | 56.1 | 34.2 | 0.610 | 101.2 | 57.0 | 0.563 |
| G-9 | 24 | 51 | 2.5 | 7.71E+06 | 6.4 | 57.0 | 34.9 | 0.612 | 98.7 | 56.7 | 0.574 |
| G-10 | 24 | 51 | 2.5 | 2.15E+06 | 3.8 | 58.9 | 37.0 | 0.628 | 143.5 | 83.2 | 0.580 |

In the Table 14-2, PD represents the number average diameter of the primary particles. SD indicates Standard deviation, DBP indicates DBP absorption amount.

A minimum value of the impedance indicates a minimum impedance value at the frequency of 1.0×100 Hz to 1.0×10¹ Hz. A representation such as “9.12E+06” indicates “9.12×10⁶”

### Production Example of Developing Roller G-2 to G-10

The developing rollers G-2 to G-10 were prepared in the same manner as in the production example of the developing roller G-1 except that the resin layer-forming coating liquid is changed to F-2 to F-10 as shown in Table 14-1, in the production example of the developing roller G-1. The physical properties of the obtained developing rollers G-2 to G-10 are shown in Table 14-2.

### Production Example of Comparative Developing Roller G-11

Materials of the types and amounts listed in Table 15 below were added to the inside of the reaction vessel and stirred. Next, after 2-butanone (MEK) was added such that the total solid ratio became 30 mass %, they were mixed with a sand mill. Next, 2-butanone (MEK) was added to adjust the viscosity of the liquid to be within the range of 6 to 10 mPa's to prepare the resin layer-forming coating liquid F-11. The developing roller G-11 was prepared in the same manner as in the production example of the developing roller G-1 except that the resin layer-forming coating liquid F-1 was changed to the resin layer-forming coating liquid F-11, and the physical properties were evaluated. Table 19 shows the evaluation results.

TABLE 15

| | Parts |
|---|---|
| Material | by mass |
| Polytetramethylene glycol ether polyol | 25 |
| (Trade name: PTG1000SN, manufactured by Hodogaya | |
| Chemical Co., Ltd.) | |
| Polycarbonate polyol | 75 |
| (Trade name: T5651, manufactured by Asahi Kasei | |
| Chemicals Corp.) | |
| Isocyanate | 55.5 |
| (Trade name: Coronate HX, manufactured by Tosoh | |
| Corporation) | |
| Carbon black | 30 |
| (Trade name: MA8, manufactured by Mitsubishi Chemical | |
| Corporation) | |
| Coarse particles | 20 |
| (Trade name: Art pearl C-400T, manufactured by Negami | |
| Chemical Industrial Co., Ltd.) | |

### Production Example of Comparative Developing Rollers G-12 and G-13

The resin layer-forming coating liquids F-12 and F-13 and the developing rollers G-12 and G-13 were prepared in the same manner as in the production example of the developing roller G-1 except that the carbon black used in the resin layer-forming coating liquid F-1 was changed to materials listed in Table 16 below, and the physical properties were evaluated. Table 19 shows the evaluation results.

TABLE 16

| | | Carbon black material | | | |
|---|---|---|---|---|---|
| | Resin layer | | Primary | DBP | |
| | forming | | particle | absorption | |
| Developing | coating | | diameter | amount | |
| rollerNo. | liquid No. | Material name | [nm] | [ml/100 g] | pH |
| G-1 | F-1 | MA8 | 24 | 51 | 2.5 |
| | | (Manufactured by | | | |
| | | Mitsubishi Chemical | | | |
| | | Corporation) | | | |
| G-12 | F-12 | MA230 | 30 | 113 | 3.0 |
| | | (Manufactured by | | | |
| | | Mitsubishi Chemical | | | |
| | | Corporation) | | | |
| G-13 | F-13 | MA14 | 40 | 73 | 3.0 |
| | | (Manufactured by | | | |
| | | Mitsubishi Chemical | | | |
| | | Corporation) | | | |

### Production Example of Comparative Developing Rollers G-14 to G-16

The resin layer-forming coating liquids F-14 to F-16 and the developing rollers G-14 to G-16 were prepared in the same manner as in the production example of the developing roller G-1 except that the additives used in the resin layer-forming coating liquid F-1 were changed to materials and parts by mass listed in Table 17 below, and the physical properties were evaluated. Table 19 shows the evaluation results.

TABLE 17

| | Resin layer | | |
|---|---|---|---|
| | forming | Additives | |
| Developing | coating | | Parts |
| roller No. | liquid No. | Material | by mass |
| G-1 | F-1 | E-1 | 7 |
| G-14 | F-14 | E-1 | 5.25 |
| G-15 | F-15 | Silane coupling agent | 14 |
| | | (Product name: A-187, | |
| | | manufactured by Momentive) | |
| G-16 | F-16 | Polymer dispersant | 24.5 |
| | | (Product name: Disper byk-185, | |
| | | manufactured by Byk-Chemie) | |

### Production Example of Comparative Developing Roller G-17

The resin layer-forming coating liquid F-17 and the developing roller G-17 were prepared in the same manner as in the production example of the developing roller G-1 except that the additives used in the resin layer-forming coating liquid F-1 were changed to E-4 listed in Table 18 below, and the physical properties were evaluated. Table 19 shows the evaluation results.

### Synthesis of Additive E-5

The additive E-5, which is a polyetheramine, was obtained by synthesizing polyoxyethylene-polyoxypropylene decyl ether, then oxidizing the secondary alcohol to form a ketone through reductive amination.

### Synthesis of Polyoxyethylene-Polyoxypropylene Decyl Ether

205.8 g of 1-decanol (manufactured by Tokyo Chemical Industry Co., Ltd.) and 3.0 g of potassium hydroxide were charged into an autoclave including a stirring device, temperature control unit, and an automatic feeding system, and dehydration was performed at 110° C. and 1.2 kPa for 30 minutes. After completion of dehydration, nitrogen purging was performed, the temperature was raised to 150° C., and 858.0 g of ethylene oxide (15 moles relative to the alcohol) was added. The reaction was performed at 150° C. for 1 hour to yield ethylene oxide adduct with an average number of moles added of 15 moles.

After cooling the resulting ethylene oxide adduct to 130° C., 1132.6 g (15 moles with respect to alcohol) of propylene oxide was charged. After the completion of charging, the reaction was performed at 130° C. for 5 hours to yield a polyoxyethylene polyoxypropylene decyl ether adduct that was a block polymer of 15 moles of ethylene oxide and 15 moles of propylene oxide as average numbers of added moles.

The obtained polyoxyethylene polyoxypropylene octyl decyl adduct was cooled to 80° C., and unreacted ethylene oxide and propylene oxide were removed at 2.5 kPa for 30 minutes. Next, an autoclave was charged with 6.0 g of 90% lactic acid, and the content was stirred at 80° C. for 30 minutes, and polyoxyethylene polyoxypropylene decyl ether was obtained by extraction.

### Synthesis of Polyetheramine E-5

A three-necked flask was fitted with a stirrer, and 1688 g of polyoxyethylene polyoxypropylene decyl ether and 460 ml of acetic acid were charged. To this, 600 ml of 2 mole/l aqueous sodium hypochlorite solution was added dropwise over 1 hour. The reaction vessel was placed in an ice bath and cooled to maintain the temperature within the range of 15 to 25° C. After the end of the dropwise addition, stirring was continued for 1 hour. To the resulting solution, dichloromethane was added, and the aqueous layer was then extracted, post-treated, and purified on a column to yield a ketonized compound of a secondary alcohol.

250 mL of a methanol-acetic acid mixed solution (volume ratio 10:1) is added to 41.4 g of a ketonized compound of a secondary alcohol acquired through cooling at 0° C. using an ice bath, and 2.7 g of 2-picoline-borane is added. The ice bath was removed and stirred overnight at an open system and room temperature. After concentration, the reaction mixture was cooled to 0° C., and 360 ml of 35% aqueous hydrochloric acid solution was then added and stirred at room temperature for 2 hours. An aqueous sodium hydroxide solution was added to form basic, and the aqueous layer was extracted with dichloromethane, post-treated, and purified on a column to yield polyetheramine E-5. Table 18 shows the structure of R61 in E-5 and the values of v and W.

### Synthesis of Resin Layer-Forming Coating F-18 and Developing Roller G-18

The resin layer-forming coating liquid F-18 and the developing roller G-18 were prepared in the same manner as in the production example of the developing roller G-1 except that the additives used in the resin layer-forming coating liquid F-1 were changed to an additive E-5, and the physical properties were evaluated. Table 19 shows the evaluation results.

### Synthesis of Additive E-6

An autoclave including a stirring apparatus, a temperature control apparatus, and an automated charging apparatus was charged with 315.2 g of 1-hexadecanol (manufactured by Tokyo Chemical Industry Co., Ltd.) and 3.0 g of potassium hydroxide, and dehydration was performed at 110° C. and 1.2 kPa for 30 minutes. After completion of dehydration, nitrogen purging was performed, and after the temperature was raised to 150° C., 858.0 g (15 moles with respect to alcohol) of ethylene oxide was charged. The reaction was performed at 150° C. for 1 hour to yield ethylene oxide adduct with an average number of moles added of 15 moles.

Then, 90.2 g of the obtained ethylene oxide adduct and 510 ml of 1 mole/L aqueous sodium hydroxide solution were mixed, then 71.1 g of potassium permanganate was added, and stirred at room temperature for 6 hours. After that, 760 ml of 2-propanol was then added and stirred for 1 hour to quench the excess potassium permanganate, and the by-product manganese oxide was filtered. The aqueous layer was extracted with dichloromethane and purified to yield E-6, which was polyoxyethylene methyl ether acetate. Table 18 shows the structure of R71 in E-6 and the value of x.

### Synthesis of Resin Layer-Forming Coating F-19 and Developing Roller G-19

The resin layer-forming coating liquid F-19 and the developing roller G-19 were prepared in the same manner as in the production example of the developing roller G-1 except that the additive used in the resin layer-forming coating liquid F-1 was changed to an additive E-6, and the physical properties were evaluated. Table 19 shows the evaluation results.

TABLE 18

| No. | Material | Structure | | |
|---|---|---|---|---|
| E-4 | Polyoxyethylene | Formula | R51 = C₁₆H₃₃ | t = 20, |
| | polyoxypropylene cetylether | (5) | | u = 8 |
| | (Trade name: Unisafe 20P-8, | | | |
| | manufactured by NOF | | | |
| | Corporation) | | | |
| E-5 | Polyether amine | Formula | R61 = C₁₀H₂₁ | v, w = 15 |
| | | (6) | | |
| E-6 | Polyoxyethylene hexadecyl | Formula | R71 = C₁₆H₃₃ | x = 14 |
| | ether acetic acid | (7) | | |

TABLE 19

| | | | | | Surface | Carbon black dispersion state | | | | | |
|---|---|---|---|---|---|---|---|---|---|---|---|
| | Carbon black | | | | electric | Dispersion circle- | | | Distance between | | |
| | physical property | | | Minimum | potential | equivalent diameter | | | wall surfaces | | |
| | | DBP | | value of | maximum | Mean | | | Mean | | |
| Developing | PD | [ml/ | | impedance | value | value | SD | | value | SD | |
| roller No. | [nm] | 100 g] | pH | [Ω] | [V] | Rc | σc | σc/Rc | d | σd | σd/d |
| G-11 | 24 | 51 | 2.5 | 3.96E+05 | 3.7 | 92.9 | 60.7 | 0.653 | 146.8 | 95.6 | 0.651 |
| G-12 | 30 | 113 | 3.0 | 2.25E+04 | 2.4 | 88.0 | 56.0 | 0.636 | 130.1 | 79.5 | 0.611 |
| G-13 | 40 | 73 | 3.0 | 1.59E+05 | 8.7 | 104.0 | 79.7 | 0.766 | 205.8 | 130.7 | 0.635 |
| G-14 | 24 | 51 | 2.5 | 4.56E+05 | 3.5 | 86.8 | 57.0 | 0.657 | 129.8 | 80.1 | 0.617 |
| G-15 | 24 | 51 | 2.5 | 2.00E+08 | 462.0 | 57.0 | 34.0 | 0.596 | 112.7 | 63.8 | 0.566 |
| G-16 | 24 | 51 | 2.5 | 4.18E+05 | 4.6 | 87.8 | 55.5 | 0.632 | 130.7 | 79.5 | 0.608 |
| G-17 | 24 | 51 | 2.5 | 1.56E+05 | 7.6 | 89.1 | 57.6 | 0.646 | 148.2 | 98.7 | 0.666 |
| G-18 | 24 | 51 | 2.5 | 1.18E+05 | 6.8 | 92.0 | 61.0 | 0.663 | 145.7 | 97.6 | 0.670 |
| G-19 | 24 | 51 | 2.5 | 8.92E+04 | 2.5 | 96.1 | 65.0 | 0.676 | 152.3 | 100.2 | 0.658 |

In the Table 19, PD represents the number average diameter of the primary particles. SD indicates Standard deviation, DBP indicates DBP absorption amount. A minimum value of the impedance indicates a minimum impedance value at the frequency of 1.0×100 Hz to 1.0×10¹ Hz.

### Examples 1 to 34

Evaluations were performed for combinations shown in Table 20 using the toners 1 to 22 and the developing rollers (D rollers) G-1 to G-10 described above. Table 20 shows the evaluation results.

### Comparative Examples 1 to 15

Evaluations ware performed using the toners 1 and 23 to 26 and the developing rollers G-11 to G-19 described above for the combinations shown in Table 20. Table 20 shows the evaluation results.

TABLE 20

| | | | | | | | | Electric charge retention after | | |
|---|---|---|---|---|---|---|---|---|---|---|
| | | | Injection charging ratio | | | | | durable output | | |
| | | D | Charging amount | Charging | Δ charging | | | Charging amount | | |
| Example | Toner | roller | at −300 V | amount at | amount | | | at −300 V | | |
| No. | No. | No. | [μC/g] | 0 V [μC/g] | [μC/g] | IR | Rank | [μC/g] | RR | Rank |
| 1 | 1 | 1 | 39 | 22 | 17 | 44% | A | 35 | 90% | A |
| 2 | 1 | 2 | 48 | 25 | 23 | 48% | A | 39 | 81% | A |
| 3 | 1 | 3 | 51 | 28 | 23 | 45% | A | 41 | 80% | A |
| 4 | 1 | 4 | 38 | 21 | 17 | 45% | A | 35 | 92% | A |
| 5 | 1 | 5 | 32 | 18 | 14 | 44% | A | 29 | 91% | A |
| 6 | 1 | 6 | 41 | 21 | 20 | 49% | A | 38 | 93% | A |
| 7 | 1 | 7 | 39 | 22 | 17 | 44% | A | 34 | 87% | A |
| 8 | 1 | 8 | 42 | 24 | 18 | 43% | A | 37 | 88% | A |
| 9 | 1 | 9 | 39 | 20 | 19 | 49% | A | 34 | 87% | A |
| 10 | 1 | 10 | 35 | 21 | 14 | 40% | A | 30 | 86% | A |
| 11 | 2 | 1 | 28 | 16 | 12 | 43% | A | 22 | 79% | B |
| 12 | 3 | 1 | 33 | 18 | 15 | 45% | A | 25 | 76% | B |
| 13 | 4 | 1 | 39 | 22 | 17 | 44% | A | 35 | 90% | A |
| 14 | 5 | 1 | 42 | 26 | 16 | 38% | B | 32 | 76% | B |
| 15 | 6 | 1 | 36 | 23 | 13 | 36% | B | 26 | 72% | B |
| 16 | 7 | 1 | 42 | 28 | 14 | 33% | C | 32 | 76% | B |
| 17 | 8 | 1 | 37 | 25 | 12 | 32% | C | 28 | 76% | B |
| 18 | 9 | 1 | 39 | 26 | 13 | 33% | C | 30 | 77% | B |
| 19 | 10 | 1 | 28 | 19 | 9 | 32% | C | 20 | 71% | B |
| 20 | 11 | 1 | 22 | 13 | 9 | 41% | A | 16 | 73% | B |
| 21 | 12 | 1 | 26 | 15 | 11 | 42% | A | 19 | 73% | B |
| 22 | 13 | 1 | 26 | 15 | 11 | 42% | A | 19 | 73% | B |
| 23 | 14 | 1 | 33 | 19 | 14 | 42% | A | 23 | 70% | B |
| 24 | 15 | 1 | 35 | 23 | 12 | 34% | C | 27 | 77% | B |
| 25 | 16 | 1 | 37 | 26 | 11 | 30% | C | 23 | 62% | C |
| 26 | 17 | 1 | 23 | 13 | 10 | 43% | A | 16 | 70% | B |
| 27 | 18 | 1 | 22 | 13 | 9 | 41% | A | 14 | 64% | C |
| 28 | 19 | 1 | 38 | 21 | 17 | 45% | A | 33 | 87% | A |
| 29 | 20 | 1 | 38 | 25 | 13 | 34% | C | 30 | 79% | B |
| 30 | 21 | 1 | 26 | 15 | 11 | 42% | A | 19 | 73% | B |
| 31 | 22 | 1 | 29 | 17 | 12 | 41% | A | 21 | 72% | B |
| 32 | 8 | 2 | 30 | 17 | 13 | 43% | A | 26 | 87% | A |
| 33 | 12 | 3 | 31 | 18 | 13 | 42% | A | 27 | 87% | A |
| 34 | 16 | 4 | 34 | 19 | 15 | 44% | A | 31 | 91% | A |
| C.E. 1 | 1 | 11 | 16 | 15 | 1 | 6% | D | — | — | — |
| C.E. 2 | 1 | 12 | 15 | 14 | 1 | 7% | D | — | — | — |
| C.E. 3 | 1 | 13 | 16 | 15 | 1 | 6% | D | — | — | — |
| C.E. 4 | 1 | 14 | 11 | 10 | 1 | 9% | D | — | — | — |
| C.E. 5 | 1 | 15 | 15 | 10 | 5 | 33% | C | 5 | 33% | D |
| C.E. 6 | 1 | 16 | 16 | 15 | 1 | 6% | D | — | — | — |
| C.E. 7 | 1 | 17 | 12 | 12 | 0 | 0% | D | — | — | — |
| C.E. 8 | 1 | 18 | 11 | 11 | 0 | 0% | D | — | — | — |
| C.E. 9 | 1 | 19 | 10 | 9 | 1 | 10% | D | — | — | — |
| C.E. 10 | 23 | 15 | 24 | 23 | 1 | 4% | D | — | — | — |
| C.E. 11 | 24 | 15 | 23 | 15 | 8 | 35% | B | 6 | 26% | D |
| C.E. 12 | 25 | 11 | 5 | 5 | 0 | 0% | D | — | — | — |
| C.E. 13 | 26 | 11 | 13 | 12 | 1 | 8% | D | — | — | — |
| C.E. 14 | 26 | 15 | 23 | 15 | 8 | 35% | B | 7 | 30% | D |
| C.E. 15 | 25 | 15 | 26 | 14 | 12 | 46% | A | 5 | 19% | D |

In the Table, “C.E.” indicates “Comparative example”, IR indicates “Injection Ratio”, and RR indicates “Retention rate”.

Hereinafter, an evaluation method and evaluation criteria of the present disclosure are described.

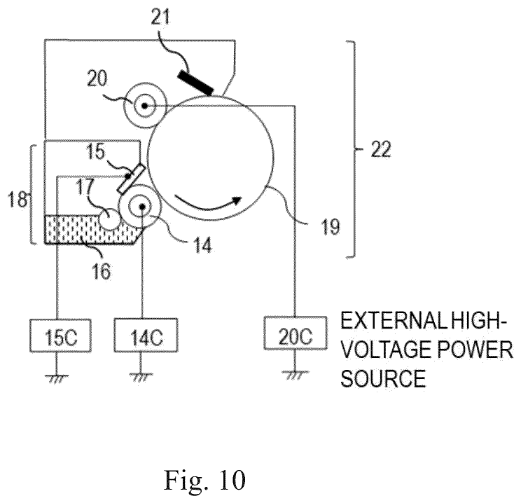

As the electrophotographic image forming apparatus, a remodeling machine of a commercially available laser printer, LBP-7600C (manufactured by Canon Inc.) was used. FIG. 10 illustrates the construction of the remodeling machine. The machine was modified such that it is connected to an external high-voltage power supply 20C in addition to power supplies 14C and 15C, an arbitrary potential difference is applied between the developing blade and the developing roller, and, for evaluations in a high-speed process, the number of output sheets per unit time was set to 50 sheets/minute for a paper sheet of the A4 size. The volume resistivity of the developing blade, which is the toner layer thickness control member, is 1.0×10⁻⁵ Ω·cm.

In addition, in the combinations of the toners and the developing rollers represented in Table 20, a developing apparatus in a process cartridge was modified. As the process cartridge, toner cartridge 318 (cyan) (manufactured by Canon Inc.) that is commercially available was used, a product toner was removed from the inside of the cartridge and was cleaned through air blow, and then, the process cartridge was filled with 100 g of a toner to be evaluated. In addition, the developing roller was also replaced with a developing roller to be evaluated. In each of stations of yellow, magenta, and black, the product toner was removed, and yellow, magenta, and black cartridges with a toner remaining detection mechanism disabled were inserted, and evaluations were performed.

### Evaluation of Charge Injection Performance (Amount of Injection Charging) and Injection Ratio

The process cartridge described above, the modified laser printer described above, and the evaluation paper sheet (GFC81 (manufactured by Canon Inc.), A4: 81.4 g/m²) were left to stand for 48 hours under normal temperature and humidity conditions (23° C./50% RH, hereinafter referred to as N/N environment).

First, an electric potential difference between the developing blade and the developing roller was set to 0 V, and a fully-white image was output. During image formation, the operation of the device was stopped, the process cartridge was removed from the main body, and the toner charging amount on the developing roller immediately after passing the developing blade was measured.

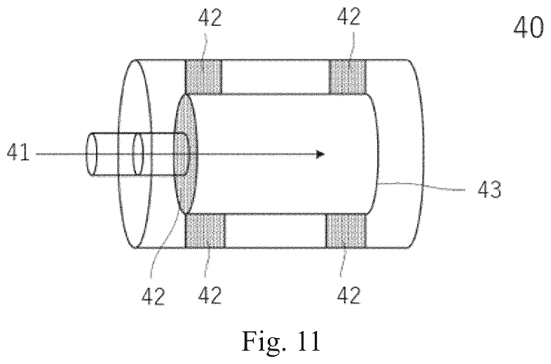

The amount of charging on the developing roller was measured using a Faraday cage 40 shown in the perspective view of FIG. 11. The interior (the right side in the drawing) was evacuated to allow the toner on the developing roller to be sucked in, and a toner filter 43 was provided to collect the toner. A suction part 41 and a holder 42 are illustrated. The charge amount Q/M (μC/g) per unit mass was calculated from the mass M of the collected toner and the total charge amount Q directly measured by a coulombmeter and is set as the charging amount (Q/M) of the toner.

Subsequently, the electric potential difference between the developing blade and the developing roller was set to −300 V, and a similar evaluation was performed.

A value acquired by dividing a charging amount change A charge amount Q/M (in unit of μC/g) between a case in which the electric potential difference is 0 V and a case in which the electric potential difference is −300 V by the charging amount of the case of −300 V and multiplying the result by 100 was evaluated to be ranked as below as an injection ratio (%). The injection ratio in this case represents the ratio of the charging amount obtained by injection charging to the charging amount of the toner of a case in which the electric potential difference is −300 V, and the larger this value, the easier the charging amount control according to an electric potential difference, which is preferable.
Rank A: Injection ratio of 40% or more
Rank B: Injection ratio of 35% or more and less than 40%
Rank C: Injection ratio of 30% or more and less than 35%
Rank D: Injection ratio less than 30%

Although the toner of this example represents negatively charging, the absolute values are shown in Table 20.

Charge Retention after Durable Output

After the evaluation of the injection charging amount and the injection charging amount distribution, the electric potential difference between the developing blade and the developing roller was set to −200 V, and, in the N/N environment, images with a printing ratio of 1.0% were continuously output onto 5,000 evaluation paper sheets and then were allowed to stand for 48 hours in the same environment.

Next, the electric potential difference between the developing blade and the developing roller was set to −300 V, and a fully-white image was output. During image formation, the apparatus was stopped, the process cartridge was removed from the main body, and the amount of charging of the toner on the developing roller immediately after passing through the developing blade as in the initial stage was measured using a Faraday cage. The acquired toner charging amount (Q/M) was compared to a value acquired before the continuous output to calculate the retention rate of the toner charging amount, and the rank was evaluated as follows. It can be understood that, the larger the value of the retention rate, the smaller the change in the amount of charging due to durability, and the more stable the developing system becomes.
Rank A: Retention rate of 80% or more
Rank B: Retention rate of 70% or more and less than 80%
Rank C: Retention rate of 60% or more and less than 70%
Rank D: Retention rate less than 60%

It can be understood that, in Comparative Examples 1 to 4, 6 to 10, and 12 and 13, the initial injection rate is low, and the charge injection performance cannot be acquired. In Comparative Examples 5, 11, 14, and 15, which exhibit good initial injection performance, the charge retention after durable output was evaluated.

In Comparative Examples 5, 11, 14, and 15, although initial charge injection performance was acquired, it can be understood that the retention rate of the amount of charging after durability is low, and a developing system having stable charging is not achieved. In Comparative Examples 5, 11, 14, and 15, toner scattering due to insufficient toner charging occurs in the cartridge after the durability. Further, when the developing roller after durability was removed from the process cartridge and observed visually, the surface of the developing roller was filmed with a toner and an external additive.

Examples 1 to 34 show good results in the evaluations of the charge injection performance the charge retention after durable output.

Particularly, combinations of toner of which the fixing ratio of titanium-containing fine particles is 10 to 90% and the developing roller according to the example exhibited better results from the viewpoint of charge retention after durable output.

In addition, a combination of the toner containing the titanium atom-containing fine particles S that are the titanium atom-containing fine particles having the major axis length of 8 nm to 60 nm and the aspect ratio of 2.0 or less and the developing roller according to the example exhibited better results in the initial charge injection performance.

Furthermore, a combination of the toner in which the titanium atom-containing fine particles described above satisfy NL/Nt≥0.3 and the developing roller according to the example exhibited better results in the charge retention after durable output.

In addition, a combination of the toner in which the presence ratio of titanium atoms at the time of measurement of the surface of the toner using the X-ray photoelectron spectroscopy is 0.10 to 1.00 atomic % and the developing roller according to the example exhibited better results in any one of the initial charge injection performance and the charge retention after durable output.

On the other hand, Comparative Examples 1 to 15 exhibited problems in the results of the evaluations of the charge injection performance and the charge retention after durability in a configuration in which the process speed is high, and the blade bias is high.

The developing rollers used in Comparative Examples 1, 12, and 13 did not achieve a desired impedance value and thus could not exhibit good results. The reason for this is considered to be reduction of the impedance due to the ether structure included in the polyurethane structure.

The developing rollers used in Comparative Examples 2 and 3 did not achieve a desired impedance value and did not exhibit good results. The reason for the low impedance value is considered that the primary particles of the carbon black had a large number average diameter and a large amount of DBP absorption, the structure of the carbon black after milling dispersion was increased, the dispersion particle size was large, and the inter-wall distance was increased.

The developing roller used in Comparative Example 4 did not achieve a desired impedance value and thus did not exhibit good results. The reason for the low impedance value is considered that the amount of additives was small, the dispersion of the conductive filler was insufficient, and thus a conduction path according to the conductive filler was formed inside of the surface layer.

Comparative Examples 5, 11, 14, and 15 had too high surface electric potentials of the developing rollers and thus did not exhibit good results of evaluations of the charge retention after durability. The reason for this is considered that the carbon black was covered with the insulating silane coupling agent, the surface potential became high, and the excessively-charged toner adhered to the surface of the developing roller, and contamination of the developing roller occurred to exhibit such results. In Comparative Example 15, the toner excessively contain titanium atom-containing fine particles, and thus the initial injection charging performance is good but could not exhibit good results of the evaluation of the charge retention after durability. In particular, Comparative Example 15 was inferior to Comparative Example 14 using a similar developing roller in the evaluation of charge retention after durability.

Comparative Example 6 exhibits results in which the impedance of the developing roller is low, and the injection charging performance is low. The reason for the low impedance is that, although a polymer dispersant suitable for dispersion of carbon black is used, the dispersibility of the carbon black in the resin is not improved, the number of added dispersing agents is large, and the electrical characteristics of the resin are affected.

Comparative Examples 7 to 9 also exhibit results in which the impedance of the developing roller is low, and the injection charging performance is low. The reason for the low impedance is that the carbon chains of R51, R61, and R71 in Structural Formulas (5), (6), and (7) used in Comparative Examples 7 to 9 exceed a good range, the dispersibility of the carbon black is reduced, and the impedance becomes low.

In Comparative Example 10, the toner did not contain titanium atom-containing fine particles, and the required injection charging performance could not be acquired. The present disclosure can provide a developing apparatus, a process cartridge, and an electrophotographic image forming apparatus that have good injection charging characteristics, are capable of being applied to a high-speed developing process, and have charging stability even in long-term use.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145487, filed Aug. 27, 2024, and Japanese Patent Application No. 2025-064998, filed Apr. 10, 2025, which are hereby incorporated by reference herein in their entirety.

What is claimed is:

1. A developing apparatus comprising:
a toner comprising a toner particle and external additive;
a toner carrying member for carrying the toner; and
a charge injection member configured to inject electric charge into the toner, wherein
the external additive contains titanium atom-containing fine particles containing a compound containing titanium atoms,
a presence ratio of the titanium atoms is 0.05 to 4.00 atomic % when a surface of the toner is measured using X-ray photoelectron spectroscopy,
the toner carrying member is a developing roller having
a substrate having a conductive outer surface and
a resin layer on the outer surface of the substrate,
a metal film is directly provided on an outer surface of the developing roller, and under an environment of 23° C. temperature and 50% relative humidity, when an AC voltage of which an amplitude is 50 V is applied between the outer surface of the substrate and the metal film with a frequency changing in a range of 1.0×10⁻¹ to 1.0×10⁵ Hz while a DC voltage of 50 V is applied therebetween, an impedance at the frequency of 1.0×10⁰ to 1.0×10¹ Hz is 1.00×10⁶ Ω or more, and
under an environment of 23° C. temperature and 50% relative humidity, a corona discharger having a grid portion of which a width is 3.0 mm is arranged such that a distance between the grid portion and the outer surface of the developing roller is 1.0 mm, and a direction of the width of the grid portion coincides with an axial direction of the developing roller, and when a voltage of 8 kV is applied to the grid portion, and the outer surface of the developing roller is charged by relatively moving the corona discharger in the axial direction of the developing roller at a speed of 400 mm/sec, a maximum value of an electric potential of the outer surface is less than 20.0 V when the electric potential is measured after 0.06 seconds from passage of the grid portion.

2. The developing apparatus according to claim 1, wherein
the titanium atom-containing fine particles are at least one selected from a group consisting of titanium oxide fine particles and strontium titanate fine particles.

3. The developing apparatus according to claim 1, wherein
a fixing ratio of the titanium atom-containing fine particles for a surface of the toner particle that is measured using wavelength dispersion-type fluorescent X-ray analysis is 10 to 90%.

4. The developing apparatus according to claim 1, wherein
the titanium atom-containing fine particles comprise titanium atom-containing fine particles Sa of which a number average value of major axis lengths is 8 to 60 nm, and a number average value of aspect ratios is 2.0 or less.

5. The developing apparatus according to claim 1, wherein
the titanium atom-containing fine particles comprise titanium atom-containing fine particles L of which a major axis length is 100 to 3000 nm, and an aspect ratio is 5.0 or more, and
the toner is observed using a scanning electron microscope, and when a total number of observed toners is denoted by Nt, and the number of toners of which presence of the titanium atom-containing fine particles L on the surface can be checked among observed toners is denoted by NL, Nt and NL satisfy NL/Nt≥0.3.

6. The developing apparatus according to claim 1, wherein
the titanium atom-containing fine particles comprise:
titanium atom-containing fine particles La of which a number average value of major axis lengths is 100 to 3000 nm and a number average value of aspect ratio is 5.0 or more; and
titanium atom-containing fine particles Sa of which a number average value of major axis lengths is 8 to 60 nm, and a number average value of aspect ratios is 2.0 or less.

7. The developing apparatus according to claim 1, wherein
the presence ratio of the titanium atoms is 0.10 to 1.00 atomic %.

8. The developing apparatus according to claim 1, wherein
the maximum value of the electric potential is 10.0 V or less.

9. The developing apparatus according to claim 1, wherein
the resin layer comprises polyurethane.

10. The developing apparatus according to claim 1, wherein
the resin layer comprises polyurethane having a polycarbonate structure.

11. The developing apparatus according to claim 10, wherein
the polyurethane satisfies at least two of the following (A), (B), and (C):
(A) The polyurethane has a structure represented by the following Structural Formula (1) in a molecule;
(B) The polyurethane has any one or both of a structure represented by the following Structural Formula (2) and a structure represented by the following Structural Formula (3) in a molecule; and
(C) The polyurethane has a structure represented by the following Structural Formula (4) in a molecule: 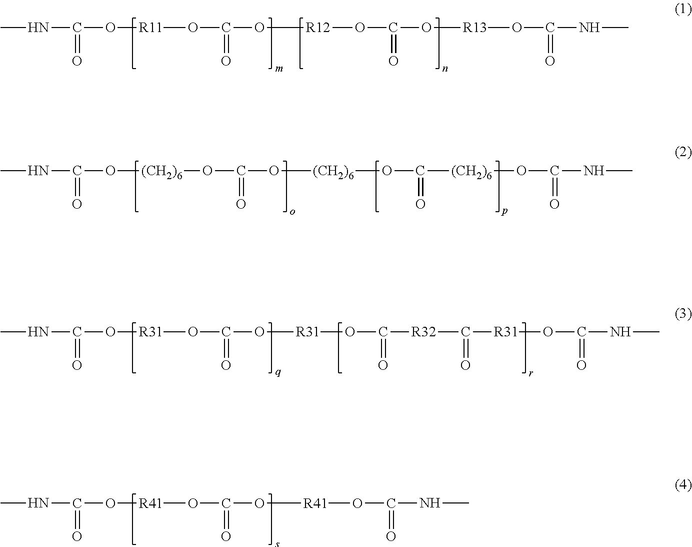
where, in Structural Formula (1), R11, R12, and R13 represent divalent hydrocarbon groups having 3 to 9 carbon atoms, provided that R11 and R12 are different from each other, and R13 is the same as at least one selected from a group consisting of R11 and R12, and m and n are average numbers of added mols and independently represent numbers of 1.0 or more,
in Structural Formula (2), o and p are average numbers of added mols and independently represent numbers of 1.0 or more,
in Structural Formula (3), R31 and R32 independently represent divalent hydrocarbon groups having 3 to 8 carbon atoms, and q and r are average numbers of added mols and independently represent numbers of 1.0 or more,
in Structural Formula (4), R41 represents a divalent hydrocarbon group having 6 to 9 carbon atoms, and s is an average number of added mols and represents a number of 1.0 or more.

12. The developing apparatus according to claim 1, wherein
the resin layer comprises a conductive filler.

13. The developing apparatus according to claim 12, wherein
the conductive filler comprises carbon black.

14. The developing apparatus according to claim 13, wherein
an arithmetic mean value Rc of a circle-equivalent diameter of the carbon black in the resin layer is 60.0 nm or less, and
when a standard deviation of the circle-equivalent diameter of the carbon black is denoted by σc, σc/Rc is 0.000 to 0.650.

15. The developing apparatus according to claim 13, wherein
an arithmetic mean value d of distance between wall surfaces of the carbon black in the resin layer is 80.0 to 150.0 nm, and
when a standard deviation of the distance between wall surfaces is denoted by σd, σd/d is 0.000 to 0.600.

16. The developing apparatus according to claim 13, wherein
a number average diameter of primary particles of the carbon black in the resin layer is 30 nm or less.

17. The developing apparatus according to claim 13, wherein
a DBP absorption amount of the carbon black in the resin layer is 90 mL/100 g or less, and
pH of the carbon black is 4.0 or less.

18. The developing apparatus according to claim 13, wherein
the resin layer comprises at least one compound selected from a group consisting of a compound having a structure represented by following Structural Formula (5), a compound having a structure represented by following Structural Formula (6), and a compound having a structure represented by following Structural Formula (7): 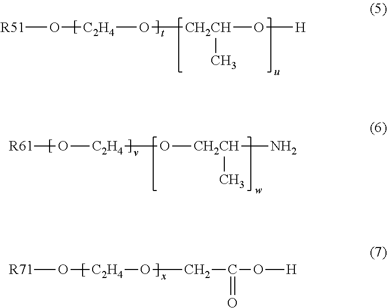
where, in Structural Formula (5), R51 represents a monovalent hydrocarbon group having 1 to 12 carbon atoms, and t and u are average numbers of added mols and independently represent numbers of 1 or more,
in Structural Formula (6), R61 represents a monovalent hydrocarbon group having 1 to 8 carbon atoms, and v and w are average numbers of added mols and independently represent numbers of 1 or more,
in Structural Formula (7), R71 represents a monovalent hydrocarbon group having 1 to 12 carbon atoms, and x is an average number of added mols and represents a number of 1 or more.

19. The developing apparatus according to claim 1,
the developing apparatus further comprising:
a toner layer thickness control member that is in contact with the toner carrying member and is used for controlling a layer thickness of the toner carried on the toner carrying member; and
a contact point electrically connected to the toner layer thickness control member, wherein
when the developing apparatus is mounted in a main body of an electrophotographic image forming apparatus, the contact point is electrically connected to a main body contact point of the main body of the electrophotographic image forming apparatus and is able to apply a predetermined voltage to the toner layer thickness control member, and
a volume resistivity of the toner layer thickness control member is 1.0×10⁶ Ω·cm or less.

20. A process cartridge configured to be attachable/detachable to/from a main body of an electrophotographic image forming apparatus,
the process cartridge comprising a developing apparatus comprising:
a toner comprising a toner particle and external additive;
a toner carrying member for carrying the toner; and
a charge injection member configured to inject electric charge into the toner, wherein
the external additive contains titanium atom-containing fine particles containing a compound containing titanium atoms,
a presence ratio of the titanium atoms is 0.05 to 4.00 atomic % when a surface of the toner is measured using X-ray photoelectron spectroscopy,
the toner carrying member is a developing roller having
a substrate having a conductive outer surface and
a resin layer on the outer surface of the substrate,
a metal film is directly provided on an outer surface of the developing roller, and under an environment of 23° C. temperature and 50% relative humidity, when an AC voltage of which an amplitude is 50 V is applied between the outer surface of the substrate and the metal film with a frequency changing in a range of 1.0×10⁻¹ to 1.0×10⁵ Hz while a DC voltage of 50 V is applied therebetween, an impedance at the frequency of 1.0×10⁰ to 1.0×10¹ Hz is 1.00× 10⁶ Ω or more, and
under an environment of 23° C. temperature and 50% relative humidity, a corona discharger having a grid portion of which a width is 3.0 mm is arranged such that a distance between the grid portion and the outer surface of the developing roller is 1.0 mm, and a direction of the width of the grid portion coincides with an axial direction of the developing roller, and when a voltage of 8 kV is applied to the grid portion, and the outer surface of the developing roller is charged by relatively moving the corona discharger in the axial direction of the developing roller at a speed of 400 mm/sec, a maximum value of an electric potential of the outer surface is less than 20.0 V when the electric potential is measured after 0.06 seconds from passage of the grid portion.

21. An electrophotographic image forming apparatus comprising a developing apparatus comprising:
a toner comprising a toner particle and external additive;
a toner carrying member for carrying the toner; and
a charge injection member configured to inject electric charge into the toner, wherein
the external additive contains titanium atom-containing fine particles containing a compound containing titanium atoms,
a presence ratio of the titanium atoms is 0.05 to 4.00 atomic % when a surface of the toner is measured using X-ray photoelectron spectroscopy,
the toner carrying member is a developing roller having
a substrate having a conductive outer surface and
a resin layer on the outer surface of the substrate,
a metal film is directly provided on an outer surface of the developing roller, and under an environment of 23° C. temperature and 50% relative humidity, when an AC voltage of which an amplitude is 50 V is applied between the outer surface of the substrate and the metal film with a frequency changing in a range of 1.0×10⁻¹ to 1.0×10⁵ Hz while a DC voltage of 50 V is applied therebetween, an impedance at the frequency of 1.0×10⁰ to 1.0×10¹ Hz is 1.00×10⁶ Ω or more, and
under an environment of 23° C. temperature and 50% relative humidity, a corona discharger having a grid portion of which a width is 3.0 mm is arranged such that a distance between the grid portion and the outer surface of the developing roller is 1.0 mm, and a direction of the width of the grid portion coincides with an axial direction of the developing roller, and when a voltage of 8 kV is applied to the grid portion, and the outer surface of the developing roller is charged by relatively moving the corona discharger in the axial direction of the developing roller at a speed of 400 mm/sec, a maximum value of an electric potential of the outer surface is less than 20.0 V when the electric potential is measured after 0.06 seconds from passage of the grid portion.
